(19) United States
(12) Patent Application Publication
(10) Pub. No.: US 2026/0144225 A1
(43) Pub. Date: May 28, 2026

(54) Clumping Agent Additive for Litter

(71) Applicant: Pioneer Pet Products, LLC, Cedarburg, WI (US)

(72) Inventors: John M. Lipscomb, Cedarburg, WI (US); Omar I. Rodriguez, Cedarburg, WI (US)

(21) Appl. No.: 18/957,863

(22) Filed: Nov. 24, 2024

(51) Int. Cl. A01K 1/015

(52) U.S. Cl. CPC A01K 1/0155

(57) ABSTRACT

A particulate extruded clumping agent additive containing clumping agent that is shaken or sprinkled onto granules of (a) preexisting non-clumping litter to transform it into clumping litter clump, and (b) preexisting clumping litter to improve clumping. Its particles are smaller than the litter granules distributing them into voids between adjacent granules plugging the voids pooling urine on top so scoopable clumps form on top. The clumping agent is composed of one constituent that is an at least partially water-soluble water reactivatable, water re-curable binder and can also be composed of another constituent that is an at least partially soluble one-time water activated, one time water cured binder preferably composed of a pregelatinized starch. The clumping agent is formed of starch in an admixture modified thereinto by subjecting it to extrusion pressures of at least 2000 PSI during extrusion. Litter tracking effectiveness can also be improved with the clumping agent additive.

### CROSS-REFERENCE TO RELATED APPLICATIONS

This application claims priority in and the benefit of U.S. Application Ser. No. 63/540,257 filed Sep. 25, 2023, the entire disclosure of which is hereby expressly incorporated herein by reference. This application also is a continuation-in-part of U.S. application Ser. No. 18/741,466, filed Jun. 12, 2024, which claims priority in and the benefit of U.S. Application Ser. No. 63/465,916 filed May 12, 2023, and a continuation-in-part of U.S. application Ser. No. 18/372,677, filed Sep. 25, 2023, which claims priority in and the benefit of U.S. Application Ser. No. 63/409,755 filed Sep. 24, 2022, the entire disclosures of each of which are hereby expressly incorporated herein by reference.

### FIELD OF THE INVENTION

The present invention relates generally to additives for litter and more particularly to a particulate clumping additive for granular litter which is configured for being added to litter to impart clumping properties thereto or, where the litter is already a clumping litter, enhance the clumping properties thereof.

### BACKGROUND OF THE INVENTION

Historically, clumping litter technology centered largely around one molecule-sodium bentonite. Sodium bentonite is a material the clumps through swelling as it absorbs water. It generally absorbs up to six times its weight in water. This absorption causes the swelling of the sodium bentonite. As it swells it fills the void between the particles of sodium bentonite. The softened particle of sodium bentonite swells into other softened sodium bentonite particles. These particles slump together and form a clump as the water further absorbs and equivalates throughout the wetted sodium bentonite.

In the past, myriad attempts have been made by others to develop clumping and non-clumping litters, but it is not believed that anyone has ever attempted heretofore to make a clumping agent that is added as an additive by a cat owner to prior art litter in a litter box to impart or enhance the ability of the litter to clump. It also is not believed that anyone has ever attempted heretofore to make such a clumping agent that enhances litter efficiency by increasing clumping efficiency by imparting to the litter the ability to forms clumps more quickly with fewer prior art litter granules that can also have and preferably also do have increased clump retention rate and clump crush strength compared to the prior art litter when used without the clumping agent of the present invention.

### SUMMARY OF THE INVENTION

The present invention is directed to a clumping agent additive, preferably a particulate clumping agent additive, configured to be added to preexisting granular clumping and non-clumping litter, referred to as base litter, typically prepackaged litter, and which is configured with an at least partially water-soluble binder clumping agent that causes non-clumping base litter to clump and clumping base litter to clump better. The present invention also is directed to a method of making a clumping agent additive in accordance with the present invention, that preferably is a particulate clumping agent additive composed of particles of an extrudate made from a starch-containing admixture subjected in an extruder to an ultrahigh extrusion pressure of at least 2000 pounds per square inch (PSI) as disclosed hereinbelow that is sufficient to modify, preferably extrusion-modify, more preferably at least partially physically modify, at least some starch in the admixture into the at least partially water-soluble binder clumping agent.

As disclosed in more detail below, the at least partially water-soluble binder clumping agent preferably is composed of at least a plurality of clumping agent additive constituents composed of extrusion-modified starch with one of the clumping agent additive constituents being a one-time water-activated one-time water-cured water-soluble binder and another one of the clumping agent additive constituents being a water-soluble binder that is water-activatable and water-curable at least a plurality of times, i.e., a water re-activatable, water re-curable water-soluble binder. In a preferred clumping agent additive embodiment and method of making clumping agent additive, at least one of these constituents is composed of a pregelatinized starch formed of at least some of the starch in the starch-containing admixture that was extrusion pressure modified in the extruder during extrusion. In one preferred embodiment, a first one of the constituents is a one-time water-activated one-time water-cured water-soluble binder composed of a pregelatinized starch formed of at least some of the extrusion-modified starch in the starch-containing admixture that was preferably at least partially physically modified by the ultrahigh extrusion pressure during extrusion, and a second one of the constituents is a water-soluble binder that is water-activatable and water-curable at least a plurality of times, i.e., a water re-activatable, water re-curable water-soluble binder, formed of at least some of the other extrusion-modified starch in the starch-containing admixture that also was preferably at least partially physically modified by the ultrahigh extrusion pressure during extrusion as discussed in more detail below. In one such preferred method of making the extruded clumping agent additive, the constituent, such as preferably second constituent, that is a binder that is water-activatable and water-curable at least a plurality of times, i.e., a water re-activatable, water re-curable water-soluble binder, is formed of at least some of the other extrusion-modified starch in the starch-containing admixture that also was preferably at least partially physically modified by the ultrahigh extrusion pressure during extrusion cross-linked by or with protein or proteins in the starch-containing admixture that can be composed of extrusion-modified proteins freed up from the starch in the admixture and/or extrusion-pressure modified, such as by being physically modified, by being subjected to ultrahigh extrusion pressures of at least 2000 PSI, preferably at least 3000 PSI, more preferably at least 4000 PSI, and even more preferably at least 5000 PSI at an extrusion temperature of at least 100° Celsius, more preferably at least 130° Celsius in the extruder during extrusion and preferably no greater than 180° C., preferably no greater than about 150° C., and preferably about 140° C. for a residency time of at least three seconds and no greater than twenty seconds, preferably between three seconds and fifteen seconds, and more preferably between about four seconds and about eight seconds in an extruder that preferably is a single screw extruder with an starch-containing admixture formulated and configured as disclosed elsewhere herein.

In a preferred embodiment and method of making clumping agent additive by extrusion, the particles of the clumping agent additive have at least 5%, preferably at least 10%, more preferably at least 15% and even more preferably at least 25% of the at least partially water-soluble binder clumping agent by clumping agent additive particle weight. In at least one preferred embodiment and method of making clumping agent additive by extrusion, preferably by ultrahigh pressure extrusion, the particles of the clumping agent additive each contains at least 2.5% by particle weight of the constituent that is the single-time water-activated single-time water-cured water-soluble binder clumping agent, and at least 2.5% by particle weight of the constituent that is the water re-activatable, water re-curable water-soluble binder clumping agent, preferably contains at least about 5% by particle weight of the constituent that is the single-time water-activated single-time water-cured water-soluble binder and at least about 5% by particle weight of the constituent that is the water re-activatable, water re-curable water-soluble binder, more preferably contains at least about 7.5% by particle weight of the constituent that is the single-time water-activated single-time water-cured water-soluble binder and at least about 7.5% by particle weight of the constituent that is the water re-activatable, water re-curable water-soluble binder, and even more preferably contains at least about 12.5% by particle weight of the constituent that is the single-time water-activated single-time water-cured water-soluble binder and at least about 12.5% by particle weight of the constituent that is the water re-activatable, water re-curable water-soluble binder.

The clumping agent additive preferably is a particulate clumping agent additive formed of particles each containing clumping agent whose particles are preferably smaller in size than at least half and preferably substantially all of the litter granules of the base litter to which the clumping agent additive particles are added to produce a clumping agent additive enhanced clumping litter of the present invention. The water-soluble clumping agent in each clumping agent additive particle preferably is cold-water soluble and which at least partially solubilizes or dissolves in urine or water coming in contact therewith forming a flowable adhesive that produces a clump composed of wetted clumping agent additive particles and wetted litter granules of the base litter to which the clumping agent additive particles were added.

The clumping agent additive is a particulate additive that is added to granules of a base litter, such as in the form of a prepackaged preexisting litter or litter formulation, such as either when the base litter is in its original retail package, e.g., container, jug or bag, or when the base litter has already been poured into a litter box. Where the granular base litter is a non-clumping litter, an amount of the particulate clumping agent additive is added to the non-clumping base litter, preferably at least 15%, more preferably at least 25%, and even more preferably at least 35% by weight, that is sufficient to produce a clumping agent additive enhanced litter of the present invention that clumps when wetted with water or urine. When added to the non-clumping base litter, the aforementioned percentage(s) of the clumping agent additive added thereto is the percentage of the resultant clumping agent additive enhanced litter that is made up of the particles of the clumping agent additive. When added to a non-clumping base litter in an amount or percentage sufficient for the resultant clumping additive enhanced litter to clump when wetted with water or urine, a clump formed from wetting at least a plurality of pairs, i.e. at least three, of the litter granules of the base litter and at least a plurality of pairs of particles of the clumping agent additive has a clump retention rate of at least 90%, preferably at least 95% and more preferably at least 97% when tested at either 10 minutes and/or 30 minutes after clump formation in accordance with the clump retention rate or clump drop test procedure disclosed hereinbelow.

Where the base litter already is a clumping litter, an amount of clumping agent additive is added to the clumping base litter, such as in an amount of at least 5%, preferably at least 10%, and more preferably at least 25% by weight, that is sufficient to produce a clumping agent additive enhanced clumping litter of the present invention that improves at least one property of the resultant clumping agent additive enhanced clumping litter, such as preferably one or more of litter efficiency, litter particle tracking effectiveness, and/or dusting, and/or that improves at least one clumping property of the resultant litter, such as one or more of the clump retention rate, clumping efficiency, and/or clump crush strength compared to the original base litter with no clumping agent additive added thereto. When added to a clumping base litter in one of the aforementioned weight percentages, the resultant clumping agent additive enhanced litter has a clump retention rate, when tested at either 10 minutes and/or 30 minutes after clump formation, that is at least 2% greater, preferably is at least 5% greater, and more preferably is at least 7% greater than the corresponding 10 minute or 30 minute clump retention rate of the clumping base litter without any clumping agent additive present. When added to a clumping base litter in one of the aforementioned weight percentages, the resultant clumping agent additive enhanced litter has a clump retention rate, when tested at 10 minutes and 30 minutes after clump formation, that is at least 90%, preferably at least 95%, and more preferably at least 97%.

The clumping agent additive is a particulate litter additive composed of particles with particle sizes ranging from as small as 400 μm to as large as 2000 μm producing a clumping agent additive of the present invention having a density of less than 25 pounds per cubic foot for enabling the smaller clumping agent additive particles to work in concert with the larger granules of preexisting litter in a litter box so that the smaller particles act as plugs in the between adjacent litter granules that block downward passage of water or urine while substantially simultaneously releasing water soluble binder that causes or facilitates clumping. In a preferred clumping agent embodiment, the clumping agent additive has a particle size distribution that preferably is relatively uniform and which ranges from about 450 μm to about 1800 μm and having a density no greater than about 20 pounds per cubic foot and preferably which ranges from 500 μm to 1680 μm or which pass through a 12 US mesh sieve and which rest upon a 35 US mesh sieve (12/35 US mesh sieve) and which have a density no greater than about 17 pounds per cubic foot.

The clumping agent preferably is in the form of an extruded organic starch-containing particulate material that is configured, such as by being packaged in a dispenser, e.g., shaker, for being added by being shaken on or mixed with litter in a litterbox forming a multicomponent litter that imparts an ability to the multicomponent litter to form clumps when wetted with water or urine, where the existing litter is a non-clumping litter, e.g., calcium bentonite litter, or enhances the ability of the multicomponent litter to form clumps when wetted with water or urine by one or more of the following: increasing clump retention rate, increasing clump crush strength, increasing the rate or speed of clump formation, decreasing clump size, increasing clumping efficiency and/or increasing litter efficiency compared to the same characteristic of the litter when used without the clumping agent. Use of the clumping agent additive preferably produces clumps containing a mixture of the clumping agent additive and the litter in the litterbox that exhibit an increase of at least 3% in clump retention rate and preferably an increase of at least 5% in clump retention rate compared to the clump retention rate of a clump made from the litter used by itself without the clumping agent additive. The use of the clumping agent additive preferably produces clumps containing a mixture of the clumping agent additive and the litter in the litterbox that exhibit an increase in clump crush strength of at least 5 PSI and preferably at least 10 PSI compared to the crush strength of a clump made from the litter used by itself without the clumping agent additive.

By increasing the rate or speed of clump formation while simultaneously decreasing clump size when the clumping agent additive is used compared to when it is not used, clumping efficiency of the resultant clumping agent additive enhanced litter is increased compared to that of the base litter. By increasing clumping efficiency when the clumping agent additive is used compared to when it is not used, the use of the clumping agent additive also increases litter efficiency because less litter is used to form a clump compared to when the clumping agent additive is not used. This advantageously results in less litter used to form clumps over a longer period of time when the clumping agent additive of the present invention is used compared to when it is not used. To put it a different way, this means that less litter is wasted because a predetermined amount of the clumping agent additive enhanced litter in a litter box will last longer, preferably at least a plurality of days longer, then the same predetermined amount of the base litter used in the same litter box.

As previously discussed, the clumping agent additive preferably includes or has (a) a first clumping agent additive constituent that is a clumping agent that is or includes a one-time water activated one-time water cured clumping agent, and (b) a second clumping agent additive constituent that is a water reactivatable, water re-curable, or water reactivating water recuring binder clumping agent configured to be water activated and water cured a plurality of times. In one preferred embodiment, the clumping agent additive contains at least 2.5% of the first constituent, preferably at least 5% of the first constituent, more preferably at least 7.5%, and even more preferably at least 12.5% of the first constituent by clumping agent additive weight. In another preferred embodiment, the clumping agent additive contains at least 2.5% of the second constituent, preferably at least 5% of the second constituent, more preferably at least 7.5% of the second constituent, and even more preferably at least 12.5% of the second constituent by clumping agent additive weight. In one such preferred embodiment, the clumping agent additive contains at least 2.5% of the first and second clumping agent additive constituents, preferably at least 5% of the first and second constituents, more preferably at least 7.5% of the first and second constituents, and even more preferably at least 12.5% of the first and second constituents by clumping agent additive weight.

In a preferred clumping agent additive embodiment and method of making the clumping agent additive, the clumping agent additive also includes or is composed of a third clumping agent additive constituent that is a sorbent constituent, composed of a sorbent or sorbent material, which preferably is a water sorbent or water sorbent material configured to sorb, preferably absorb, water and urine. In one such embodiment and method, the third constituent is a sorbent that is both water and oil sorbent, preferably by being both water and oil absorbent such as preferably by being at least partially composed of a water-insoluble aliphatic, hydrocarbon or petroleum liquid sorbent starch. Where the third constituent is at least partially composed of a water-insoluble aliphatic, hydrocarbon or petroleum liquid sorbent starch, the water-insoluble aliphatic, hydrocarbon or petroleum liquid sorbent starch is composed of at least some further starch in the starch-containing admixture modified, preferably at least partially physically modified, in the extruder by extrusion pressure, preferably ultrahigh extrusion pressure during extrusion of the extruded clumping agent additive. Where the clumping agent additive contains such a third constituent, it contains at least 5% of the third constituent, preferably at least 7.5% of the third constituent, and more preferably at least 10% of the third constituent.

In a preferred embodiment, the clumping agent additive includes or has (a) a first constituent that is or includes a one-time moisture activated one-time moisture cured binder, and (b) a second constituent that is or includes a moisture reactivating moisture recuring binder configured to be moisture activated and moisture cured a plurality of times. In one such preferred embodiment, the clumping agent additive includes or has a third constituent that is or includes a water sorbent, preferably a water absorbent, which preferably is configured to sorb, more preferably absorb, water.

The first constituent is formed of or includes a cold-water soluble starch that is at least partially water soluble at a room temperature of between 68 degrees Fahrenheit and 72 degrees Fahrenheit. The first constituent is formed of or includes an extrusion-modified starch that is or includes starch in the admixture that is modified during extrusion. The first constituent is formed of or includes extrusion-modified starch which is from or includes starch in the admixture modified by ultrahigh pressure extrusion into the extrusion modified starch of the first constituent. In one preferred embodiment, the first constituent is formed of or includes an extrusion-modified amylopectin starch. In another embodiment, the first constituent is formed of or includes an extrusion-modified amylose starch.

The second constituent is formed of or includes a cold-water soluble starch that is at least partially water soluble at a room temperature of between 68 degrees Fahrenheit and 72 degrees Fahrenheit. The second constituent is formed of or includes an extrusion-modified starch that is or includes starch in the admixture that is modified during extrusion. The second constituent is formed of or includes extrusion-modified starch which is from or includes starch in the admixture modified by ultrahigh pressure extrusion into the extrusion modified starch of the second constituent. In one preferred embodiment, the second constituent is formed of or includes an extrusion-modified amylopectin starch. In another embodiment, the second constituent is formed of or includes an extrusion-modified amylose starch.

In at least one embodiment, either the first constituent or the second constituent is or includes a water sorbent, preferably a water absorbent. In at least one such embodiment, either the first constituent or the second constituent is water sorbent, preferably water absorbent. In at least one such embodiment, the clumping agent additive has a third constituent which is sorbent, preferably water absorbent.

In at least one other embodiment, both the first constituent and the second constituent are or include a water sorbent. In at least one such other embodiment, both the first constituent and the second constituent are water sorbent, preferably water absorbent. In at least one such embodiment, the clumping agent additive has a third constituent which is sorbent, preferably water absorbent.

Where the clumping agent additive includes a third constituent, the third constituent also is formed of or includes a cold-water soluble starch that is at least partially water soluble at a room temperature of between 68 degrees Fahrenheit and 72 degrees Fahrenheit. The third constituent is formed of or includes an extrusion-modified starch that is or includes starch in the admixture that is modified during extrusion. The third constituent is formed of or includes extrusion-modified starch which is from or includes starch in the admixture modified by ultrahigh pressure extrusion into the extrusion modified starch of the third constituent. In one embodiment, the third constituent is formed of or includes an extrusion-modified amylopectin starch. In another embodiment, the third constituent is formed of or includes an extrusion-modified amylose starch.

A preferred method of making a clumping agent additive for being added to an existing litter in a litter box in accordance with the present invention includes (a) providing an extruder and an admixture that includes or is composed of starch, and (b) extruding the admixture by subjecting the admixture to an ultrahigh pressure of at least 2500 PSI within the extruder and thereafter discharging the admixture as an extrudate from the extruder where the extrudate is the clumping agent additive configured to be shaken onto, sprinkled on or mixed with litter in a litterbox to (i) impart the ability to non-clumping litter in the litterbox to clump when wetted with water or urine, or (ii) enhance the ability of clumping litter in the litterbox to clump when wetted with water or urine. The extrudate is cut into clumping agent additive particles by a rotary cutter as the extrudate exits a perforate die of the extruder. The extrudate can also be cut into pellets which are then subsequently particle-size reduced, such as by comminution, e.g., grinding or milling, into smaller particles of extruded clumping agent additive of the present invention.

The extruder preferably is a single screw extruder having at least 50 horsepower, preferably has no greater than 200 horsepower, which preferably has a horsepower or horsepower rating of between 50 and 100 horsepower, which more preferably has a horsepower or horsepower rating of about 100 horsepower (100 HP±15 HP), and which even more preferably has a horsepower rating of between about 100 horsepower (100 HP±15 HP) and about 200 horsepower (200 HP±30 HP) with an output of at least about 150 pounds of extrudate per hour and not more than about 500 pounds of extrudate per hour, preferably with an output of at least 250 pounds of extrudate per hour and not more than about 450 pounds of extrudate per hour, and more preferably between 380 and 420 pounds of extrudate per hour. The single screw extruder, such as preferably a 100 horsepower single screw extruder, has a main screw which rotates at a speed of between about 300 RPM and 450 RPM, an auger which rotates at a speed of about 35 RPM, and its rotary cutter, which has between 2 knife blades and 6 knife blades, preferably between 4 knife blades and 6 knife blades, rotates at a speed of at least about 1000 RPM to cut the extrudate into suitably small particles, e.g., pellets or granules, having desired particle sizes and/or desired particle size range(s) or distributions in accordance with that discussed in more detail below.

The admixture is subjected to an aforementioned ultrahigh extrusion pressure within the single screw extruder for a residency time of no longer than 24 seconds, preferably no longer than 20 seconds, more preferably no longer than about 18 seconds (18 seconds±2 seconds), preferably between 4 seconds and 20 seconds, more preferably between 5 seconds and 18 seconds, even more preferably between 7 seconds and 15 seconds, and most preferably between 8 seconds and 12 seconds. The extruder die has at least a plurality of pairs of die holes formed therein with each die hole having a width or diameter of no greater than 0.070 inches and which is preferably about 0.050 inches (0.050 inches±0.015 inches) to help produce extrudate when cut to pellets or granules have desired particle sizes and/or particle size range(s) or distributions in accordance with that discussed in more detail below. In a preferred embodiment, the extruder die has between 125 die holes and 250 die holes, preferably about 154 die holes (154 die holes±25 die holes) to produce a desirably high enough amount of the extrudate per hour of extruder operation in accordance with the pounds of extrudate per hour amounts and/or ranges discussed above in the preceding paragraph.

In a preferred implementation of the method, the extruder subjects the admixture to an ultrahigh extrusion pressure of at least 1500 PSI, at least 2500 PSI, at least 3000 PSI, at least 3500 PSI, at least 4000 PSI, at least 5000 PSI, or at least 7500 PSI during the extruding step, where the extrusion pressure is measured at the die. In a preferred method implementation, the extruder operates at an extrusion temperature of at least 100 degrees Celsius, preferably at least 120 degrees Celsius, and more preferably about 140 degrees Celsius (140° C.±25° C.) during the extruding step, where the temperature also is measured at the die. In one such preferred method implementation, the extruder subjects the admixture to an extrusion temperature of at least 100 degrees Celsius, preferably at least 120 degrees Celsius and more preferably about 140 degrees Celsius at an extrusion pressure of at least 1500 PSI, preferably at least 2500 PSI, and more preferably at least 3000 PSI during the extruding step, where the extrusion temperature and extrusion pressure are both measured at the die. In another such preferred method implementation, the extruder subjects the admixture to an extrusion temperature of at least 100 degrees Celsius, preferably at least 120 degrees Celsius and more preferably about 140 degrees Celsius at an extrusion pressure of at least 3500 PSI, preferably at least 4000 PSI, and more preferably at least 5000 PSI during the extruding step, where the extrusion temperature and extrusion pressure are both measured at the die.

The admixture is a starch-containing admixture that contains at least 35% starch by dry admixture weight, preferably at least 40% starch by dry admixture weight, more preferably at least 50% starch by dry admixture weight, most preferably at least about 60% starch (60%±15%) by dry admixture weight before any water is added to the admixture before carrying out the extruding step in the extruder. The admixture preferably has a moisture content of no greater than 22% by admixture weight, preferably no greater than 20% by admixture weight, more preferably no greater than about 17% by admixture weight (17%±3%), and most preferably no greater than about 15% by admixture weight (15%±2%) after any water is added to the admixture and before carrying out the extruding step in the extruder. A preferred admixture has a moisture content of no greater than 22% by admixture weight, preferably no greater than 20% by admixture weight, more preferably no greater than about 17% by admixture weight (17%±3%), and most preferably no greater than about 15% by admixture weight (15%±2%) before any water is added.

A preferred admixture includes starch from at least one cereal grain, such as starch from barley, corn, e.g., maize, oats, sorghum, and wheat. One such admixture is composed substantially completely of at least one cereal grain such as being substantially completely composed of barley, corn, oats, sorghum, and/or wheat. Another such admixture is composed substantially completely of at least one whole grain cereal grain such as being substantially completely composed of whole-grain barley, whole-grain corn, whole-grain oats, sorghum, and/or whole-grain wheat. One other preferred admixture includes or is composed of one of a whole grain cereal grain, a decorticated cereal grain, flour made from a whole grain cereal grain, grits made from a whole grain cereal grain, and/or meal made from a whole grain cercal grain. Another such preferred admixture includes or is composed of one of a whole grain cercal grain, a decorticated cereal grain, e.g., decorticated sorghum, flour made from a whole grain cercal grain, e.g., barley flour, corn flour, oat flour, sorghum flour and/or wheat flour, grits made from a whole grain cercal grain, e.g., barley grits, corn grits, oat grits, sorghum grits and/or wheat grits, and/or meal made from a whole grain cereal grain, e.g., barley meal, cornmeal, oatmeal, sorghum meal and/or wheat meal. If desired, the admixture can be composed of or also include starch from one or more legumes, such as lentils, peanuts, alfalfa, clover, as well as one or more pulse, such as kidney beans, lima beans, garbanzo beans, chickpeas, cow peas, black-eyed peas, one or more tubers, such as potatoes, yams, jicama, as well as one or more of sweet potatoes and/or cassava. One preferred admixture can be composed of one or more cercal grains, legumes, pulse, tubers, and/or sweet potatoes and/or cassava.

In a preferred method implementation, no water is added to the admixture during the extruding step, but water may be added prior to the extruding step to bring the moisture content of the admixture up to one of the aforementioned moisture percentages. In one preferred method implementation where the extruder is a single screw extruder, no water is added to the admixture during the extruding step, but water may be added prior to the extruding step to bring the moisture content up to one of the aforementioned moisture percentages. In one such preferred method implementation where the extruder is a single screw extruder, no water is added to the admixture prior to the extruding step nor during the extruding step.

As previously discussed, the extrudate is particle size reduced into clumping agent additive particles, such as by a rotary cutter as the extrudate exits the perforate die of the extruder. The extrudate is cut by the cutter into relatively small sized particles ranging in size from particles as small as 400 μm to granules as large as 2000 μm, preferably which range in size between about 450 μm and about 1800 μm, and more preferably between 500 μm and 1680 μm (which pass through a 12 US mesh sieve and which rest upon a 35 US mesh sieve (12/35 US mesh sieve)). After being cut to size to fall within an aforementioned particle size range or particle size distribution, the resultant clumping agent additive particles have a density of less than 25 pounds per cubic foot, preferably no greater than 20 pounds per cubic foot, and more preferably no greater than 17 pounds per cubic foot.

The result is a particulate litter additive that is a litter clumping agent additive of the present invention whose particles are water or urine sorbent, which also contain a clumping agent, and which during use are sprinkled on and/or mixed with (a) litter granules of a base litter while prepackaged in its litter container before being poured into a litter box, and/or (b) litter granules of the base litter already poured into the litter box either way producing a clumping agent additive enhanced litter of the present invention having improved and/or enhanced litter and clumping related features, characteristics, values and/or parameters compared to using the base litter alone without any particles of the additive as discussed in more detail hereinbelow.

The clumping agent additive is composed of particles, e.g., pellets, preferably extruded particles, e.g., such as preferably extruded pellets, with sizes ranging from particles as small as 400 μm to pellets as large as 2000 μm having a density less than 25 pounds per cubic foot for enabling the smaller particles of the clumping agent additive to work in concert with the larger existing litter granules of base litter in the litterbox to act as swelling and clump-facilitating plugs disposed in between the existing litter granules of the base litter on or adjacent the surface of the litter in the litter box that block downward passage of water or urine while the clumping agent additive particles substantially simultaneously release water soluble binder that causes clumping, where the base litter is a non-clumping litter, or facilitates better clumping, where the base litter is a clumping litter. The extruded particles are not only configured to act as plugs which block downward water or urine passage, but the clumping agent additive particles are also configured to swell when wetted in a manner which not only absorbs part of the water or urine, but which also enlarges them making their water or urine flow blocking or plugging action more effective. The extruded particles, e.g., pellets, have a water-soluble binder clumping agent in the form of a starch complex that includes starches modified during extrusion by the extrusion pressure in the extruder that the starches are subjected to during extrusion. At least some of the water-soluble binder in the extruded particles of the clumping agent additive with which the urine or water contacts will go into solution immediately upon being wetted with the water or urine traversing downwardly towards the bottom of the litterbox immediately thickening the water or urine increasing its viscosity beyond its normal viscosity of about 1 centipoise which in turn slows its downward flow. By slowing its downward flow, it increases the time with which it remains in contact not only with the extruded particles of clumping agent additive but also other litter granules. This not only causes the rate of flow to further slow from the release of additional water-soluble binder from the downwardly flowing urine or water contacting additional clumping agent additive particles, but this also increases its contact time with litter granules of the base litter thereby enabling more of the urine or water to be absorbed all of which increases litter efficiency compared to conventional litters lacking the extruded particles. Litter efficiency is defined as the amount or mass of litter required to absorb a given amount of urine or water divided by the amount or mass of the litter in the litter box. Increasing litter efficiency simply means that less litter, in this case less particles and granules, are required to absorb a predetermined given amount of water or urine than a different conventional litter. Greater litter efficiency means that a predetermined amount of litter in a litter box will last longer because less litter will be used each time a cat urinates in the litter in the litter box thereby requiring the litter box to be refilled less frequently saving the customer who purchased the litter money and time because it lasts longer. In a preferred clumping agent additive embodiment, the clumping agent additive has a particle size distribution that preferably is relatively uniform and which ranges from about 450 μm to about 1800 μm having a density no greater than 20 pounds per cubic foot and which more preferably ranges from 500 μm to 1680 μm or which pass through a 12 US mesh sieve and which rest upon a 35 US mesh sieve (12/35 US mesh sieve) and which have a density no greater than 17 pounds per cubic foot.

In the past, when a cat urinated onto litter granules of a base litter that was a clumping litter composed of sodium bentonite litter granules responsible for giving the base litter the ability to clump, the urine stream initially flows over and in between bentonite granules on and near the top of the litter before continuing to flow downwardly towards the bottom of the litterbox. Because other bentonite granules not directly in the path of the urine stream which become wetted by the urine are not pulled into the stream that continues to be discharged by the cat, it takes time for the bentonite granules directly in the path of the stream to swell enough to block the rest of the urine being discharged from cat to prevent it from flowing downwardly toward the bottom of the litterbox. This results in a clump formed of wetted bentonite granules of the granular bentonite clumping base litter that extend at least a plurality of layers deeper than a clump formed of clumping agent additive enhanced litter composed of particles of the clumping agent additive added to the same granular bentonite clumping base litter. This is because particles of the clumping agent additive (a) are lighter in density, enabling them to be more readily pulled into the urine stream to horizontally deflect the stream thereby reducing the amount and rate of downward urine flow, (b) swell more rapidly when wetted with urine than the urine-wetted bentonite granules further horizontally deflecting the urine stream thereby even further reducing the amount and rate of downward urine flow, (c) swell more when wetted with urine to occupy a significantly greater volume than the urine-wetted bentonite granules more completely plugging voids between and underneath bentonite granules on top and adjacent the top of the litter yet still further reducing the amount and rate of downward urine flow, (d) more rapidly absorb urine contacting the clumping agent particles even yet still further reducing the amount and rate of downward urine flow, and (c) release at least partially water-soluble clumping agent that increases in viscosity thereby slowing the flow of urine in any direction, much less downwardly, helping contain the urine and the clump formed by the urine closer to the top producing a smaller, denser and more efficient clump having a higher clump retention rate as discussed elsewhere herein. To put it another way, this smaller, denser, more efficient and higher clump retention rate clump is formed closer to the top of the litter as a result of the clumping agent additive enhanced litter of the present invention getting pulled into the stream more quickly deflecting the stream of urine horizontally, more quickly swelling a greater amount to more quickly plug voids and channels between adjacent bentonite granules along the top and just below the top of the litter, and forming an at least partially water-soluble binder that is released into the stream whose viscosity relatively rapidly increases until it gels or forms a gel.

As a result, a granular sodium bentonite clumping base litter having much larger sized bentonite granules can advantageously be used with the clumping agent additive to produce a clumping agent additive enhanced litter that tracks less and produces less dust during use by a cat of the clumping agent additive enhanced litter in a litterbox (compared to the same base litter used alone or by itself without any particles of the clumping agent additive added to it or mixed with it). As a further result, such a granular sodium bentonite clumping base litter can also be made with a greater percentage of filler granules made of one or more filler materials that also advantageously reduces the overall cost of the litter to the consumer or user of the litter.

The clumping agent additive formed from the extrudate preferably is in the form of an extruded organic starch-containing particulate material that is configured for being shaken on and mixed with a base litter in its prepackaged form in a litter container and/or already poured into litterbox forming a multicomponent clumping agent additive enhanced litter that imparts an ability to the multicomponent litter to form clumps when wetted with water or urine, where the existing litter is a non-clumping litter, e.g., a calcium bentonite litter, and enhances the ability of the multicomponent litter to form clumps when wetted with water or urine by one or more of the following: increasing clump retention rate, increasing clump crush strength, increasing the rate or speed of clump formation, decreasing clump size, increasing clumping efficiency and/or increasing litter efficiency compared to the same characteristic of the litter when used without the clumping agent additive. Clumping efficiency is advantageously increased by making a clump formed of water or urine wetted clumping agent additive particles and litter granules of the base litter of clumping agent enhanced litter denser than a clump formed only of granules of the base litter, which thereby advantageously also increases clump retention rate and clump compressive or crush strength of clumps formed using the clumping agent additive enhanced litter compared to clumps formed using only the base litter (without the base litter containing any particles of extruded clumping agent additive).

The use of the clumping agent additive preferably also produces clumps containing a mixture of the clumping agent additive and granules of the base litter in the litterbox that exhibits an increase of at least 3% in clump retention rate, preferably an increase of at least 5% in clump retention rate, and more preferably at least 7% in clump retention rate compared to the clump retention rate of a clump made from a clumping base litter used by itself without the clumping agent additive. A clumping agent additive enhanced litter of the present invention also produces clumps have increased crush strength compared to clumps formed using only a clumping base litter preferably having an increased crush strength of at least 5 PSI, preferably at least 10 PSI, more preferably at least 50 PSI, even more preferably at least 100 PSI and even more preferably at least 150 PSI greater than the crush strength of clumps formed only of the clumping base litter before the addition of any clumping agent additive to the base litter.

A clumping agent additive enhanced litter of the present also forms clumps composed of at least a plurality of pairs, i.e., at least three, of water or urine wetted litter granules of base litter and at least a plurality of pairs, i.e., at least three, of water or urine wetted clumping agent additive particles faster, preferably at least 10% faster, preferably at least 15% faster, and more preferably at least 20% faster than clumps formed only of wetted litter granules of the base litter (before and without any clumping agent additive particles added to the base litter). The clumps of such a clumping agent additive enhanced litter of the present also forms clumps are also at least 10% smaller, preferably at least 15% smaller and at least 20% smaller than clumps than clumps formed only of wetted litter granules of the base litter because the clumps formed with the clumping agent additive enhanced litter is at least 5% denser, preferably at least 10% denser and more preferably at least 15% denser than clumps formed with the base litter without any particles of the clumping agent additive added thereto or otherwise mixed therewith. By increasing the rate or speed of clump formation while simultaneously decreasing clump size when the clumping agent additive is used compared to when it is not used, clumping efficiency is advantageously increased by at least 5%, preferably at least 10% and more preferably at least 15% compared to the base litter that does not contain any clumping agent additive particles. Clumping efficiency is increased by the resultant clump formed of wetted extruded particles and wetted litter granules being denser than a clump formed only of the litter granules, which advantageously means that the clump retention rate and clump crush or compressive strength of the resultant clump formed of the wetted extruded particles and wetted litter granules are greater than for a clump formed only of the wetted litter granules. By increasing clumping efficiency when the clumping agent additive is used compared to what it is not used, the use of the clumping agent additive also increases litter efficiency because less litter is used to form a clump compared to when the clumping agent additive is not used. This advantageously results in less litter being used to form clumps over a given or predetermined period of time when the clumping agent additive of the present invention is used compared to when it is not used which of course beneficially lowers the actual cost or total cost of using a clumping agent additive enhanced litter of the present invention compared to using the base litter alone without any particles of clumping agent additive added thereto or mixed therewith.

In a preferred embodiment, the clumping agent additive formed from the clumping agent additive extrudate extruded under an ultrahigh extrusion pressure as discussed hereinabove and hereinbelow includes or has (a) a first constituent that is or includes a one-time moisture activated one-time moisture cured binder, and (b) a second constituent that is or includes a moisture reactivating moisture recuring binder configured to be moisture activated and moisture cured a plurality of times. A preferred clumping agent additive formed from the extrudate in carrying out a preferred method of making clumping agent additive in accordance with the present invention includes or has (a) a first constituent that is or includes a one-time water activated one-time water cured binder that can be and preferably is at least partially water soluble and more preferably is at least partially cold water soluble, and (b) a second constituent that is or includes a water reactivatable water re-curable or water reactivating water recuring binder configured to be water activated and water cured a plurality of times that can also be and preferably is at least partially water soluble and which more preferably is at least partially cold water soluble. In one such preferred embodiment, the clumping agent additive includes or has a third constituent that is or includes a water sorbent, preferably a water absorbent, which preferably is configured to sorb, more preferably absorb, water.

In one preferred embodiment, the clumping agent additive is an extruded clumping agent additive that contains at least 5% of the first constituent, preferably at least 7.5% of the first constituent, and more preferably at least 10% of the first constituent. In one preferred embodiment, the clumping agent additive contains at least 5% of the second constituent, preferably at least 7.5% of the second constituent, and more preferably at least 10% of the second constituent. In another preferred embodiment, the clumping agent additive contains at least 5% of the first and second constituent, preferably at least 7.5% of the first and second constituent, and more preferably at least 10% of the first and second constituent. Where the clumping agent additive has a third constituent, the clumping agent additive contains at least 5% of the third constituent, preferably at least 7.5% of the third constituent, and more preferably at least 10% of the third constituent. In still another preferred embodiment, the clumping agent additive contains at least about 5% of the first, second and third constituent, preferably at least about 7.5% of the first, second and third constituent, and more preferably at least about 10% of the first, second and third constituent.

The first constituent is formed of or includes a cold-water soluble starch that is at least partially water soluble at a room temperature of between 68 degrees Fahrenheit and 72 degrees Fahrenheit. The first constituent is formed of or includes an extrusion-modified starch that is or includes starch in the admixture that is modified during the extruding step. The first constituent is formed of or includes extrusion-modified starch which is from or includes starch in the admixture modified by ultrahigh pressure extrusion into the extrusion modified starch of the first constituent. In one preferred embodiment, the first constituent is formed of or includes an extrusion-modified amylopectin starch. In another preferred embodiment, the first constituent is formed of or includes an extrusion-modified amylose starch.

The second constituent also is formed of or includes a cold-water soluble starch that is at least partially water soluble at a room temperature of between 68 degrees Fahrenheit and 72 degrees Fahrenheit. The second constituent is formed of or includes an extrusion-modified starch that is or includes starch in the admixture that is modified during extruding step. The second constituent is formed of or includes extrusion-modified starch which is from or includes starch in the admixture modified by ultrahigh pressure extrusion into the extrusion modified starch of the second constituent. In one preferred embodiment, the second constituent is formed of or includes an extrusion-modified amylopectin starch. In another preferred embodiment, the second constituent is formed of or includes an extrusion-modified amylose starch.

The third constituent also is formed of or includes a cold-water soluble starch that is at least partially water soluble at a room temperature of between 68 degrees Fahrenheit and 72 degrees Fahrenheit. The third constituent is formed of or includes an extrusion-modified starch that is or includes starch in the admixture that is modified during the extruding step. The third constituent is formed of or includes extrusion-modified starch which is from or includes starch in the admixture modified by ultrahigh pressure extrusion into the extrusion modified starch of the third constituent. In one embodiment, the third constituent is formed of or includes an extrusion-modified amylopectin starch. In another embodiment, the third constituent is formed of or includes an extrusion-modified amylose starch.

These and various other features, aspects, and advantages of the present invention will be made apparent from the following descriptions of the drawings.

### DESCRIPTION OF THE DRAWINGS

One or more preferred exemplary embodiments of the invention are illustrated in the accompanying drawings in which like reference numerals represent like parts throughout and in which:

FIG. 1 is an elevation view illustrating particles of a particulate litter clumping agent additive of the present invention being dispensed from a shaker-type dispenser onto granules of a granular litter in a litter box shown in fragmentary cross-section;

FIG. 2 is a fragmentary cross-sectional view of litter granules in a litter box after particles of the clumping agent additive have been added and mixed therewith producing a clumping agent additive enhanced clumping litter of the present invention also illustrating a clump of the clumping agent additive particles and litter granules formed on top of the litter from wetting them with urine, water or another aqueous liquid;

FIG. 3 is a perspective view the shaker-type dispenser and a tub of litter holding granules of a litter prepackaged in the tub illustrating dispensing of particles of clumping agent additive into the mouth or opening of the tub for mixing with the granules of the prepackaged litter to produce a litter clumping agent additive enhanced clumping litter;

FIG. 4 is a perspective view of a clumping agent additive dispensing container equipped with a dispenser opening formed with a screw-on coupling configured for threadably mating with a threaded neck of a litter dispensing opening of a tub of prepackaged litter;

FIG. 5 is a perspective view of the shaker dispenser and a litter bag holding granules of prepackaged litter illustrating dispensing particles of the clumping agent additive into the litter bag for mixing with granules of the litter prepackaged therein producing a litter clumping agent additive enhanced clumping litter of the invention;

FIG. 6 is an RVA graph of RVA curves for a first set of samples of a first preferred embodiment of an extruded litter clumping agent additive of the present invention made using an approximately 50 hp single screw extruder and being hydrated once and before being rehydrated;

FIG. 7 is an RVA graph of RVA curves for the first set of samples of the first preferred embodiment of the extruded litter clumping agent additive of the present invention made using the approximately 50 hp single screw extruder after being hydrated, dried and then rehydrated;

FIG. 8 is an RVA graph of RVA curves for a second set of samples of a second preferred embodiment of an extruded particulate litter clumping agent additive made using an approximately 100 hp single screw extruder after being hydrated a single time and before being rehydrated;

FIG. 9 is an RVA graph of RVA curves for the second set of samples of the second preferred embodiment of the extruded litter clumping agent made using the approximately 100 hp single screw extruder after being hydrated once, dried and then rehydrated;

FIG. 10 is an RVA graph of RVA curves for a third set of samples of a third preferred embodiment of an extruded litter clumping agent additive made with the approximately 100 hp single screw extruder after being hydrated once and before being rehydrated; and

FIG. 11 is an RVA graph of RVA curves for the third set of samples of third preferred embodiment of the extruded litter clumping agent additive made with the approximately 100 hp single screw extruder after being hydrated once, dried and rehydrated.

While preferred embodiments of a method of making self-clumping litter using a granular non-clumping particles in accordance with the present invention have worked with as many types of granular non-clumping substrates as has been tried to date, it is contemplated that the litter making methods of the present invention will also work with many other types of particles, both non-clumping and clumping particles.

Before explaining one or more embodiments of the invention in detail, it is to be understood that the invention is not limited in its application to the details of construction and the arrangement of the components set forth in the following description and illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION

### Definitions

Before explaining one or more embodiments of the invention in detail, it is to be understood that the invention is not limited in its application to the details of construction and the arrangement of the components set forth in the following description and illustrated in the drawings. The invention is capable of other embodiments or being practiced or carried out in various ways.

Before the present materials, products and methods are described hereinbelow, it is to be further understood that this invention is not limited to the particular methodology, protocols, materials, and reagents described, as these may vary. It is also to be understood that the terminology used herein is for the purpose of describing particular embodiments only and is not intended to limit the scope of the present invention, which will be limited only by the appended claims.

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, and “having” can be used interchangeably.

For purposes of the present invention, terms which indicate direction, such as “top,” “bottom,” “upper,” “lower,” “above,” “below,” “left,” “right,” “horizontal,” “vertical,” “up,” “down,” and the like, as well as terms which indicate positioning and orientation are merely used for convenience in describing the various embodiments of the present invention. The embodiments of the present invention also may be oriented in various ways. For example, the diagrams, apparatuses, etc., shown in the drawing figures may be flipped over, rotated by ninety (90) degrees in any direction, reversed, mirror imaged, etc.

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are now described. All publications and patents specifically mentioned herein are incorporated by reference for all purposes including describing and disclosing the ingredients, reagents, chemicals, devices, manufactures, statistical analysis and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

Where the definition of any of the following terms departs from the commonly used meaning of the term, applicant intends to utilize the definitions provided below, unless specifically indicated.

For purposes of the present invention, a value or property is “based” on a particular value, property, the satisfaction of a condition or other factor, if that value is derived by performing a mathematical calculation or logical decision using that value, property, or other factor.

For purposes of the present invention, the term “blend” refers to a uniform or substantially uniform mixture of two or more solid materials. One or more materials in a blend may be coated.

For purposes of the present invention, the term “substantially uniform” refers to a mixture that has substantially the same density throughout the mixture.

For purposes of the present invention, the term “uniform” refers to a mixture of two or more solid materials wherein a measured density of the composition for ten or more samples of the mixture has a standard deviation of no greater than 2.0 lbs/ft³ throughout the mixture. One or more of the solid materials may be coated.

For purposes of the present invention, the term “uniform blend” refers to a blend that is uniform.

For purposes of the present invention, the term “uniform mixture” refers to a mixture that is uniform.

For purposes of the present invention, the terms “wetting agent” or “wetting liquid” refers to a liquid that wets granules and particles of litter, which can be particles, preferably sorbent particles, of clumping agent additive as well as litter granules that are sorbent, non-sorbent or even liquid impermeable and which can be granules of a clumping sorbent material, e.g., sodium bentonite, a non-clumping sorbent material, e.g., calcium bentonite, or even a filler material composed of cellulose, e.g., wood or paper, perlite, plastic, glass, or the like. Examples of wetting agents or wetting liquids include liquids such as water, urine, synthetic urine, an aqueous liquid, e.g., an aqueous liquid containing urine and/or liquid fecal matter, and the like which contact the litter granules and litter particles such as during use and testing of litter.

For purposes of the present invention, the term “cellulose-containing material” refers to a material in which at least 10% or more of the material is composed of cellulose. Examples of cellulose-containing materials include paper, wood fiber, sawdust, fibers, hulls, etc.

For purposes of the present invention, the term “clumping additive” refers to a clumping agent other than sodium bentonite.

For purposes of the present invention, the term “clumping agent” refers to a material that causes granules containing the clumping agent additive to clump together when wetted with a wetting agent forming a cohesive clump of at least a plurality of pairs, i.e., at least three, of the wetted granules that becomes substantially hard when dried to a moisture content of no greater than 15% by weight of the hardened clump.

For purposes of the present invention, the term “clump strength” refers to the numerical value of average clump compressive strength in pounds per square inch (psi) for a clump that has been dried to a moisture content of no greater than about 12% and crushed while measuring compressive or crush strength.

For purposes of the present invention, the term “filler” and the term “filler material” refer to a material in a litter product other than a clumping agent, i.e., other than sodium bentonite or a clumping additive. In one embodiment of the present invention, a filler material may be calcium bentonite. In another embodiment of the present invention, the filler material may be sand. In a further embodiment of the present invention, the filler material may be a cellulose-containing material.

For purposes of the present invention, the term “fines” refers to particles that are generally smaller than 1/32 inch (≈800 microns) but larger than 2/125 inch (≈400 microns) which pass through a #20 US Mesh screen or sieve and which stand on a #40 US Mesh screen or sieve.

For purposes of the present invention, the term “flour” refers to particles smaller than fines and which pass through a #40 US Mesh screen or sieve.

For purposes of the present invention, the term “fragrance” is a compound configured to give off an odor that is perceived as a pleasant smell and/or is a compound such as in the form of a masking fragrance that neutralizes or hides an odor that is unpleasant or undesirable. The term “fragrance” can refer to a coating comprising a fragrance such as by being added to a coating or by the fragrance itself being a coating. A fragrance coating may include one or more other constituents or components.

For purposes of the present invention, the term “granular” refers to a solid material having a particle size below two (2) mesh. A solid material used in a mixture of the present invention may be ground to form a granular material.

For purposes of the present invention, the term “granular filler” and the term “granular filler material” refer to a filler that is granular.

For purposes of the present invention, the term “heterogeneous mixture” refers to a composition in which the components of the mixture may be readily separated from each other.

For purposes of the present invention, the term “homogeneous mixture” refers to a composition that is uniform.

For purposes of the present invention, the term “mixture” refers to a composition comprising two or more different components that are mixed but not combined chemically. An individual component of a heterogenous mixture may comprise two or more substances that are combined chemically, such as a filler material that is coated with a sorbent swelling and gelling starch-containing biopolymeric clumping agent of the present invention.

For purposes of the present invention, the term “non-calcium bentonite clay” refers to a clay other than calcium bentonite. Because a filler material cannot be sodium bentonite, a “non-calcium bentonite clay” cannot be sodium bentonite.

For purposes of the present invention, the term “removably clumpable” refers to a litter that, when exposed to a wetting agent or wetting liquid forms a clump comprised of at least a plurality of pairs of granules of the litter having a firmness of sufficient structural integrity and hardness to withstand mechanical separation from unwetted litter for disposal and which has a clump retention rate of at least 98%, preferably at least 99%, when a clump of the litter granules is drop tested in accordance with the Standard Litter Drop Test defined hereinbelow.

### INTRODUCTION

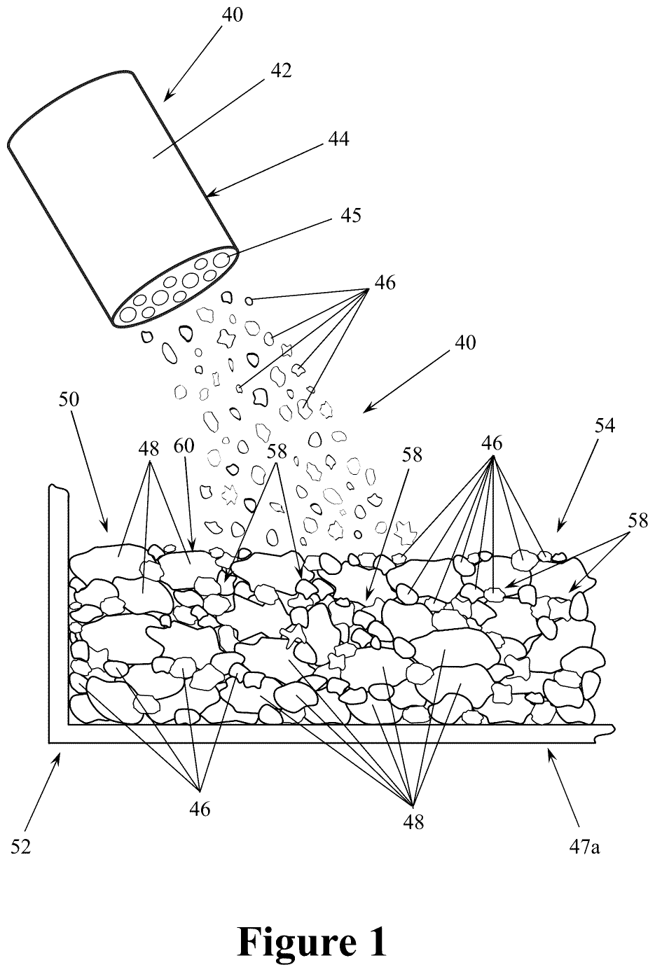

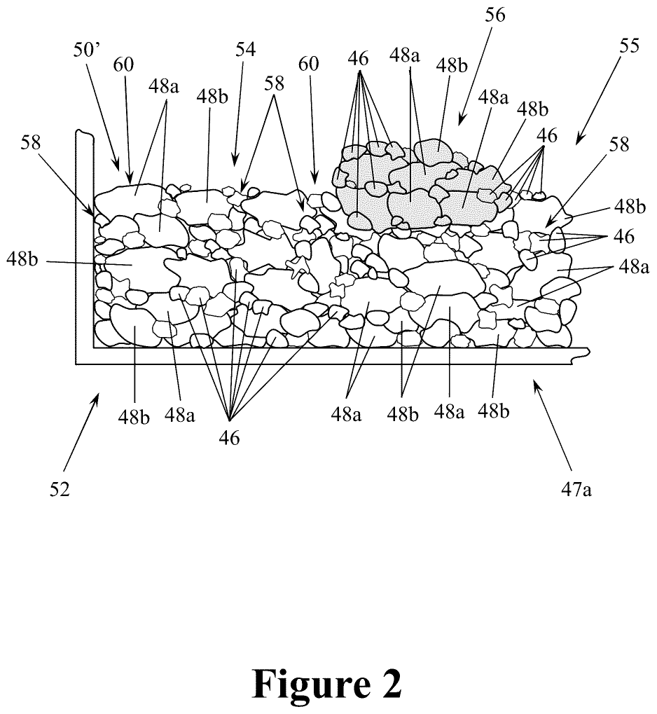

With reference to FIG. 1, the present invention is directed to a particulate clumping agent additive 40 in a clumping agent additive dispensing container 42, such as preferably a perforate shaker 44 having a perforated dispensing end 45, configured for being manually shaken, such as by a person who is a pet owner, to add particles 46 of the additive 40 to granules 48 of litter 50 in a litter-holding container 47a that is a litter box 52 in the manner depicted producing a clumping agent additive enhanced litter 54 of the invention. Litter 50, also referred to herein as base litter 50, is a preexisting litter or litter formulation, such as a commercially available litter formulation, which comes prepackaged in a litter container from a retail or online store containing litter granules 48 of at least one type with the litter 50 modified with the addition of the clumping agent additive particles 46 into an enhanced clumping litter 54 of the present invention which improves clumping, where the litter 50 is/was a clumping litter, and which becomes self-clumping that forms clumps when wetted with urine, water or an aqueous liquid, where the litter 50 is/was a non-clumping litter. As also discussed below, the particulate clumping agent additive 40 can also be added to a base litter that is a multicomponent litter 50′ like that depicted in FIG. 2 which contains a plurality of different types of litter granules 48a, 48b. Granules 48a, 48b include clumping litter granules, such as clumping granules composed of sodium bentonite, a gum, e.g., guar gum, or another clumping material, and/or non-clumping litter granules, such as non-clumping litter granules composed of a sorbent material, e.g. calcium bentonite, a filler material, e.g. a cellulosic material such as wood or paper, and/or another type of material that can be an antibacterial material, an antifungal material, a scented material, or another type of material commonly used in litter.

As also discussed elsewhere herein, the addition of particles 46 of clumping agent additive 40 to granules 48 of base litter 50 or to granules 48a and/or 48b of multicomponent base litter 50′ produces a clumping enhanced litter 54 in accordance with the present invention with at least one clumping property, such as one or more of the ability to clump, clump retention rate, clump crush strength, clumping efficiency, and/or clump density, which is improved over the base litter 50 or 50′ compared to before the addition of the clumping agent additive particles 46 thereto. In one or more preferred embodiments, addition of particles 46 of clumping agent additive 40 to granules 48 of base litter 50 or to granules 48a and/or 48b of multicomponent base litter 50′ produces a clumping litter 54 in accordance with the present invention with at least one property of the litter 54, such as one or more of bulk density, efficiency, absorption, or the like that also is improved over the base litter 50 or 50′ before the addition of the clumping agent additive 40 thereto.

FIG. 1 also illustrates a method of making and using clumping agent additive enhanced litter 54 of the present invention by dispensing clumping agent additive particles 46 from dispenser 42 disposed above granules 48 of litter 50 in litter box 52 onto the litter granules 48 of in the box 52 distributing the particles 46 along and in between granules 48 in the box 52. Particles 46 preferably become substantially uniformly distributed throughout at least a plurality and preferably at least a plurality of pairs, i.e. at least three, of the uppermost layers of the granules 48 of the litter 50 in the box 52. The particles 46 preferably are smaller than the granules 48 enabling particles 46 to become relatively uniformly distributed in voids between adjacent granules 48 and/or underneath granules 48 disposed along at least a plurality of pairs of the uppermost layers of the granules 48 of the litter 50 in the litter box 52. The method contemplates agitating or shaking box 52 to facilitate mixing of the particles 46 with the granules 48 of the pre-existing litter 50 in making clumping enhanced litter 54 of the present invention.

In one implementation of a method of making and using litter 54, the clumping agent additive particles 46 become substantially uniformly distributed throughout the granules 48 of the base litter 50 using a scoop (not shown) to stir, agitate and/or blend the granules 48 and particles 46 together in a manner that preferably substantially uniformly distributes the particles 46 amongst and between the granules 48 along at least a plurality of pairs of layers along and adjacent the top of the litter 50 in the box 52. In another implementation of a method of making and using the litter 54, the granules 48 and/or the litter 54 can be agitated, such as by shaking or vibrating the litter box 52, in a manner that substantially uniformly distributes the particles 46 throughout the granules 48 base litter 50 at least along a plurality of pairs of layers of the granules 48 disposed on, along and immediately underneath the top of the litter 54 in the box 52. In yet another implementation of a method of making and using the litter 54, a rake or the like (not shown), can be used to help substantially uniformly distributes the particles 46 along and in between the granules 48 of at least a plurality of pairs of the uppermost layers of the base litter 50 present in the litter box 52 before the particles 46 of clumping agent additive 40 are added thereto. A presently preferred method of making and using litter 54 contemplates doing one or more of (a) using a scoop, (b) agitating or vibrating the litter box, (c) using a rake or raking, or any combination thereof to mix and/or blend the particles 46 with the litter granules 48 of the base litter 50 in a manner that preferably substantially uniformly distributes the particles 46 along in in between granules 48, including along and/or in between adjacent granules 48, in a manner that fills voids between adjacent granules 48 and underneath granules 48 for at least a plurality of pairs of layers of granules 48 along the top of the litter 50 as well as immediately underneath the top of the litter 50.

FIG. 2 depicts a clumping agent additive enhanced litter 54 of the present invention formed by adding clumping agent additive particles 46 to a preexisting multicomponent litter 50′, e.g., a base multicomponent litter 50′ which includes prepackaged litter sold in a retail store, having a plurality of different types of litter granules 48a and 48b. FIG. 2 illustrates a clump 56 formed on top of clumping enhanced litter 54 produced by wetting at least a plurality of pairs, i.e. at least three, of the clumping agent additive particles 46, at least a plurality of pairs of litter granules 48a, and at least a plurality of pairs of litter granules 48b with urine, water or an aqueous liquid. Where all of the granules 48a, 48b of litter 50′ are non-clumping litter granules such that the multicomponent base litter 50′ is a non-clumping litter, adding a sufficient amount of clumping agent additive particles 46 to the litter 50′ produces a clumping agent additive enhanced litter 54 in accordance with the present invention that now is a clumping litter that forms a clump 56, preferably on top of the litter 54, when at least a plurality of pairs of particles 46, at least a plurality of pairs of granules 48a, and at least a plurality of pairs of granules 48b are wetted with urine, water or an aqueous liquid, such as depicted in FIG. 2. Clump 56 preferably possesses good clumping properties, preferably good clumping parameters, in accordance with that discussed elsewhere herein with respect to clump retention rate, clump crush or compressive strength, clump density, and/or clumping efficiency. Where the multicomponent litter 50′ is a clumping litter having one or more of its litter granules 48a and/or 48b being a clumping granule preferably at least partially or substantially composed of a clumping material, such as sodium bentonite, a gum, e.g., guar gum, or the like, adding clumping agent additive particles 46 to such a clumping multicomponent base litter 50′ produces a clumping enhanced litter 54 in accordance with the present invention that forms a clump 56, when at least a plurality of pairs of particles 46, at least a plurality of pairs of granules 48a, and at least a plurality of pairs of granules 48b wetted with water or urine, that has one or more improved clumping properties, one or more improved clumping parameters and/or one or more improved clumping parameter values as discussed elsewhere herein compared to a clump formed by wetting at least a plurality of pairs of granules 48a and at least a plurality of pairs of granules 48b of the base litter 50′ prior to the addition of any clumping agent additive particles 46.

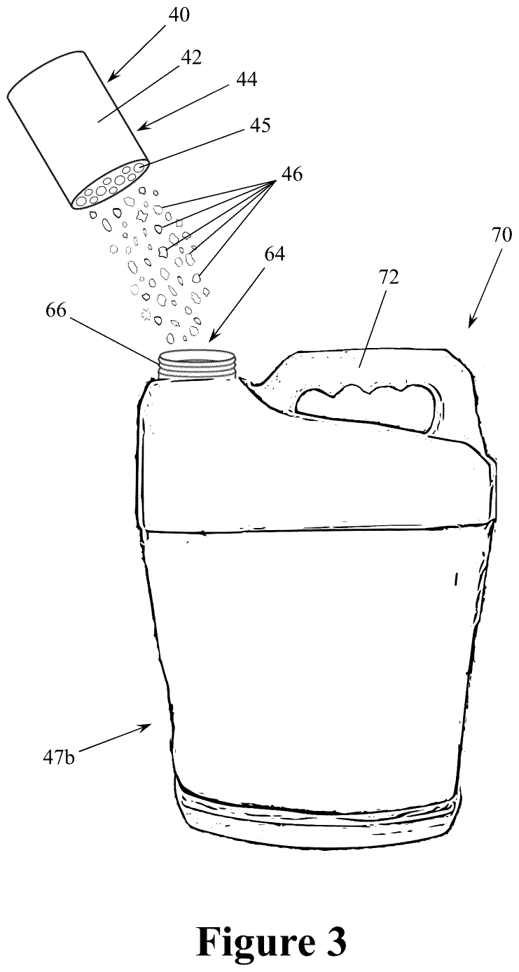

FIG. 3 illustrates a method of making clumping agent additive enhanced litter 54 by dispensing particles 46 from dispenser 42 into a mouth 64 of a threaded neck 66 of another type of litter-holding container 47b that is a plastic litter holding container 68, such as preferably a jug 70, substantially completely filled, i.e., prepackaged, with granules 48 of base litter 50 or granules 48a, 48b of multicomponent litter 50′. The jug 70 can be agitated, such as by being shaken, e.g., by manually grasping its handle 72 and shaking the jug 70, during and after dispensing particles 46 from dispenser 42 through the mouth 64 into the jug 70 onto granules 48 or granules 48a, 48b in the jug 70 to blend, mix or facilitate mixing or blending the particles 46 with the granules 48 or the granules 48a, 48b in a manner that substantially uniformly distributes the particles 46 throughout the litter 50 or 50′ within the jug 70. When mixing or blending in this manner is completed, the pre-existing litter 50 or 50′ is transformed by the addition of the clumping agent additive particles 46 into a clumping agent additive enhanced litter 54 of the present invention that remains disposed within litter jug 70 ready to be poured out into litter box 52 and used as cat or animal litter. When the litter 54 is poured into a litter box, e.g., box 52, a method of using the litter 54 contemplates further mixing or blending the particles 46, granules 48 and/or granules 48a, 48b in a manner that even more uniformly distributes the particles 46 throughout and between the granules 48 and/or granules 48a, 48b. In one preferred implementation of a method of using litter 46, pouring of the litter 46 into box 52 agitates, further mixes and/or further blends the particles 46 with the granules 48 and/or granules 48a, 48b producing a litter 46 that advantageously is substantially homogenous mixture thereof all throughout the litter box 50.

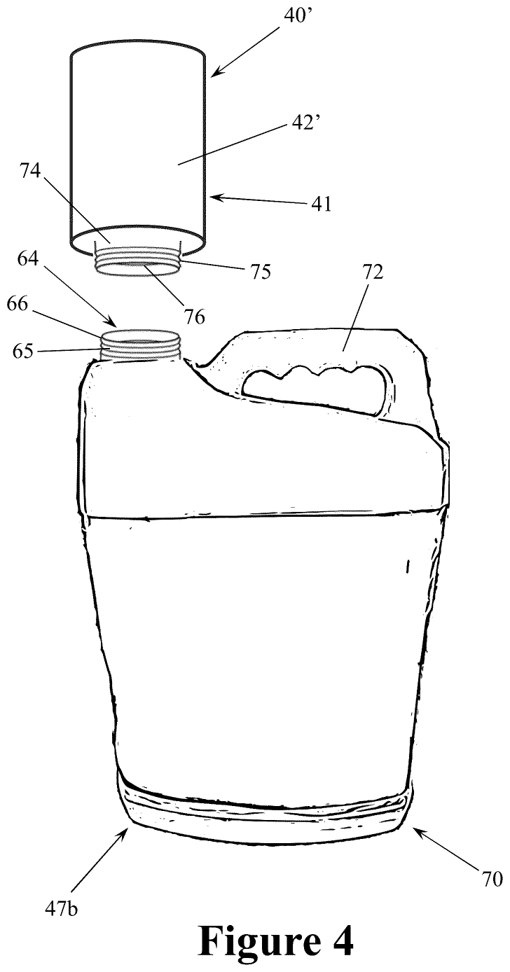

FIG. 4 depicts a clumping agent additive dispenser 42′ that is a threadably-coupled pour-type dispenser 41 with an externally threaded neck 74 with internal threads 76 configured to releasably threadably couple with external threads 65 of the threaded neck 66 of jug 70 to dispense particles 46 into the jug 70 after the internally threaded neck 74 of dispenser 42′ is manually threaded onto the externally threaded neck 66 of the jug 70 threadably coupling and scaling the dispenser 42′ to the jug 70. In use, the cap (not shown) of the dispenser 42′ and the cap (not shown) of the jug 70 are removed and the dispenser 42′ manipulated by a user so its internally threads 76 of its neck 74 threadably engages the external threads 65 of the neck 66 of the jug 70. As is also shown in FIG. 4, the neck 74 of the dispenser 42′ also has external threads 75 to configure the neck 74 for receiving a removable cap (not shown). Thereafter, preferably the entire contents of clumping agent additive particles 46 are emptied from the dispenser 42′ into the jug 70 causing the particles 46 to blend in or mix with the granules 48 or granules 48a, 48b inside the jug 70 producing a preferred embodiment of an enhanced clumping agent additive litter 54 in accordance with the present invention. If desired, to facilitate more complete blending or mixing, the jug 70 can be manually agitated or shaken during or after pouring the particles 46 from the dispenser 42′ into the jug 70.

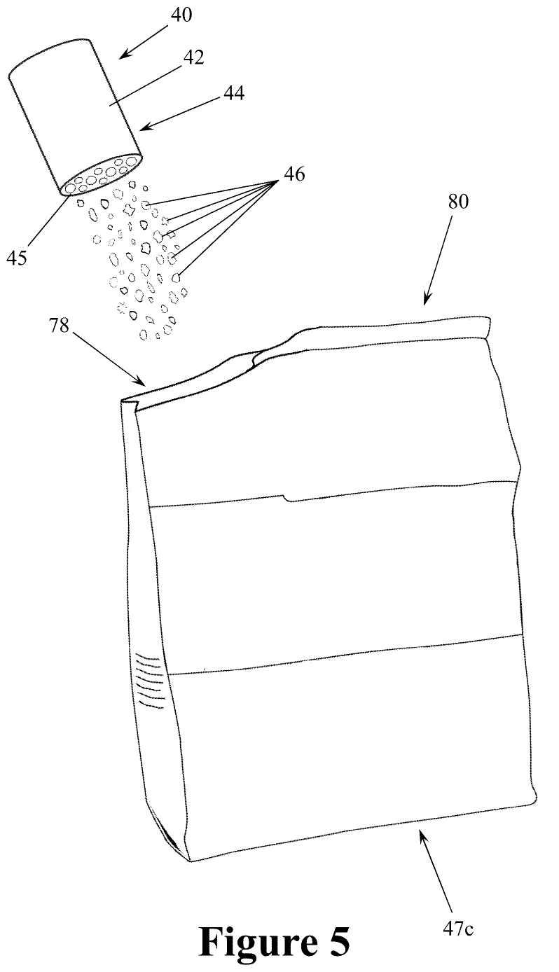

FIG. 5 illustrates a dispenser 42 used to dispense clumping agent additive particles 46 into an opening 78 in a further type of litter holding container 47c that preferably is a litter holding bag 80, e.g., bag of litter, which is substantially completely filled with granules 48 of litter 50 or granules 48a, 48b of multicomponent litter 50′.

In a preferred embodiment, the clumping agent additive container, e.g. shaker 44 or threadably-coupled pour-type dispenser 41, has a large enough particle-holding volume within to hold enough particles 46 to provide the enhanced clumping agent additive litter 54 with at least about 10%, preferably at least about 25%, and more preferably at least about 35% of clumping agent additive particles 46 by weight of the resultant litter 54 made therewith. While the clumping agent additive container can be a generally cylindrical substantially rigid can or tube, like that shown in FIGS. 1 and 3-5, the container can also be in the form of a packet, pouch or bag (not shown) of substantially flexible sidewall construction having a size, e.g. volume or volumetric size, that holds enough of the particles 46 dispensed therefrom and mixed with pre-existing base litter 50 or 50′ to produce a clumping agent additive enhanced litter 54 which contains at least about 10%, preferably contains at least about 25%, and which more preferably contains at least about 35% of particles 46 by weight of the resultant litter 54.

Where the base litter 50 or 50′ is a clumping litter, a preferred implementation of a method of making and using enhanced clumping agent additive litter 54 of the present invention uses an amount or weight percentage of clumping agent additive particles 46 of at least 5%, preferably at least 10%, more preferably at least 20%, even more preferably at least 25%, and yet even more preferably at least 30% and preferably no more than about 40% by weight of litter 54, which is sufficient to produce clumps when wetted with water or urine that have at least one clumping property, such as one or more of a clump retention rate, clump density, clumping efficiency, and/or clump crush strength, which is improved over clumps made with the preexisting, prepackaged clumping base litter 50 or 50′ before adding particles 46 thereto. Where the base litter 50 or 50′ is a non-clumping litter, a preferred implementation of a method of making and using clumping agent additive enhanced litter 54 of the present invention uses an amount or weight percentage of clumping agent additive particles 46 of at least 25%, preferably at least 30%, more preferably at least about 35%, and preferably no more than about 50% by weight of litter 54, which is sufficient for the litter 46 resulting from the blending or mixing of (a) the particles 46 with the non-clumping granules 48 of base litter 50, or (b) the particles 46 with the non-clumping granules 48a, 48b to form a clump when at least a plurality of pairs of the particles 46, at least a plurality of pairs of granules 48 and at least a plurality of pairs of granules 48a and/or 48b are wetted with water or urine. Such a litter 54 resulting from the blending or mixing of particles 46 with granules 48 of non-clumping base litter 50 or granules 48a, 48b of non-clumping multicomponent base litter 50′ preferably has a clump retention rate of at least 90%, preferably at least 95%, more preferably at least 97% and a clump crush strength of at least 100 PSI, preferably at least 200 PSI and more preferably at least 300 PSI when tested in accordance with the corresponding clump retention rate and clump crush strength test procedures set forth below. Whether the base litter 50 or 50′ is a clumping litter or non-clumping litter, the corresponding resultant litter 54 preferably also has at least one litter property, such as one or more of litter efficiency, bulk density, litter absorbency, or another litter property, which is improved over the same litter property or litter properties of the original base litter 50 or 50′ before adding any particles 46 thereto.

With reference once again to FIG. 1, the present invention contemplates use of the particles 46 of clumping agent additive 40 that preferably is an extruded clumping agent additive 40 with pre-existing litters 50, e.g., pre-existing or commercially available litter formulations 50, such as those sold in retail stores, having at least one type of litter granule 48, such as preferably a liquid, e.g., water, absorbent granule, which can be a non-clumping litter granule, such as partially or substantially completely composed of calcium bentonite, perlite, wood, paper, another type of cellulose, or another type of non-clumping material, or can be a clumping litter granule, such as partially or substantially completely composed of sodium bentonite, a gum, e.g. xanthan gum, or another type of clumping material. Although not shown in FIG. 1, litter 50 can also include one or more filler particles as known in the art. With reference once again to FIG. 2, the pre-existing litter 50′ can be a multicomponent litter 55 like that depicted in FIG. 2 composed of at least a plurality of different types of litter granules 48a, 48b having one of the types of the litter granules 48a made of or containing one type of material and another one of the types of the litter granules 48b made of or containing one type of material. At least one of the different types of litter granules 48a, 48b are water absorbent, is a clumping litter granule composed at least partially of a clumping material, e.g. sodium bentonite, a gum, e.g. xanthan gum, or another type of clumping material, or is a non-clumping litter granule composed at least partially of a non-clumping material, e.g. calcium bentonite, perlite, wood, paper, another type of cellulose, or another type of non-clumping material. Such a multicomponent litter 50′ can also include one or more types of filler particles (not shown) blended together with granules 48a, 48b.

Where the pre-existing litter 50 is a clumping litter, adding the clumping agent additive particles 46 thereto produces an enhanced clumping litter 54 with improved clumping compared to the original preexisting litter 50 to which the particles 46 are added by improving, preferably by increasing, at least one of the following clumping parameters: (a) clump retention or clump retention rate, and/or (b) clump crush or compressive strength. In a preferred enhanced clumping litter embodiment and method of making enhanced clumping litter in accordance with the present invention, adding at least 10%, preferably at least 15%, more preferably at least 25% and even more preferably at least 35% of the clumping agent additive particles 46 by clumping agent additive enhanced litter weight to a pre-existing clumping litter 50 preferably increases the value at least one of these parameters and preferably each of these parameters by at least 5%, preferably by at least 10%, more preferably at least 15% compared to the value of the corresponding parameter(s) of the pre-existing litter 50 before the clumping agent additive particles 46 were added thereto. In such a preferred enhanced clumping litter embodiment and method of making enhanced clumping litter 54 in accordance with the present invention, adding at least 10%, preferably at least 15%, more preferably at least 25% and even more preferably at least 35% of the particles 46 by litter weight to the pre-existing clumping litter 50 produces an enhanced clumping litter 54 of the present invention that absorbs at least 10% more, preferably at least 15% more, and more preferably at least about 25% more water by litter weight than did the same amount, i.e., mass, of the pre-existing litter 50 prior to the addition of the clumping agent additive particles 46 thereto.

Where the pre-existing base litter 50 is a non-clumping litter, adding a sufficient amount or weight percentage in accordance with that discussed above of the clumping agent additive particles 46 thereto to produce an clumping agent additive enhanced litter 54 that is now a clumping litter, e.g. self-clumping litter, because it will form a clump 56 of particles 46 and litter granules 48 when wetted by urine, water or an aqueous liquid during enhanced clumping litter use. In a preferred clumping agent additive enhanced litter embodiment and method of making enhanced clumping litter in accordance with the present invention, adding at least 25%, preferably at least 30%, more preferably at least 35%, and even more preferably at least 40% of the clumping agent additive particles 46, by clumping agent additive enhanced litter weight, to pre-existing non-clumping litter 50 produces a clumping litter 54 that clumps when wetted with urine, water or aqueous liquid forming clumping having a clump retention rate of at least 85%, preferably at least 90%, more preferably at least 95%, and even more preferably at least about 97% at 10 minutes and 30 minutes after clump formation as determined using the clump retention rate test procedure (clump drop test) disclosed below.

Such a clumping litter 54 formed by such a sufficient weight percentage of the particles 46 to non-clumping litter 50 forms clumps 56 when wetted by urine, water or an aqueous liquid that have a clump compressive strength or clump crush strength of at least 50 pounds per square inch, preferably at least 100 pounds per square inch, and more preferably at least about 150 pounds per square inch determined using the clump compression strength test procedure disclosed below. Clumps 56 subjected to the clump compression strength test can be and preferably are dried to a moisture content of no greater than about 12% by clump weight and preferably to a moisture content of between 10% and 12% by clump weight. In addition, adding at least 10%, preferably at least 15%, more preferably at least 25%, even more preferably at least 35% of the clumping agent additive particles 46 to a pre-existing non-clumping litter 50 produces an enhanced clumping litter 54 of the present invention that absorbs at least 10% more, preferably at least 15% more and more preferably at least 25% more water than the amount of water that the same amount of litter 50 absorbed prior to the blending or mixing of the clumping agent additive particles 46 therewith.

Where granules 48 of litter 50 or granules 48a and/or 48b of the litter 50′ are non-clumping granules composed of a non-clumping material, such as granules at least partially or substantially the made of calcium bentonite, wood, paper, another cellulosic or cellulose containing non-clumping material, or another type of non-clumping material, the addition of the clumping agent additive particles 46 to the litter 50 or 50′ imparts the resultant blend or mixture with the ability to clump when wetted with water, urine, or an aqueous liquid advantageously producing a litter blend or formulation that is a clumping agent additive enhanced litter 54 or enhanced clumping litter 54 of the present invention that now is a clumping litter. As depicted in FIG. 2, such a clumping enhanced litter 54 of the present invention that results from blending or mixing particles 46 with a pre-existing multicomponent litter 50′ composed of non-clumping granules 48a and 48b there after forms a clump 56 composed of at least a plurality of pairs, i.e. at least three, of the particles 46 and at least a plurality of pairs, i.e. at least three, of the granules 48a and 48b when the particles 46 and granules 48a, 48b of the litter 54 are wetted with urine, water or an aqueous liquid.

With continued reference to FIGS. 1 and 2, the clumping agent additive particles 46 are smaller than the litter granules 48 thereby configuring the particles 46 relative to the larger granules 48 such that particles 46 dispensed from the clumping agent additive container 42 above the top 60 of the litter 50 become relatively uniformly distributed throughout at least a plurality of the uppermost layers of granules 48 of the litter 50. The plurality of the uppermost layers of granules 48 of litter 50 or granules 48a, 48b of litter 50′ includes the layer of granules 48 or granules 48a and/or 48b that forms a top 60, i.e., top surface or top layer 60, of the litter 50 or 50′ as well as at least one layer and preferably at least a plurality of layers of the litter granules 48 underlying the top layer 60 of granules 50. Upon being dispensed, the smaller-sized particles 46 fall downwardly onto the top surface 60 of the litter 50 and are sufficiently small enough relative to the larger granules 48 or 48a and/or 48b, to configure the particles 46 so they flow downwardly into and/or through voids 58 between adjacent larger granules 48 or 48a, 48b, as well as into and/or through voids 58 below adjacent larger granules 48 or 48a and/or 48b. If desired, the litter box 52 can be manually agitated or shaken after dispensing the particles 46 onto litter 50 or 50′ in the box 52 to help more uniformly mix or blend the particles 46 with the granules 48 of the litter 50 or the granules 48a, 48b of the litter 50′ forming an enhanced clumping litter 54 the same as or like that shown in FIGS. 1 and 2.

As is depicted in FIGS. 1 and 2, each one of the litter granules 48 or 48a and 48b is at least 25%, preferably at least 35%, more preferably at least 50%, and even more preferably can be a plurality of times larger in size than each of the clumping agent additive particles 46 to facilitate the smaller particles 46 flowing into and through these voids 58 between and below adjacent granules 48 or granules 48a and/or 48b when being dispensed onto the litter 50 or 50′. By these smaller particles 26 flowing into these voids 58, urine or water applied onto the top 60 of the litter 54 plugs these voids 58 preventing the year and all water from flowing downwardly into the litter 54 trapping it at or near the top 60 of the litter 54 helping to ensure any clump 56 of wetted particles 46 and granules 48 (or granules 48a, 48b) that forms is disposed at or adjacent the top 60 of the litter 54 as shown in FIG. 2 and as taught in commonly owned U.S. application Ser. No. 18/741,466, filed Jun. 12, 2024, the entirety of which is hereby expressly incorporated by reference herein.

In a particularly preferred embodiment, the particles 46 are sized sufficiently smaller than the granules 48 such that each one of the granules 48 is at least a plurality of pairs of, i.e. at least three, times larger in size than each of the clumping agent additive particles 46 dispensed onto the litter. In a preferred embodiment, the clumping agent additive 40 is composed of clumping agent additive particles 46 having particle sizes or a particle size distribution such that the particles 46 in the container or dispenser have particle sizes ranging between 1800 μm to 700 μm, preferably from about 1700 μm to about 800 μm, and more preferably between about 1680 μm and about 841 μm, the latter of which being particles 46 that pass through a #12 screen and rest on a #20 screen. In a preferred embodiment, at least 75%, preferably at least 80% and more preferably at least 90% of the litter granules 48 or granules 48a, 48b have a particle size larger than the largest sized clumping agent additive particle 46 with granules 48 of litter 50 or granules 48a and 48b of litter 50′ having particle sizes ranging between 1500 μm and 5000 μm, preferably between about 1800 μm and about 4800 μm, more preferably between about 2000 μm and about 4650 μm and even more preferably between about 2800 μm and about 4750 μm. The above disclosed size ranges of the clumping agent additive particles 46 not only helps plug voids 58 between the larger litter granules 48 or 48a, 48b, helping to ensure clump formation on top, but it also minimizes the number of particles 46 dispensed on top 60 of the litter 54 that remain on top 60 as disclosed in in commonly owned U.S. application Ser. No. 18/741,466, filed Jun. 12, 2024, the entirety of which is hereby expressly incorporated by reference herein, thereby minimizing tracking from the litter 54 producing a clumping agent additive enhanced litter 54 in accordance with the invention having a relatively low litter particle effectiveness of no greater than 200 particles per square inch, preferably no greater than 150 particles per square inch, and more preferably no greater than about 100 particles per square inch. Litter particle tracking effectiveness is determined using the litter particle tracking effectiveness test procedure set forth hereinbelow.

In a preferred embodiment, the clumping agent additive particles 46 are extruded in an extruder that preferably is a single screw extruder from a starch containing mixture in the manner disclosed in more detail below at a high enough extrusion temperature, preferably of at least 100° Celsius, more preferably of at least about 125° Celsius, and at a great enough extrusion pressure, preferably of at least 2000 pounds per square inch (PSI), more preferably of at least 2500 PSI, even more preferably of at least 3000 PSI, further preferably of at least 4000 PSI, and yet even further preferably of at least 5000 PSI, to modify, preferably extrusion modify, preferably at least partly or substantially completely via physical modification, at least some of the starch in the admixture during extrusion in the extruder into a mobile clumping agent that is composed of a flowable binder that is at least partially cold water soluble in water, e.g., urine, having a temperature of between 0° Celsius and 25° Celsius advantageously facilitating formation of clump 56 during tat or animal litter use. In such a preferred embodiment, each clumping agent additive particle 46 contains at least 5%, preferably at least 7.5% and more preferably at least 10% of the mobile clumping agent in the form of a cold water soluble binder that is at least partially soluble in water, e.g., urine, having a temperature of between 0° Celsius and 25° Celsius, and preferably is substantially completely soluble in water, e.g., urine, having a temperature of between 0° Celsius and 25° Celsius during cat or animal litter use.

In a preferred embodiment, the particles 46 of the clumping agent additive 40 include, have or are composed of (a) a first clumping agent additive constituent that is or includes a one-time water activated one-time water cured binder, and (b) a second clumping agent additive constituent that is or includes a water reactivating water recuring binder configured to be water activated and water cured a plurality of times. In one such preferred embodiment, the particles 46 of the clumping agent additive 40 also include or have a third constituent that is or includes a water sorbent, preferably a water absorbent, which preferably is configured to sorb, more preferably absorb, urine, water or another aqueous liquid. In a preferred embodiment, the first constituent is produced by dextrinization of starch in the admixture from which the particles 46 are formed that occurs during the extruding step with the first constituent being or including extrusion-modified dextrinized starch that is a one-time water activated one-time water cured binder that is cold water soluble and forms a flowable adhesive when wetted by water or urine. In such a preferred embodiment, the second constituent is or includes an extrusion-modified pregelatinized starch that is or includes a water reactivating water recuring binder configured to be water activated and water cured a plurality of times. It also forms a flowable adhesive when wetted by water urine. The difference between the two is instead of being a one-shot one-time clumping binder like the first constituent, it can be rewetted to reactivate it and thereafter recured to harden at least a plurality of times, preferably even a plurality of pairs of, i.e., at least three, times. These constituents act like a glue when wetted, such that they form clumps of particles 46 and granules 48 or 48a and 48b of clumping enhanced litter 54 in a litter box 52 when wetted with urine, water or another aqueous liquid advantageously maximizing the clumping efficiency of the litter 54 compared to the pre-existing litter 50 from which it is made.

### Sorbent Swelling and Gelling Biopolymeric Clumping Agent

In a preferred embodiment, the mobile clumping agent in each one of the clumping agent additive particles 46 is a sorbent swelling and gelling starch-containing biopolymeric clumping agent that contains at least 5%, preferably at least 7.5%, more preferably at least 10%, by clumping agent additive particle weight, of a water-activated moisture curing at least partially soluble cold-water soluble binder that forms a flowable adhesive when wetted defining a viscous flowable clumping agent that gels and solidifies by hardening as moisture cures as it dries. In one preferred embodiment, the water-activated moisture cured sorbent swelling and gelling biopolymeric clumping agent contains at least 5%, preferably at least 7.5%, more preferably at least 10%, by clumping agent additive particle weight, of a pregelatinized starch that preferably is in the form of an extrusion-modified starch pregel produced by extruding an admixture composed of at least 25% starch by admixture weight, preferably at least 30% starch by admixture weight, more preferably at least 40% starch by admixture weight and which has a relatively low moisture content of no greater than 30% by admixture weight, preferably no greater than 25% by admixture weight, more preferably no greater than 20% by admixture weight, even more preferably no greater than about 17%±2% by admixture weight. The starch in the admixture preferably is composed of unmodified amylopectin starch, making up at least 7.5% by weight of the starch present in the admixture, preferably making up at least 10% by weight of the starch present in the admixture, more preferably making up at least 15% by weight of the starch present in the admixture, and even more preferably making up at least 20% by weight of the starch present in the admixture, and unmodified amylose starch, making up at least 5% by weight of the starch present in the admixture, preferably making up at least 7.5% by weight of the starch present in the admixture, more preferably making up at least 10% by weight of the starch present in the admixture, and even more preferably making up at least 15% by weight of the starch present in the admixture. The starch admixture is extruded using an extruder, preferably a single screw extruder, having at least about 50 horsepower (hp), preferably at least 100 hp subjecting the starch admixture within the extruder to an extrusion pressure of at least 2000 pounds per square inch (PSI), preferably at least 2500 PSI, more preferably at least 3000 PSI, even more preferably at least 4000 PSI, and even further preferably at least 5000 PSI, and an extrusion temperature of at least 100° C., preferably at least about 120° C., and preferably no greater than 200° C., preferably no greater than about 150° C., for a relatively short residency time of between 3 seconds and 20 seconds, preferably between 3 seconds and 15 seconds, more preferably between 4 seconds and 12 seconds, and even more preferably between about 5 seconds and about 10 seconds. No water or moisture, including steam, is added to the admixture while it is inside the extruder, preferably single screw extruder, during extrusion of clumping agent additive extrudate. Upon exiting the extrusion die of the extruder, preferably single screw extruder, the extrudate is rapidly cooled and dried without adding any heat thereto, preferably by air quenching the extrudate immediately upon exiting the die with turbulently flowing air to freeze the state of the extrusion-modified starches in the sorbent swelling and gelling biopolymeric mobile clumping agent in the extrudate, clumping agent additive extrudate, thereby freezing the state of the extrusion-modified starch therein, including the pregelatinized starch (extrusion-modified starch pregel) in the extrudate, and particularly also any water-soluble extrusion-modified starch pregel, further including any-water-soluble extrusion-modified starch pregel in the extruded clumping agent additive particles 46. The extrudate contains the modified starch water absorbent clumping material, preferably modified starch water absorbent clumping agent, and can be and preferably is comminuted into smaller extruded clumping agent additive particles 46 of the present invention.

In a preferred admixture, the admixture contains at least one of a cereal grain, such as wheat, buckwheat, oats, rice, corn (maize), quinoa, barley, sorghum, rye, triticale, and millet and a legume, such as chickpeas, kidney beans, black beans, lentils, pinto beans, peas including green peas and yellow peas, adzuki beans, and peanuts and can be composed of a mixture of a plurality of cereal grains and/or a plurality of legumes. In one such preferred admixture, the admixture is substantially completely composed of at least one of a cereal grain, such as wheat, buckwheat, oats, rice, corn (maize), quinoa, barley, sorghum, rye, triticale, and millet and a legume, such as chickpeas, kidney beans, black beans, lentils, pinto beans, peas including green peas and yellow peas, adzuki beans, and peanuts and can be composed of a mixture of a plurality of cereal grains and/or a plurality of legumes.

Extrusion of such an unmodified starch-containing admixture as described hereinabove using a single screw extruder operating in accordance with the above extrusion pressure and extrusion temperature parameters modifies, preferably extrusion modifies, more preferably physically modifies, at least some of the starch in the admixture during extrusion at an ultrahigh extrusion pressure disclosed above into an extrusion-modified cold water soluble starch pregel which preferably is or includes cold water-soluble extrusion-modified starch pregel, and which more preferably is or contains at least partially water-soluble modified starch binder, of which at least a portion forms an at least partially water-soluble flowable adhesive when wetted with cold water having a temperature between 0 degrees Celsius and 25° C., room temperature water having a temperature between 20° C. and 25° C., and/or cat body temperature urine having a temperature of between about 37° C. and about 40° C. In at least one such preferred method implementation, extrusion of such a starch containing admixture as described hereinabove using such a single screw extruder operating in accordance with the above parameters modifies, preferably physically modifies, at least some of the starch in the admixture, during extrusion at an ultrahigh extrusion pressure disclosed above, into modified starch water absorbent clumping agent containing extrudate having at least 5%, preferably at least 10%, more preferably at least 15%, and even more preferably at least 30% by extrudate, e.g., particle 46, weight of extrusion-modified starch pregel which preferably is or includes an at least partially cold water-soluble extrusion-modified starch pregel. As a result of extrusion out such an ultrahigh extrusion pressure using a single screw extruder, the extrusion-modified starch pregel, including any cold water-soluble extrusion-modified starch pregel, is substantially uniformly distributed throughout the modified starch water absorbent clumping agent containing extrudate, i.e., particles 46.

Extrusion of such a starch containing admixture using such a single screw extruder modifies, preferably extrusion modifies, such as by preferably via physically modification in the extruder, at least some of the starch in the admixture in the extruder into an extrusion-modified starch pregel that remains in the extruded clumping agent additive, which can and preferably does contain at least some cold water-soluble extrusion-modified starch pregel, thereby producing extrudate from which the particles 46 of extruded clumping agent additive 40 are subsequently made that contains extrusion-modified starch pregel, including any cold water-soluble extrusion-modified starch pregel that may be present therein, which is substantially uniformly distributed throughout the extrudate discharged through a perforate extrusion die at a discharge end of the single screw extruder. In at least one preferred method implementation, extrusion of such a starch containing admixture using such a single screw extruder modifies, preferably physically modifies, at least some of the starch in the admixture in the extruder, by being subjected to an above-disclosed extrusion temperature and extrusion pressure, into at least 5%, preferably at least 10%, more preferably at least 15%, and even more preferably at least 30% by extrudate, e.g., particle 46, weight of extrusion-modified starch pregel, which can and preferably does contain at least some cold water-soluble extrusion-modified starch pregel, thereby producing an extrudate from which the particles 46 are subsequently formed, which can be an extruded instantized starch containing extrudate, a water gelling extrudate, and/or a water swelling extrudate, which contains at least 5%, preferably at least 10%, more preferably at least 15%, and even more preferably at least 30% by weight of the extrusion-modified starch pregel, including any cold water-soluble extrusion-modified starch pregel present in the extrudate, substantially uniformly distributed throughout the extrudate discharged from the single screw extruder. In at least one such preferred method implementation, extrusion of such a starch containing admixture using such a single screw extruder modifies, preferably extrusion modifies at least partially or substantially completely by physical modification in the extruder, at least some of the starch in the admixture in the extruder into at least 5%, preferably at least 10%, more preferably at least 15%, and even more preferably at least 30% by extrudate, e.g., particle 46, weight of the cold water-soluble extrusion-modified starch pregel which contains at least 5%, preferably at least 10%, more preferably at least 15%, and even more preferably at least 30% by extrudate weight, e.g., particle 46 weight, of cold water-soluble extrusion-modified starch pregel, substantially uniformly distributed throughout the extrudate, e.g., particle 46.

In a preferred implementation of making extruded clumping agent additive in accordance with present invention, the extruder has at least 50 hp and preferably is one of (a) about a 50 hp single screw extruder having a barrel length of between eight inches and sixteen inches, preferably between about nine inches and about twelve inches, and more preferably of about nine inches, a barrel internal diameter of between two inches and five inches, preferably between three inches and four inches, and more preferably of about three and one-half inches, and a residency time of between three seconds and fifteen seconds, preferably between four seconds and twelve seconds, more preferably between about five seconds (±1 second) and about ten seconds (±1 second), and even more preferably between about four seconds (±1 second) and about eight seconds (±1 second), and (b) about a 100 hp single screw extruder having a barrel length of between fourteen inches and twenty inches, preferably between about sixteen inches and about eighteen inches, more preferably of either about sixteen inches (±1 inch) or about eighteen inches (±1 inch), a barrel internal diameter (I.D) of between three inches and six inches, preferably between about four inches and about five inches, and more preferably about four and one half inches (±1 inch), and a residency time of between four seconds and twenty seconds, preferably between six seconds and eighteen seconds, more preferably between seven seconds and fifteen seconds, and even more preferably between about eight seconds (±1 second) and about twelve seconds (±1 second). During operation, the extruder, preferably about a 50 hp or about a 100 hp single screw extruder, subjects the starch-containing admixture therein to an ultrahigh extrusion pressure of at least at least about 2000 PSI, preferably at least 2500 PSI, more preferably at least 3000 PSI, even more preferably at least 4000 PSI, and further even more preferably at least about 5000 PSI, and which preferably ranges between about 2000 PSI and about 5000 PSI during single screw extruder operation.

In one preferred method of making clumping agent additive extrudate 40 and extruded clumping agent additive particles 46 of the present invention, the aforementioned single screw extruder parameters are configured and controlled during extrusion of such a starch-containing admixture containing (a) at least about 25% starch, preferably at least 30% starch, more preferably at least 40% starch by admixture weight, and (b) a relatively low moisture content of no greater than 30%, preferably no greater than 25%, more preferably no greater than about 20%, and even more preferably no greater than about 17%+2%, by admixture weight. In one such preferred method implementation, such a starch-containing admixture is composed of at least one of a cereal grain and a legume having a sufficiently great enough starch content to achieve at least 65% starch gelatinization within the single screw extruder, preferably at least 70% starch gelatinization within the extruder, more preferably at least 75% starch gelatinization within the extruder, even more preferably between 75% and 95% starch gelatinization within the extruder operating at the aforementioned extrusion temperature(s) and ultrahigh extrusion pressure(s) to produce extrudate that is particle size classified or particle-size reduced into relatively small particles 46 of the extruded clumping agent additive 40, which can have particle sizes or size ranges in accordance with that discussed above and which can have even smaller particles sizes by being particle-size reduced, comminuted, ground or milled into extruded clumping agent additive flour 46 and/or extruded clumping agent additive powder 46. Even where particle size reduced, milled, ground or otherwise comminuted into flour or powder particles 46, they can be and preferably are composed of extrusion-modified starch water-absorbent mobile clumping agent that is or includes modified-starch-based sorbent swelling biopolymeric gellant comprised of at least 15% of an extrusion-starch modified pregel, i.e., an extrusion-modified pregelatinized starch. In another preferred method and extrudate of the present invention, the aforementioned single screw extruder parameters are configured and controlled during extrusion of such a starch-containing admixture containing at least 25% starch, preferably at least 30% starch, more preferably at least 40% starch, even more preferably at least 50% starch by admixture weight composed or derived of or from at least one of a cereal grain and a legume, to achieve between 35% and 65% starch gelatinization within the extruder and preferably between 40% and 60% starch gelatinization within the extruder to produce an extrudate composed of extrusion-modified starch water-absorbent clumping agent comprising modified-starch-based sorbent swelling biopolymeric gellant containing both an at least partially soluble extrusion-modified starch binder, preferably extrusion-modified starch cold water soluble binder, and a water swellable water absorbent extrusion-modified starch. No water or moisture, including any steam, is added to the admixture while it is inside the single screw extruder during extrusion nor is added to the extrudate upon exiting the extruder. Upon exiting the extrusion die of the single screw extruder, the extrudate is rapidly cooled and dried without adding any heat thereto preferably by air quenching the extrudate immediately upon exiting the die and being cut into pellets using turbulently flowing air to freeze the state of the extrusion-modified starches in the extrudate. This thereby also freezes the state of the extrusion-modified starch pregelatinized starch (extrusion-modified starch pregel) in the extrudate, including any water-soluble extrusion-modified starch pregel, i.e., water-soluble extrusion-modified pregelatinized starch, which also includes or encompasses any-water-soluble extrusion-modified starch pregel in the extrudate.

It was previously thought that extruded fines or flour 40 of extruded clumping agent additive 40 air quenched upon extrusion to freeze the state of its modified water-soluble starches only forms (a) an at least partially water-soluble binder and (b) an at least partially water-soluble flowable adhesive that can only be water-activated and moisture-cured a single time once wetted with water or urine. It is therefore a surprise that at least some of the extrusion modified starch in the extruded clumping agent additive 40 that is or forms (a) the at least partially water-soluble binder and (b) the at least partially water soluble flowable adhesive can be at least partially solubilized, water re-activated, and moisture re-cured at least once and preferably at least a plurality of times after previously being wetted, water activated (for a first time), and moisture cured (also for a first time) with cold water, room temperature water, or cat body temperature urine. During extrusion, the heat of vaporization affects the already modified starches in the extrudate that becomes the extruded clumping agent additive 40 to produce one or more of the desired water swelling, water absorption, binder or binding, flowable adhesive, clumping, water activated and moisture curing, water re-activated and moisture re-curing, endothermic water re-activated and moisture re-curing, and/or endothermic re-gelatinization properties and/or characteristics, including by setting or freezing in place their respective extrusion modified starch state(s) upon or immediately after extrusion out the extruder die to retain these properties, even when the extrudate, even in the form of flour or powder particles 46, is stored for a relative long period of time of at least six months or even greater than one year.

It was also previously believed that the extrusion modified starch water absorbent clumping material or clumping agent containing extrudate 40, i.e., extruded clumping agent additive 40, could not be heated up after extrusion and air quenched/flash dried without adversely affecting the ability of at least partially soluble modified starch binder of the mobile clumping agent in each particle 46 to form flowable adhesive when wetted with urine, water or an aqueous liquid, as well as to adhesively bond thereafter. As such, it was an unexpected surprise to learn that ultrahigh pressure extrusion modified starch water absorbent clumping material or clumping agent containing extrudate in the form of particles 46 of extruded clumping agent additive 40 of the present invention can be heated after being wetted and even saturated with water to a temperature of at least 100° Fahrenheit, preferably at least 150°, more preferably at least 180° Fahrenheit to dry the particles 46, which are moist when finished, without adversely affecting the ability of the outer layers of the particles 46 to at least partially solubilize and water activate enough of the binder and flowable adhesive therein when re-wetted with room temperature urine or cat body temperature urine and form clumps of the just the particles 46 that have a clump retention rate of at least 97%, preferably at least 98% and more preferably at least 99%, and a clump crush strength of at least 100 PSI, preferably at least 150 PSI, and more preferably at least 300 PSI.

The extrudate containing the extrusion-modified starch water-absorbent clumping agent additive 40 can be particle-size reduced, such as by using a particle-size reducing machine, such as a hammermill, roll granulator, a roller crusher or another type of particle-size reducing machine to reduce particle size. The extrudate containing the extrusion-modified starch water-absorbent clumping agent can be particle-size classified, such as by using a sieve, screen, a pneumatic or air classifier, a pneumatic or air classifying mill, or another type of particle size classifier that particle size classifies in real time as the extrudate from which the clumping agent additive 40 is extruded from the extruder and conveyed pneumatically downstream to the size classifying equipment that forms the extrudate into particles 46 of the additive 40.

As previously discussed, the clumping agent additive extrudate produced during ultrahigh pressure extrusion using the extrusion parameters set forth above is particle size reduced into clumping agent additive particles, such as by a rotary cutter as the extrudate exits the perforate die of the extruder. The extrudate is cut by the cutter into relatively small sized particles ranging in size from particles as small as 400 μm to granules as large as 2000 μm, preferably which range in size between about 450 μm and about 1800 μm, and more preferably between 500 μm and 1680 μm (which pass through a 12 US mesh sieve and which rest upon a 35 US mesh sieve (12/35 US mesh sieve)). After being cut to size to fall within an aforementioned particle size range or particle size distribution, the resultant clumping agent additive particles have a density of less than 25 pounds per cubic foot, preferably no greater than 20 pounds per cubic foot, and more preferably no greater than 17 pounds per cubic foot.

The result is a particulate litter additive that is a litter clumping agent additive of the present invention whose particles are water or urine sorbent, which also contain a clumping agent, and which during use are sprinkled on and/or mixed with (a) litter granules of a base litter while prepackaged in its litter container before being poured into a litter box, and/or (b) litter granules of the base litter already poured into the litter box either way producing a clumping agent additive enhanced litter of the present invention having improved and/or enhanced litter and clumping related features, characteristics, values and/or parameters compared to using the base litter alone without any particles of the additive as discussed in more detail hereinbelow.

The clumping agent additive is composed of particles, e.g., pellets, preferably extruded particles, e.g., such as preferably extruded pellets, with sizes ranging from particles as small as 400 μm to pellets as large as 2000 μm having a density less than 25 pounds per cubic foot for enabling the smaller particles of the clumping agent additive to work in concert with the larger existing litter granules of base litter in the litterbox to act as swelling and clump-facilitating plugs disposed in between the existing litter granules of the base litter on or adjacent the surface of the litter in the litter box that block downward passage of water or urine while the clumping agent additive particles substantially simultaneously release water soluble binder that causes clumping, where the base litter is a non-clumping litter, or facilitates better clumping, where the base litter is a clumping litter. The extruded particles are not only configured to act as plugs which block downward water or urine passage, but the clumping agent additive particles are also configured to swell when wetted in a manner which not only absorbs part of the water or urine, but which also enlarges them making their water or urine flow blocking or plugging action more effective. The extruded particles, e.g., pellets, have a water-soluble binder clumping agent in the form of a starch complex that includes starches modified during extrusion by the extrusion pressure in the extruder that the starches are subjected to during extrusion. At least some of the water-soluble binder in the extruded particles of the clumping agent additive with which the urine or water contacts will go into solution immediately upon being wetted with the water or urine traversing downwardly towards the bottom of the litterbox immediately thickening the water or urine increasing its viscosity beyond its normal viscosity of about 1 centipoise which in turn slows its downward flow. By slowing its downward flow, it increases the time with which it remains in contact not only with the extruded particles of clumping agent additive but also other litter granules. This not only causes the rate of flow to further slow from the release of additional water-soluble binder from the downwardly flowing urine or water contacting additional clumping agent additive particles, but this also increases its contact time with litter granules of the base litter thereby enabling more of the urine or water to be absorbed all of which increases litter efficiency compared to conventional litters lacking the extruded particles. Litter efficiency is defined as the amount or mass of litter required to absorb a given amount of urine or water divided by the amount or mass of the litter in the litter box. Increasing litter efficiency simply means that less litter, in this case less particles and granules, are required to absorb a predetermined given amount of water or urine than a different conventional litter. Greater litter efficiency means that a predetermined amount of litter in a litter box will last longer because less litter will be used each time a cat urinates in the litter in the litter box thereby requiring the litter box to be refilled less frequently saving the customer who purchased the litter money and time because it lasts longer. In a preferred clumping agent additive embodiment, the clumping agent additive has a particle size distribution that preferably is relatively uniform and which ranges from about 450 μm to about 1800 μm having a density no greater than 20 pounds per cubic foot and which more preferably ranges from 500 μm to 1680 μm or which pass through a 12 US mesh sieve and which rest upon a 35 US mesh sieve (12/35 US mesh sieve) and which have a density no greater than 17 pounds per cubic foot.

In the past, when a cat urinated onto litter granules of a base litter that was a clumping litter composed of sodium bentonite litter granules responsible for giving the base litter the ability to clump, the urine stream initially flows over and in between bentonite granules on and near the top of the litter before continuing to flow downwardly towards the bottom of the litterbox. Because other bentonite granules not directly in the path of the urine stream which become wetted by the urine are not pulled into the stream that continues to be discharged by the cat, it takes time for the bentonite granules directly in the path of the stream to swell enough to block the rest of the urine being discharged from cat to prevent it from flowing downwardly toward the bottom of the litterbox. This results in a clump formed of wetted bentonite granules of the granular bentonite clumping base litter that extend at least a plurality of layers deeper than a clump formed of clumping agent additive enhanced litter composed of particles of the clumping agent additive added to the same granular bentonite clumping base litter. This is because particles of the clumping agent additive (a) are lighter in density, enabling them to be more readily pulled into the urine stream to horizontally deflect the stream thereby reducing the amount and rate of downward urine flow, (b) swell more rapidly when wetted with urine than the urine-wetted bentonite granules further horizontally deflecting the urine stream thereby even further reducing the amount and rate of downward urine flow, (c) swell more when wetted with urine to occupy a significantly greater volume than the urine-wetted bentonite granules more completely plugging voids between and underneath bentonite granules on top and adjacent the top of the litter yet still further reducing the amount and rate of downward urine flow, (d) more rapidly absorb urine contacting the clumping agent particles even yet still further reducing the amount and rate of downward urine flow, and (e) release at least partially water-soluble clumping agent that increases in viscosity thereby slowing the flow of urine in any direction, much less downwardly, helping contain the urine and the clump formed by the urine closer to the top producing a smaller, denser and more efficient clump having a higher clump retention rate as discussed elsewhere herein. To put it another way, this smaller, denser, more efficient and higher clump retention rate clump is formed closer to the top of the litter as a result of the clumping agent additive enhanced litter of the present invention getting pulled into the stream more quickly deflecting the stream of urine horizontally, more quickly swelling a greater amount to more quickly plug voids and channels between adjacent bentonite granules along the top and just below the top of the litter, and forming an at least partially water-soluble binder that is released into the stream whose viscosity relatively rapidly increases until it gels or forms a gel.

As a result, a granular sodium bentonite clumping base litter having much larger sized bentonite granules can advantageously be used with the clumping agent additive to produce a clumping agent additive enhanced litter that tracks less and produces less dust during use by a cat of the clumping agent additive enhanced litter in a litterbox (compared to the same base litter used alone or by itself without any particles of the clumping agent additive added to it or mixed with it). As a further result, such a granular sodium bentonite clumping base litter can also be made with a greater percentage of filler granules made of one or more filler materials that also advantageously reduces the overall cost of the litter to the consumer or user of the litter.

The clumping agent additive formed from the extrudate preferably is in the form of an extruded organic starch-containing particulate material that is configured for being shaken on and mixed with a base litter in its prepackaged form in a litter container and/or already poured into litterbox forming a multicomponent clumping agent additive enhanced litter that imparts an ability to the multicomponent litter to form clumps when wetted with water or urine, where the existing litter is a non-clumping litter, e.g., a calcium bentonite litter, and enhances the ability of the multicomponent litter to form clumps when wetted with water or urine by one or more of the following: increasing clump retention rate, increasing clump crush strength, increasing the rate or speed of clump formation, decreasing clump size, increasing clumping efficiency and/or increasing litter efficiency compared to the same characteristic of the litter when used without the clumping agent additive. Clumping efficiency is advantageously increased by making a clump formed of water or urine wetted clumping agent additive particles and litter granules of the base litter of clumping agent enhanced litter denser than a clump formed only of granules of the base litter, which thereby advantageously also increases clump retention rate and clump compressive or crush strength of clumps formed using the clumping agent additive enhanced litter compared to clumps formed using only the base litter (without the base litter containing any particles of extruded clumping agent additive).

The use of the clumping agent additive preferably also produces clumps containing a mixture of the clumping agent additive and granules of the base litter in the litterbox that exhibits an increase of at least 3% in clump retention rate, preferably an increase of at least 5% in clump retention rate, and more preferably at least 7% in clump retention rate compared to the clump retention rate of a clump made from a clumping base litter used by itself without the clumping agent additive. A clumping agent additive enhanced litter of the present invention also produces clumps have increased crush strength compared to clumps formed using only a clumping base litter preferably having an increased crush strength of at least 5 PSI, preferably at least 10 PSI, more preferably at least 50 PSI, even more preferably at least 100 PSI and even more preferably at least 150 PSI greater than the crush strength of clumps formed only of the clumping base litter before the addition of any clumping agent additive to the base litter.

A clumping agent additive enhanced litter of the present also forms clumps composed of at least a plurality of pairs, i.e., at least three, of water or urine wetted litter granules of base litter and at least a plurality of pairs, i.e., at least three, of water or urine wetted clumping agent additive particles faster, preferably at least 10% faster, preferably at least 15% faster, and more preferably at least 20% faster than clumps formed only of wetted litter granules of the base litter (before and without any clumping agent additive particles added to the base litter). The clumps of such a clumping agent additive enhanced litter of the present also forms clumps are also at least 10% smaller, preferably at least 15% smaller and at least 20% smaller than clumps than clumps formed only of wetted litter granules of the base litter because the clumps formed with the clumping agent additive enhanced litter is at least 5% denser, preferably at least 10% denser and more preferably at least 15% denser than clumps formed with the base litter without any particles of the clumping agent additive added thereto or otherwise mixed therewith. By increasing the rate or speed of clump formation while simultaneously decreasing clump size when the clumping agent additive is used compared to when it is not used, clumping efficiency is advantageously increased by at least 5%, preferably at least 10% and more preferably at least 15% compared to the base litter that does not contain any clumping agent additive particles. Clumping efficiency is increased by the resultant clump formed of wetted extruded particles and wetted litter granules being denser than a clump formed only of the litter granules, which advantageously means that the clump retention rate and clump crush or compressive strength of the resultant clump formed of the wetted extruded particles and wetted litter granules are greater than for a clump formed only of the wetted litter granules. By increasing clumping efficiency when the clumping agent additive is used compared to what it is not used, the use of the clumping agent additive also increases litter efficiency because less litter is used to form a clump compared to when the clumping agent additive is not used. This advantageously results in less litter being used to form clumps over a given or predetermined period of time when the clumping agent additive of the present invention is used compared to when it is not used which of course beneficially lowers the actual cost or total cost of using a clumping agent additive enhanced litter of the present invention compared to using the base litter alone without any particles of clumping agent additive added thereto or mixed therewith.

In a preferred embodiment, the clumping agent additive formed from the clumping agent additive extrudate extruded under an ultrahigh extrusion pressure as discussed hereinabove and hereinbelow includes or has (a) a first constituent that is or includes a one-time moisture activated one-time moisture cured binder, and (b) a second constituent that is or includes a moisture reactivating moisture recuring binder configured to be moisture activated and moisture cured a plurality of times. A preferred clumping agent additive formed from the extrudate in carrying out a preferred method of making clumping agent additive in accordance with the present invention includes or has (a) a first constituent that is or includes a one-time water activated one-time water cured binder that can be and preferably is at least partially water soluble and more preferably is at least partially cold water soluble, and (b) a second constituent that is or includes a water reactivatable water re-curable or water reactivating water recuring binder configured to be water activated and water cured a plurality of times that can also be and preferably is at least partially water soluble and which more preferably is at least partially cold water soluble. In one preferred method of making the extruded clumping agent additive, the constituent, preferably the second constituent, which is a binder, preferably at least partially water soluble binder, that is water-activatable and water-curable at least a plurality of times, i.e., a water re-activatable, water re-curable water-soluble binder, is formed of at least some of the other extrusion-modified starch in the starch-containing admixture that also was preferably at least partially physically modified in an extruder, preferably a single-screw extruder, by the ultrahigh extrusion pressure during extrusion is cross-linked by or with protein or proteins in the starch-containing admixture. The protein or proteins, which crosslink or function as a cross-linker that cross-links the aforementioned extrusion-modified starch to form the water re-activatable, water re-curable water-soluble binder can be composed of extrusion-modified, e.g., extrusion-pressure modified, proteins freed up from the starch in the admixture and/or be otherwise extrusion-modified, preferably extrusion-pressure modified, such as by being physically modified, by being subjected to an ultrahigh extrusion pressure of at least 2000 PSI, preferably at least 3000 PSI, more preferably at least 4000 PSI, and even more preferably at least 5000 PSI at an extrusion temperature of at least 100° Celsius, more preferably at least 130° Celsius and preferably no greater than 180° C., preferably no greater than about 150° C., and preferably about 140° C. in the extruder during extrusion for a residency time of at least three seconds and no greater than twenty seconds, preferably between three seconds and fifteen seconds, and more preferably between about four seconds and about eight seconds in the extruder that preferably is a single screw extruder with a starch-containing admixture formulated and configured as disclosed elsewhere herein. In one such preferred embodiment, the clumping agent additive includes or has a third constituent that is or includes a water sorbent, preferably a water absorbent, which preferably is configured to sorb, more preferably absorb, water.

In one preferred embodiment, the clumping agent additive is an extruded clumping agent additive that contains at least 5% of the first constituent, preferably at least 7.5% of the first constituent, and more preferably at least 10% of the first constituent. In one preferred embodiment, the clumping agent additive contains at least 5% of the second constituent, preferably at least 7.5% of the second constituent, and more preferably at least 10% of the second constituent. In another preferred embodiment, the clumping agent additive contains at least 5% of the first and second constituent, preferably at least 7.5% of the first and second constituent, and more preferably at least 10% of the first and second constituent. Where the clumping agent additive has a third constituent, the clumping agent additive contains at least 5% of the third constituent, preferably at least 7.5% of the third constituent, and more preferably at least 10% of the third constituent. In still another preferred embodiment, the clumping agent additive contains at least about 5% of the first, second and third constituent, preferably at least about 7.5% of the first, second and third constituent, and more preferably at least about 10% of the first, second and third constituent.

The first constituent is formed of or includes a cold-water soluble starch that is at least partially water soluble at a room temperature of between 68 degrees Fahrenheit and 72 degrees Fahrenheit. The first constituent is formed of or includes an extrusion-modified starch that is or includes starch in the admixture that is modified during the extruding step. The first constituent is formed of or includes extrusion-modified starch which is from or includes starch in the admixture modified by ultrahigh pressure extrusion into the extrusion modified starch of the first constituent. In one preferred embodiment, the first constituent is formed of or includes an extrusion-modified amylopectin starch. In another preferred embodiment, the first constituent is formed of or includes an extrusion-modified amylose starch.

The second constituent also is formed of or includes a cold-water soluble starch that is at least partially water soluble at a room temperature of between 68 degrees Fahrenheit and 72 degrees Fahrenheit. The second constituent is formed of or includes an extrusion-modified starch that is or includes starch in the admixture that is modified during extruding step. The second constituent is formed of or includes extrusion-modified starch which is from or includes starch in the admixture modified by ultrahigh pressure extrusion into the extrusion modified starch of the second constituent. In one preferred embodiment, the second constituent is formed of or includes an extrusion-modified amylopectin starch. In another preferred embodiment, the second constituent is formed of or includes an extrusion-modified amylose starch.

The third constituent also is formed of or includes a cold-water soluble starch that is at least partially water soluble at a room temperature of between 68 degrees Fahrenheit and 72 degrees Fahrenheit. The third constituent is formed of or includes an extrusion-modified starch that is or includes starch in the admixture that is modified during the extruding step. The third constituent is formed of or includes extrusion-modified starch which is from or includes starch in the admixture modified by ultrahigh pressure extrusion into the extrusion modified starch of the third constituent. In one embodiment, the third constituent is formed of or includes an extrusion-modified amylopectin starch. In another embodiment, the third constituent is formed of or includes an extrusion-modified amylose starch.

### RVA Testing and Test Results

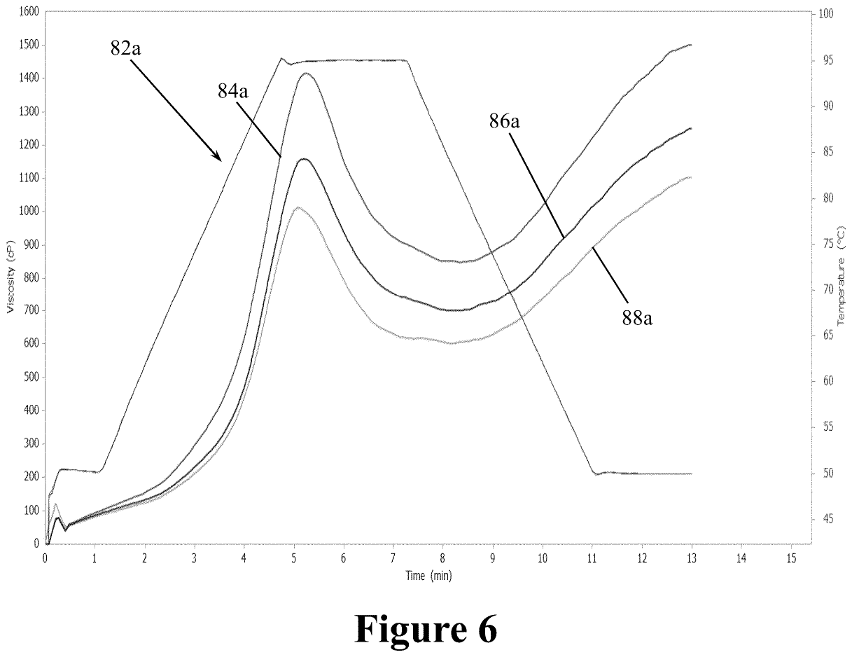

The particulate extrudate used as an extrusion-modified starch water-absorbent clumping agent of the present invention preferably has certain preferred rheological properties as measured by a Rapid Visco Analyzer (RVA), preferably a Perten Instruments RVA 450 Rapid Visco Analyzer made, sold and/or distributed by PerkinElmer® of 940 Winter Street, Waltham, Massachusetts, which are reflected in the RVA charts of the RVA graphs shown in FIGS. 6-11 which are discussed in more detail hereinbelow.

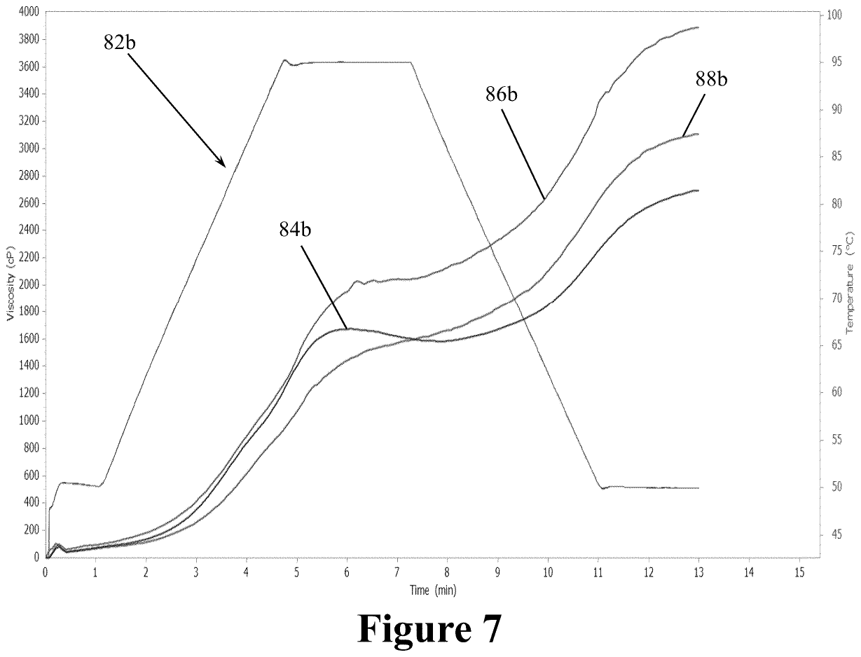

FIGS. 6 and 7 illustrate respective charts 82a, 82b of RVA curves 84a, 86a and 88a in FIG. 6 and RVA curves 84b, 86b, and 88b in FIG. 7 for samples of a preferred embodiment of an extruded clumping agent additive 40 of the present invention that not only agglutinates upon being wetted with water a first time, such as depicted with RVA curves 84a, 86a and 88a of FIG. 6, but which also unexpectedly advantageously agglutinates upon being dried and rewetted or rehydrated with water by being wetted a second time with water, such as depicted with RVA curves 84b, 86b, and 88b of FIG. 7. The clumping agent additive 40 whose RVA curves 84a, 84b, 86a, 86b, 88a and 88b are respectively depicted in FIGS. 6 and 7 is extruded using single screw extruder having a horsepower rating of about 50 hp that is equipped with an extruder die like that disclosed above having about 0.050 inch die holes through which is extruded a starch-containing admixture having a moisture content of no greater than 25%, preferably no greater than 20%, and more preferably no greater than about 17%±2% by admixture weight that preferably is composed substantially completely of wheat, such as preferably a whole grain wheat. The admixture contains at least 40%, preferably at least 50%, more preferably at least 65% starch. No moisture is added to the admixture while it is in the extruder. During extrusion, the extruder subjects the admixture to an extrusion pressure of at least about 2000, PSI, preferably at least 2500 PSI, more preferably at least 3000 PSI, even more preferably at least 4000 PSI, yet even more preferably at least 5000 PSI, and still yet even more preferably between about 2000 PSI±500 PSI and about 5000 PSI±1000 PSI, in the extruder and an extrusion temperature of at least about 100° C., preferably at least 130° C. and no greater than 180° C., preferably no greater than about 150° C., and preferably about 140° C. for a residency time of at least three seconds and no greater than twenty seconds, preferably between three seconds and fifteen seconds, and more preferably between about four seconds and about eight seconds gelatinizing at least 40%, preferably at least 50%, more preferably at least 75%, and even more preferably between about 75% and about 95% of the starch in the admixture.

Upon exiting the extrusion die of the extruder, the clumping agent additive extrudate is rapidly cooled and dried without adding any heat thereto, preferably by air quenching the extrudate immediately upon exiting the die of the extruder using turbulently flowing air to freeze the state of extrusion-modified starches in the extrudate formed of starch modified, preferably at least partially physically modified, from being subjected to ultrahigh extrusion pressure in the extruder into an extrusion-modified starch water-soluble binder clumping agent, including any water-soluble binder clumping agent composed of extrusion-modified starch pregelatinized starch (extrusion-modified starch pregel). The extrudate is typically in pelletized form from being cut into pellets as the extrudate is being discharged from the extruder die, can thereafter be and preferably is comminuted into smaller particles 46 having a sufficiently small particle size and/or falling within a desirably small particle size range in accordance with that disclosed elsewhere herein making them suitably small enough for use as clumping agent additive 40 of the present invention.

For purposes of preparing a first set of samples of the extrudate tested with the RVA to produce pre-rehydration RVA curves 84a, 86a and 88a of graph 82a in FIG. 6 and thereafter the post-rehydration curves 84b, 86b and 88b of graph 82b in FIG. 7, the clumping agent additive extrudate was comminuted into a flour, such as a flour having particles ranging in size between about 10 μm and about 100 μm, or a powder, such as a powder having particle sizes no greater than about 400 μm and which be as small as 1 μm. The flour or powder samples of clumping agent additive extrudate or extruded clumping agent additive 40 were each tested using a standard “flour” pasting cycle (the AACCI/Cereals & Grains standard method for wheat and rye flour) with each sample tested composed of about 3.34 grams of extruded clumping agent additive flour or powder added to about 25.16 grams of distilled water without any mixing or shaking, including without any manual mixing or shaking being performed. Each sample was tested using a Perten Instruments RVA 450 Rapid Visco Analyzer made, sold and/or distributed by PerkinElmer® of 940 Winter Street, Waltham, Massachusetts operated according to parameters set forth in Table 1 below:

TABLE 1

| Time | Event Type | Value | |
|---|---|---|---|
| 0:00:00 | Temp | 50° | C. |
| 0:00:00 | Speed | 960 | RPM |
| 0:00:10 | Speed | 160 | RPM |
| 0:01:00 | Temp | 50° | C. |
| 0:04:42 | Temp | 95° | C. |
| 0:00:00 | Temp | 50° | C. |
| 0:11:00 | Temp | 50° | C. |

| | |
|---|---|
| 0:13:00 | End |

With continued reference to FIG. 6, each sample of the first preferred embodiment of clumping agent additive flour or powder having a moisture content of about 10% by weight dissolved or that went into solution in water were tested in accordance with the test procedure set forth above in the preceding paragraph using the Perten Instruments RVA to produce the RVA test data used to generate the respective RVA curves 84a, 86a, and 88a of the graph 82a in FIG. 6. These curves 84a, 86a, and 88a help show the advantageous agglutinating properties of the samples of clumping agent additive 40 at pre-rehydration in being hydrated a first time as the below-disclosed RVA parameters obtained from testing used to generate these curves also define desired RVA characteristics of a clumping agent additive 40 added to granular litter that advantageously produces a resultant clumping agent enhanced litter (a) that clumps, where the original or base litter to which it was added was a non-clumping litter, or (b) performs better in some way, preferably clumps better in some way, where the original or base litter to which it was added was a clumping litter. Where added to a base litter that is a clumping litter, the resultant clumping agent additive enhanced litter has one or more litter properties and/or one or more clumping properties that are improved over the same litter properties and/or clumping properties of the base litter before adding any clumping agent additive 40 to it, i.e., a base litter that contains no clumping agent additive 40.

As is depicted by the RVA curves 84a, 86a, and 88a in FIG. 6 from the RVA test data from RVA testing the clumping agent additive samples used to generate the curves 84a, 86a, and 88a, a clumping agent additive 40 of the present invention which agglutinates when wetted or hydrated a single time, e.g., pre-rehydrated, thereby promoting clumping of litter to which it is added preferably has (a) a minimum first peak of at least about 850 centipoise (cP), preferably a minimum first peak of at least about 1000 cP, and a maximum first peak of no greater than about 1750 cP, preferably no greater than about 1500 cP, with an average first peak of about 1200 cP±225 cP, (b) a minimum peak time of at least about 4.5 seconds, preferably at least about 5 seconds, a maximum peak time of no more than about 6 seconds, preferably no more than about 5.5 seconds, and an average peak time of about 5.2 seconds±1 second, (c) a minimum first trough of at least about 1800 cP, preferably a minimum first trough of at least about 500 cP, and a maximum first trough of no more than about 1000 cP, preferably a maximum first trough of no more than about 900 cP with an average first trough of about 725 cP±150 cP, (d) a minimum breakdown viscosity of at least about 300 cP, preferably a minimum breakdown viscosity of at least about 350 cP, a maximum breakdown viscosity of no more than about 650 cP, preferably a maximum breakdown viscosity of no more than about 600 cP, with an average breakdown viscosity of about 480 cP±100 cP, (c) a minimum final viscosity of at least about 850 cp, preferably a minimum final viscosity of at least about 900 cP, a maximum final viscosity of no more than about 1800 cP, preferably a maximum final viscosity of no more than about 1600 cP, with an average final viscosity of about 1285 cP±250 cP, (f) a minimum setback viscosity of at least about 400 cP, preferably a minimum setback viscosity of at least about 450 cP, a maximum setback viscosity of no more than about 750 cP, preferably a maximum setback viscosity of no more than about 700 cP, with an average setback viscosity of about 570 cP±100 cP, and (g) a pasting temperature of between 70° Celsius and 95° Celsius, preferably between 75° Celsius and 90° Celsius, more preferably between about 77° Celsius and about 85° Celsius, and preferably having an average pasting temperature of about 81° Celsius±5° Celsius. In a preferred clumping agent additive embodiment, these RVA parameters define a clumping agent additive 40 of the present invention extruded from wheat, such as preferably a whole grain wheat, which not only agglutinates when wetted with water a single time by being hydrated a single time but which advantageously also causes non-clumping litter to clump and clumping litter to clump better when added thereto.

With reference once again to FIG. 7, after pre-rehydration in being wetted or hydrated a first time, the samples of the clumping agent additive flour or powder were then dried to a moisture content of about 10% by weight before being rehydrated by being rewetted with water. The pre-rehydrated or single time hydrated and dried samples dissolved or that went into solution in water were then tested in accordance with the test procedure disclosed above using the Perten Instruments RVA to produce the respective RVA curves 84b, 86b, and 88b of graph 82b in FIG. 7 depicting the RVA characteristics of the samples of clumping agent additive 40 during rehydration in being rewetted or hydrated a second time. It has been discovered that, after being wetted or hydrated a first time, dried, and then rewetted or rehydrated, the clumping agent additive samples unexpectedly still agglutinate as evidenced by the RVA characteristics exhibited in these curves 84b, 86b, and 88b. These curves 84b, 86b, and 88b further help to show the advantageous agglutinating properties of the samples of clumping agent additive 40 at pre-rehydration in being hydrated a first time as the below-disclosed RVA parameters obtained from testing used to generate these curves also further define desired RVA characteristics of such a clumping agent additive 40 added to granular litter that advantageously causes the litter (a) to clump, where the litter to which it was added was non-clumping, or (b) to perform better in some way, preferably clump better in some way, where the original or base granular litter to which it was added was a clumping litter. To put it a different way, by the clumping agent additive 40 still being able to agglutinate after rewetting or rehydration, these curves and the RVA parameters used to generate these curves further help define a clumping agent additive 40 in accordance with the present invention that, when added to granular litter, causes the litter to clump, where the litter to which it was added was non-clumping, and causes the litter to clump better in some way by improving one or more properties, including one or more clumping properties, of the litter, where the litter to which it was added was a clumping litter.

As is depicted by the RVA curves 84b, 86b, and 88b in FIG. 7 from the test data used to generate the curves 84b, 86b, and 88b, a rehydrated clumping agent additive 40 in accordance with the present invention has (a) a minimum first peak of at least about 1250 centipoise (cP), preferably a minimum first peak of at least about 1250 cP, and a maximum first peak of no greater than about 2500 cP, preferably no greater than about 2250 cP, with an average first peak of about 1760 cP±300 cP, (b) a minimum peak time of at least about 5 seconds, preferably at least about 5.5 seconds, a maximum peak time of no more than about 8 seconds, preferably no more than about 7.5 seconds, and an average peak time of about 6.7 seconds±1 second, (c) a minimum first trough of 1200 cP, preferably a minimum first trough of about 1300 cP, and a maximum first trough of about 2400 cP, preferably a maximum first trough of about 2100 with an average first trough of about 1675 cP±350 cP, (d) a minimum breakdown viscosity of at least about 40 cP, preferably a minimum breakdown viscosity of at least about 50 cP, a maximum breakdown viscosity of no more than about 400 cP, preferably a maximum breakdown viscosity of no greater than about 200 cP, with an average breakdown viscosity of about 90 cP±50 cP, (c) a minimum final viscosity of at least 2400 cp, preferably a minimum final viscosity of at least about 2500 cP, a maximum final viscosity of no more than 4250 cP, preferably a maximum final viscosity of no greater than about 4000 cP, with an average final viscosity of about 3230 cP±750 cP, (f) a minimum setback viscosity of at least 900 cP, preferably a minimum setback viscosity of at least about 1000 cP, a maximum setback viscosity of no greater than about 2250 cP, preferably a maximum setback viscosity of no more than about 2000 cP, with an average setback viscosity of about 1550 cP±500 cP, and (g) a pasting temperature of between 60° Celsius and 85° Celsius, preferably between 65° Celsius and 80° Celsius, more preferably between about 67° Celsius and about 77° Celsius and preferably having an average pasting temperature of about 72° Celsius±5° Celsius. These additional RVA parameters further define such a clumping agent additive 40 of the present invention extruded from wheat, such as preferably a whole grain wheat, which not only agglutinates when wetted with water a single time by being hydrated a single time but which especially advantageously also causes non-clumping litter to clump and clumping litter to clump better when added thereto.

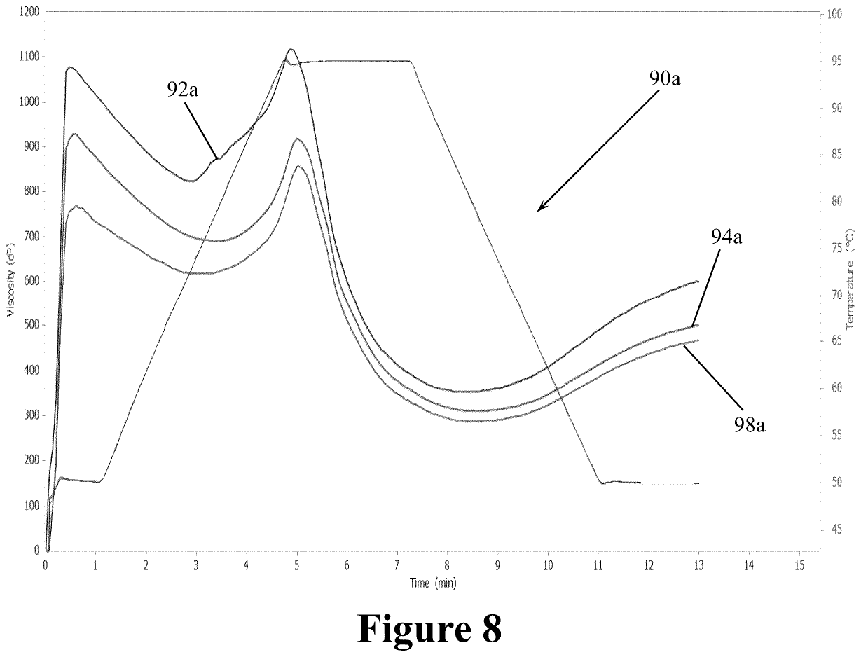

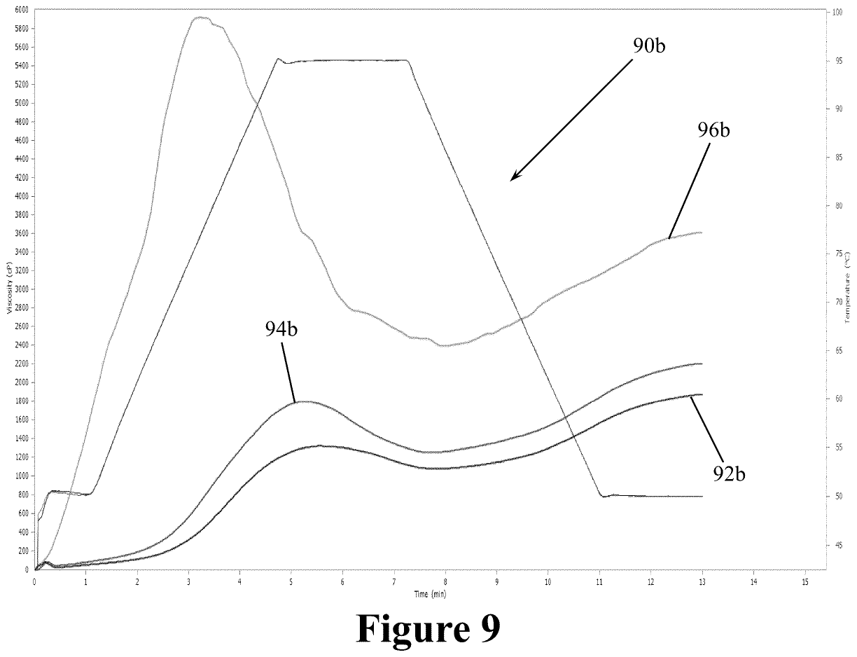

FIGS. 8 and 9 illustrate respective charts 90a, 90b of RVA curves 92a, 94a and 96a in FIG. 8 and RVA curves 92b, 94b, and 96b in FIG. 9 for a set of samples of a second preferred embodiment of an extruded clumping agent additive 40 of the present invention that not only agglutinates upon being wetted with water a first time, such as characterized by RVA curves 92a, 94a and 96a of FIG. 8, but which also unexpectedly advantageously agglutinates upon being dried and rewetted or rehydrated with water by being wetted a second time with water, such as characterized by RVA curves 92b, 94b, and 96b of FIG. 9. The clumping agent additive 40 whose RVA curves 92a, 92b, 94a, 94b, 96a and 96b are respectively depicted in FIGS. 8 and 9 is extruded using single screw extruder having a horsepower of about 100 hp with the clumping agent additive extrudate being extruded through a perforate extrusion die, such as a die having about 0.050 inch die holes, from a starch-containing admixture having a moisture content of no greater than 25%, preferably no greater than 20%, and more preferably no greater than about 17%±2% by admixture weight that preferably is composed substantially completely of wheat, such as preferably a whole grain wheat. The admixture contains at least 40%, preferably at least 50%, more preferably at least 65% starch. No moisture is added to the admixture while it is in the extruder. During extrusion, the extruder subjects the admixture to an extrusion pressure of at least about 2000, PSI, preferably at least 2500 PSI, more preferably at least 3000 PSI, even more preferably at least 4000 PSI, yet even more preferably at least 5000 PSI, and still yet even more preferably between about 2000 PSI±500 PSI and about 5000 PSI±1000 PSI, in the extruder and an extrusion temperature of at least about 100° C., preferably at least 130° C. and no greater than 180° C., preferably no greater than about 150° C., and preferably about 140° C. for a residency time of at least three seconds and no greater than twenty seconds, preferably between three seconds and fifteen seconds, and more preferably between about four seconds and about eight seconds gelatinizing at least 40%, preferably at least 50%, more preferably at least 75%, and even more preferably between about 75% and about 95% of the starch in the admixture.

Upon exiting the extrusion die of the extruder, the clumping agent additive extrudate also is rapidly cooled and dried without adding any heat thereto, preferably by air quenching the extrudate immediately upon exiting the die of the extruder using turbulently flowing air to freeze the state of extrusion-modified starches in the extrudate formed of starch modified, preferably at least partially physically modified, from being subjected to ultrahigh extrusion pressure in the extruder into an extrusion-modified starch water-soluble binder clumping agent, including any water-soluble binder clumping agent composed of extrusion-modified starch pregelatinized starch (extrusion-modified starch pregel). The extrudate is typically in pelletized form from being cut into pellets as the extrudate is being discharged from the extruder die, can thereafter be and preferably is comminuted into smaller particles 46 having a sufficiently small particle size and/or falling within a desirably small particle size range as discussed elsewhere herein which are suitably small enough for use as clumping agent additive 40 of the present invention.

For purposes of preparing a second set of samples of the extrudate tested with the RVA to produce pre-rehydration RVA curves 92a, 94a and 96a of graph 90a in FIG. 8 and thereafter the post-rehydration curves 92b, 94b and 96b of graph 90b in FIG. 9, the clumping agent additive extrudate was comminuted into particles having sizes smaller than the particles 46 used as clumping agent additive 40 preferably comminuting it into a flour or powder, having particle with sizes smaller than 250 μm which pass through a 60 mesh screen. Each sample of the second set of samples of clumping agent additive extrudate or extruded clumping agent additive 40 were tested using a standard “flour” pasting cycle (the AACCI/Cereals & Grains standard method for wheat and rye flour) with each sample tested composed of about 3.34 grams of extruded clumping agent additive flour or powder added to about 25.16 grams of distilled water without any mixing or shaking, including without any manual mixing or shaking being performed. Each sample was tested using a Perten Instruments RVA 450 Rapid Visco Analyzer made, sold and/or distributed by PerkinElmer® of 940 Winter Street, Waltham, Massachusetts operated according to parameters set forth above in Table 1.

With continued reference to FIG. 8, each sample of the clumping agent additive flour or powder having a moisture content of about 10% by weight dissolved or that went into solution in water were tested in accordance with the test procedure set forth above in the preceding paragraph using the Perten Instruments RVA to produce the RVA test data used to generate the respective RVA curves 92a, 94a, and 96a of the graph 90a in FIG. 8. These curves 92a, 94a, and 96 help show the advantageous agglutinating properties of the samples of clumping agent additive 40 at pre-rehydration in being hydrated a first time as the below-disclosed RVA parameters obtained from testing used to generate these curves also define desired RVA characteristics of a preferred embodiment of a clumping agent additive 40 added to granular litter that advantageously produces a resultant clumping agent enhanced litter (a) that clumps, where the original or base litter to which it was added was a non-clumping litter, or (b) performs better in some way, preferably clumps better in some way, where the original or base litter to which it was added was a clumping litter. Where added to a base litter that is a clumping litter, the resultant clumping agent additive enhanced litter has one or more litter properties and/or one or more clumping properties that are improved over the same litter properties and/or clumping properties of the base litter before adding any clumping agent additive 40 to it, i.e., a base litter that contains no clumping agent additive 40.

As is depicted by the RVA curves 92a, 94a, and 96 in FIG. 8 from the RVA test data from RVA testing the clumping agent additive samples used to generate the curves 92a, 94a, and 96, a preferred embodiment of a clumping agent additive 40 of the present invention which agglutinates when wetted or hydrated a single time, e.g., pre-rehydrated, thereby promoting clumping of litter to which it is added preferably has (a) a minimum first peak of at least about 750 centipoise (cP), preferably a minimum first peak of at least about 800 cP, and a maximum first peak of no greater than about 1350 cP, preferably no greater than about 1200 cP, with an average first peak of about 965 cP±150 cP, (b) a minimum peak time of at least about 4 seconds, preferably at least about 4.5 seconds, a maximum peak time of no more than about 6 seconds, preferably no more than about 5.5 seconds, and an average peak time of about 5 seconds±0.5 seconds, (c) a minimum first trough of at least about 200 cP, preferably a minimum first trough of at least about 250 cP, and a maximum first trough of no more than about 500 cP, preferably a maximum first trough of no more than about 400 cP with an average first trough of about 315 cP±40 cP, (d) a minimum breakdown viscosity of at least about 450 cP, preferably a minimum breakdown viscosity of at least about 500 cP, a maximum breakdown viscosity of no more than about 850 cP, preferably a maximum breakdown viscosity of no more than about 800 cP, with an average breakdown viscosity of about 650 cP±125 cP, (c) a minimum final viscosity of at least about 400 cp, preferably a minimum final viscosity of at least about 450 cP, a maximum final viscosity of no more than about 700 cP, preferably a maximum final viscosity of no more than about 650 cP, with an average final viscosity of about 525 cP±85 cP, (f) a minimum setback viscosity of at least about 100 cP, preferably a minimum setback viscosity of at least about 150 cP, a maximum setback viscosity of no more than about 350 cP, preferably a maximum setback viscosity of no more than about 300 cP, with an average setback viscosity of about 205 cP±50 cP, and (g) a pasting temperature of between 85° Celsius and 100° Celsius, preferably between 87° Celsius and 97° Celsius, more preferably between about 90° Celsius and about 95° Celsius, and which has an average pasting temperature of about 94° Celsius±4° Celsius. In a preferred clumping agent additive embodiment, these RVA parameters define a clumping agent additive 40 of the present invention extruded from wheat, such as preferably a whole grain wheat, which not only agglutinates when wetted with water a single time by being hydrated a single time but which advantageously also causes non-clumping litter to clump and clumping litter to clump better when added thereto.

With reference once again to FIG. 9, after pre-rehydration in being wetted or hydrated a first time, the samples of the clumping agent additive flour or powder were then dried to a moisture content of about 10% by weight before being rehydrated by being rewetted with water. The pre-rehydrated or single time hydrated and dried samples dissolved or that went into solution in water were then tested in accordance with the test procedure disclosed above using the Perten Instruments RVA to produce the respective RVA curves 92b, 94b, and 96b of graph 90b in FIG. 9 depicting the RVA characteristics of the samples of preferred clumping agent additive 40 during rehydration in being rewetted or hydrated a second time. It has been discovered that, after being wetted or hydrated a first time, dried, and then rewetted or rehydrated, the clumping agent additive samples unexpectedly still agglutinate as evidenced by the RVA characteristics exhibited in these curves 92b, 94b, and 96b. These curves 92b, 94b, and 96b further help to show the advantageous agglutinating properties of the samples of clumping agent additive 40 during rehydration in being rewetted or hydrated a second time as the below-disclosed RVA parameters obtained from testing used to generate these curves also further define desired RVA characteristics of such a clumping agent additive 40 added to an original or base granular litter that advantageously causes the resultant clumping agent additive enhanced litter (a) to clump, where the original or base litter to which the clumping agent additive 40 was added was non-clumping, or (b) to perform better in some way, preferably clump better in some way, where the original or base granular litter to which the clumping agent additive 40 was added was a clumping litter. To put it a different way, by the clumping agent additive 40 still being able to agglutinate after rewetting or rehydration, the aforementioned curves and the RVA parameters used to generate these curves even further help define a clumping agent additive 40 in accordance with the present invention that, when added to original or base granular litter, causes the litter to clump, where the original or base litter to which the clumping agent additive 40 was added was non-clumping, and causes the litter to clump better in some way by improving one or more properties, preferably by improving one or more clumping properties, of the litter, where the original or base litter to which the clumping agent additive 40 was added was a clumping litter.

As is depicted by the RVA curves 92b, 94b, and 96b in FIG. 9 from the test data used to generate these curves 92b, 94b, and 96b, a rehydrated clumping agent additive 40 in accordance with the present invention has (a) a minimum first peak of at least about 1000 centipoise (cP), preferably a minimum first peak of at least about 1250 cP, and a maximum first peak of no greater than about 2250 cP, preferably no greater than about 2000 cP, with an average first peak of about 1550 cP±300 cP, (b) a minimum peak time of at least about 3.5 seconds, preferably at least about 4 seconds, a maximum peak time of no more than about 6.5 seconds, preferably no more than about 6 seconds, and an average peak time of about 5.4 seconds±1 second, (c) a minimum first trough of about 850 cP, preferably a minimum first trough of about 900 cP, and a maximum first trough of about 1500 cP, preferably a maximum first trough of about 1350 with an average first trough of about 1150 cP±150 cP, (d) a minimum breakdown viscosity of at least about 150 cP, preferably a minimum breakdown viscosity of at least about 200 cP, a maximum breakdown viscosity of no more than about 650 cP, preferably a maximum breakdown viscosity of no greater than about 600 cP, with an average breakdown viscosity of about 400 cP±175 cP, (c) a minimum final viscosity of at least 1500 cp, preferably a minimum final viscosity of at least about 1750 cP, a maximum final viscosity of no more than about 2750 cP, preferably a maximum final viscosity of no greater than about 2500 cP, with an average final viscosity of about 2050 cP±200 cP, (f) a minimum setback viscosity of at least 600 cP, preferably a minimum setback viscosity of at least about 650 cP, a maximum setback viscosity of no greater than about 1150 cP, preferably a maximum setback viscosity of no more than about 1050 cP, with an average setback viscosity of about 875 cP±125 cP, and (g) a pasting temperature of between 55° Celsius and 80° Celsius, preferably between 60° Celsius and 75° Celsius, more preferably between about 62.5° Celsius and about 72.5° Celsius and preferably having an average pasting temperature of about 68° Celsius±5° Celsius. These additional RVA parameters further define such a preferred embodiment of a clumping agent additive 40 extruded from wheat, such as preferably a whole grain wheat, which not only agglutinates when wetted with water a single time by being hydrated a single time but which unexpectedly continues to agglutinate when rehydrated by being rewetted or hydrated a second time after being dried producing a clumping agent additive 40 in accordance with the present invention which advantageously causes non-clumping litter to clump and clumping litter to clump better when added thereto.

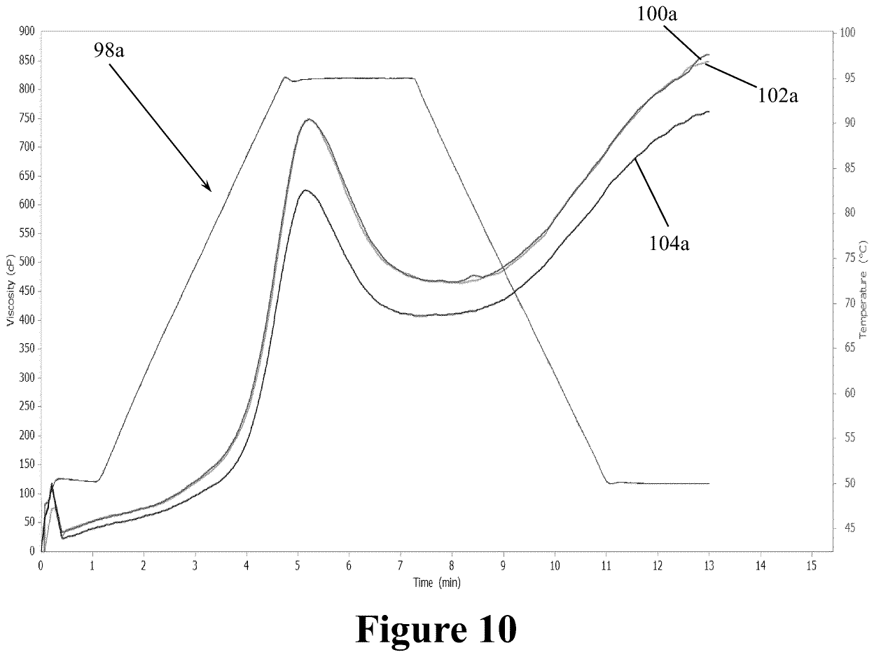

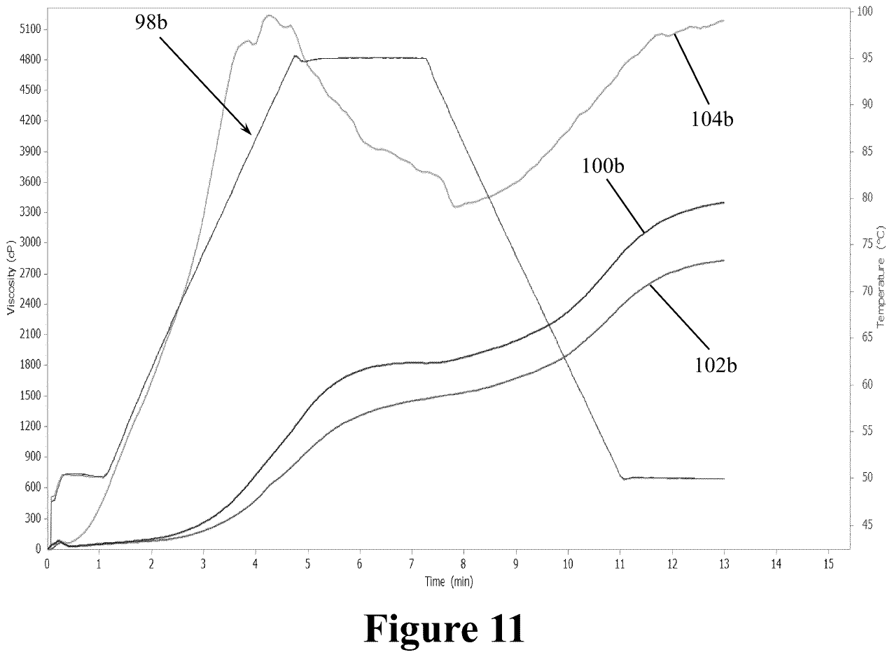

FIGS. 10 and 11 illustrate respective charts 98a, 98b of RVA curves 100a, 102a and 104a in FIG. 10 and RVA curves 100b, 102b, and 104b in FIG. 11 for samples of a third preferred embodiment of an extruded clumping agent additive 40 of the present invention that not only agglutinates upon being wetted with water a first time, such as characterized by RVA curves 100a, 102a and 104a of FIG. 10, but which also unexpectedly advantageously agglutinates upon being dried and rewetted or rehydrated with water by being wetted a second time with water, such as characterized by RVA curves 100b, 102b, and 104b of FIG. 11. The clumping agent additive 40 whose RVA curves 100a, 100b, 102a, 102b, 104a and 104b are respectively depicted in FIGS. 10 and 11 is extruded using a single screw extruder having a horsepower rating of about 100 hp with the clumping agent additive extrudate discharged through an extrusion die having about 0.050 inch die holes from a starch-containing admixture having a moisture content of no greater than 25%, preferably no greater than 20%, and more preferably no greater than about 17%±2% by admixture weight that preferably is composed substantially completely of wheat, such as preferably a whole grain wheat. The admixture contains at least 40%, preferably at least 50%, more preferably at least 65% starch. No moisture is added to the admixture while it is in the extruder. During extrusion, the extruder subjects the admixture to an extrusion pressure of at least about 2000, PSI, preferably at least 2500 PSI, more preferably at least 3000 PSI, even more preferably at least 4000 PSI, yet even more preferably at least 5000 PSI, and still yet even more preferably between about 2000 PSI±500 PSI and about 5000 PSI±1000 PSI, in the extruder and an extrusion temperature of at least about 100° C., preferably at least 130° C. and no greater than 180° C., preferably no greater than about 150° C., and preferably about 140° C. for a residency time of at least three seconds and no greater than twenty seconds, preferably between three seconds and fifteen seconds, and more preferably between about four seconds and about eight seconds gelatinizing at least 40%, preferably at least 50%, more preferably at least 75%, and even more preferably between about 75% and about 95% of the starch in the admixture.

Upon exiting the extrusion die of the extruder, the clumping agent additive extrudate also is rapidly cooled and dried without adding any heat thereto, preferably by air quenching the extrudate immediately upon exiting the die of the extruder using turbulently flowing air to freeze the state of extrusion-modified starches in the extrudate formed of starch modified, preferably at least partially physically modified, from being subjected to ultrahigh extrusion pressure in the extruder into an extrusion-modified starch water-soluble binder clumping agent, including any water-soluble binder clumping agent composed of extrusion-modified starch pregelatinized starch (extrusion-modified starch pregel). The extrudate is typically in pelletized form from being cut into pellets as the extrudate is being discharged from the extruder die, can thereafter be and preferably is comminuted into smaller particles 46 having a sufficiently small particle size and/or falling within a desirably small particle size range as discussed elsewhere herein which are suitably small enough for use as clumping agent additive 40 of the present invention.

For purposes of preparation of a third set of samples of the extrudate that were tested with the RVA that produced the pre-rehydration RVA curves 100a, 102a and 104a of graph 98a in FIG. 10 and thereafter the post-rehydration curves 100b, 102b and 104b of graph 98b in FIG. 11, the clumping agent additive extrudate was comminuted into particles 46 having sizes ranging between about 400 μm and about 2380 μm which pass through a 9 mesh screen and are retained on top of a 40 mesh screen. Each sample of the particles 46 of clumping agent additive extrudate or extruded clumping agent additive 40 were tested using a standard “flour” pasting cycle (the AACCI/Cereals & Grains standard method for wheat and rye flour) with each sample tested composed of about 3.34 grams of the extruded clumping agent additive particles 46 having particle sizes between about 400 μm and about 2380 μm added to about 25.16 grams of distilled water without any mixing or shaking, including without any manual mixing or shaking being performed. Each sample was tested using a Perten Instruments RVA 450 Rapid Visco Analyzer made, sold and/or distributed by PerkinElmer® of 940 Winter Street, Waltham, Massachusetts operated according to parameters set forth above in Table 1.

With continued reference to FIG. 10, each sample of the particles 46 of the third preferred embodiment of clumping agent additive 40 of the third set of test samples having a moisture content of about 10% by weight dissolved or that went into solution in water were tested in accordance with the test procedure set forth above in the preceding paragraph using the Perten Instruments RVA to produce RVA test data used to generate the respective RVA curves 92a, 94a, and 96a of the graph 90a in FIG. 8. These curves 92a, 94a, and 96 help show the advantageous agglutinating properties of the samples of clumping agent additive particles 46 at a pre-rehydration stage where the particles 46 were hydrated a first time with the RVA data of the below-disclosed RVA parameters obtained from testing that were used to generate these curves also define desired RVA characteristics of this preferred embodiment of clumping agent additive 40 added to granular litter advantageously producing a resultant clumping agent enhanced litter (a) that clumps, where the original or base litter to which it was added was a non-clumping litter, and/or (b) performs better in some way, preferably clumps better in some way, where the original or base litter to which it was added was a clumping litter. Where added to a base litter that is a clumping litter, the resultant clumping agent additive enhanced litter performs and/or clumps better by having one or more litter properties and/or one or more clumping properties that are improved over the same litter properties and/or clumping properties of the base litter before the addition of any clumping agent additive 40 to it, i.e., a base litter that contains no clumping agent additive 40.

As is depicted by the RVA curves 100a, 102a, and 104a in FIG. 10 from the RVA test data from RVA testing the clumping agent additive samples used to generate the curves 100a, 102a, and 104a, this preferred third embodiment of a clumping agent additive 40 of the present invention which agglutinates when wetted or hydrated a single time, e.g., pre-rehydrated, thereby promoting clumping of litter to which it is added preferably has (a) a minimum first peak of at least about 500 centipoise (cP), preferably a minimum first peak of at least about 600 cP, and a maximum first peak of no greater than about 900 cP, preferably no greater than about 850 cP, with an average first peak of about 700 cP±125 cP, (b) a minimum peak time of at least about 4 seconds, preferably at least about 4.5 seconds, a maximum peak time of no more than about 6 seconds, preferably no more than about 5.5 seconds, and an average peak time of about 5 seconds±0.75 seconds, (c) a minimum first trough of at least about 300 cP, preferably a minimum first trough of at least about 350 cP, and a maximum first trough of no more than about 550 cP, preferably a maximum first trough of no more than about 500 cP with an average first trough of about 450 cP±75 cP, (d) a minimum breakdown viscosity of at least about 100 cP, preferably a minimum breakdown viscosity of at least about 150 cP, a maximum breakdown viscosity of no more than about 450 cP, preferably a maximum breakdown viscosity of no more than about 400 cP, with an average breakdown viscosity of about 260 cP±125 cP, (c) a minimum final viscosity of at least about 600 cp, preferably a minimum final viscosity of at least about 675 cP, a maximum final viscosity of no more than about 1000 cP, preferably a maximum final viscosity of no more than about 925 cP, with an average final viscosity of about 825 cP±75 cP, (f) a minimum setback viscosity of at least about 250 cP, preferably a minimum setback viscosity of at least about 300 cP, a maximum setback viscosity of no more than about 550 cP, preferably a maximum setback viscosity of no more than about 450 cP, with an average setback viscosity of about 375 cP±75 cP, and (g) a pasting temperature of between 70° Celsius and 100° Celsius, preferably between 75° Celsius and 95° Celsius, more preferably between about 80° Celsius and about 92.5° Celsius, and which has an average pasting temperature of about 87° Celsius±5° Celsius. In a preferred clumping agent additive embodiment, these RVA parameters define a clumping agent additive 40 of the present invention extruded from wheat, such as preferably a whole grain wheat, which, by agglutinating so strongly when wetted with water a single time by being hydrated a single time, advantageously causes non-clumping litter to clump and clumping litter to clump better when a sufficient amount of particles 46 of clumping agent additive 40 are added thereto.

With reference once again to FIG. 11, after pre-rehydration by being wetted or hydrated the first time, the samples of clumping agent additive particles 46 were then dried to a moisture content of about 10% by weight before being rehydrated by being rewetted with water. The pre-rehydrated or single time hydrated and dried samples dissolved or that went into solution in water were then tested in accordance with the test procedure disclosed above using the Perten Instruments RVA to produce the respective RVA curves 100b, 102b, and 104b of graph 98b in FIG. 11 depicting the RVA characteristics of the samples of preferred clumping agent additive 40 during rehydration by being rewetted or hydrated a second time. It has been unexpectedly discovered that, after being wetted or hydrated a first time, dried, and then rewetted or rehydrated by hydrating a second time, the samples of clumping agent additive particles 46 advantageously still agglutinate as evidenced by the RVA characteristics exhibited in these curves 100b, 102b, and 104b. These curves 100b, 102b, and 104b therefore also help show that the advantageous agglutinating properties of the clumping agent additive 40 continue after rehydration by being rewetted or hydrated a second time. This is because the below-disclosed RVA parameters obtained from testing used to generate these curves also further defines desired RVA characteristics of clumping agent additive 40 added to granular litter that advantageously causes the resultant clumping agent additive enhanced litter to clump, where the original or base granular litter to which the particles 46 of clumping agent additive 40 were added was non-clumping, and/or to perform better in some way, such as preferably clump better in some way, where the original or base granular litter to which the particles 46 of clumping agent additive 40 were added was a clumping litter. To put it a different way, by the clumping agent additive 40 still being able to agglutinate after rewetting or rehydration, these curves 100b, 102b, and 104b and the RVA parameters of the RVA data used to generate these curves further help define a clumping agent additive 40 in accordance with the present invention that, when added to a granular litter, such as a commercially available litter purchased by a user, causes the litter to clump, where the original or base litter to which it was added was non-clumping, and causes the litter to perform preferably by clumping better in some way by improving one or more properties of the original or base litter, preferably by improving one or more clumping properties, of the original or base litter, where the original or base litter to which it was added was a clumping litter.

As is depicted by the RVA curves 100b, 102b, and 104b in FIG. 11 from the test data used to generate these curves 100b, 102b, and 104b, a rehydrated clumping agent additive 40 in accordance with the present invention has (a) a minimum first peak of at least about 1000 centipoise (cP), preferably a minimum first peak of at least about 1250 cP, and a maximum first peak of no greater than about 2250 cP, preferably no greater than about 2000 cP, with an average first peak of about 1650 cP±200 cP, (b) a minimum peak time of at least about 5 seconds, preferably at least about 6 seconds, a maximum peak time of no more than about 9 seconds, preferably no more than about 8 seconds, and an average peak time of about 7 seconds±1 second, (c) a minimum first trough of about 1000 cP, preferably a minimum first trough of about 1150 cP, and a maximum first trough of about 2000 cP, preferably a maximum first trough of about 1850 cP with an average first trough of about 1550 cP±250 cP, (d) a minimum breakdown viscosity of at least about 40 cP, preferably a minimum breakdown viscosity of at least about 50 cP, a maximum breakdown viscosity of no more than about 250 cP, preferably a maximum breakdown viscosity of no greater than about 200 cP, with an average breakdown viscosity of about 100 cP±75 cP, (c) a minimum final viscosity of at least 1750 cp, preferably a minimum final viscosity of at least about 2250 cP, a maximum final viscosity of no more than about 5000 cP, preferably a maximum final viscosity of no greater than about 3750 cP, with an average final viscosity of about 3125 cP±350 cP, (f) a minimum setback viscosity of at least 1000 cP, preferably a minimum setback viscosity of at least about 1250 cP, a maximum setback viscosity of no greater than about 2250 cP, preferably a maximum setback viscosity of no more than about 1900 cP, with an average setback viscosity of about 1650 cP±250 cP, and (g) a pasting temperature of between 50° Celsius and 90° Celsius, preferably between 50° Celsius and 80° Celsius, more preferably between about 60° Celsius and about 80° Celsius and preferably having an average pasting temperature of about 67° Celsius±15° Celsius. These additional RVA parameters further define such a third preferred embodiment of a clumping agent additive 40 of the present invention extruded from wheat, such as preferably a whole grain wheat, which not only agglutinates when wetted with water a single time by being hydrated a single time but which continues to agglutinate when dried and rewetted or hydrated a second time unexpectedly causing non-clumping litter to clump and clumping litter to clump better when at least a plurality of pairs, i.e., at least three, of particles 46 of the clumping agent additive 40 added thereto.

### Other Aspects of the Invention

The present invention also is directed to an extruded gelling constituent of the extruded clumping agent additive 40 that is composed of a gelling constituent extrudate extruded from a starch-containing admixture, like one of the starch-containing admixtures disclosed elsewhere herein, that is subjected to sufficiently high extrusion pressures and extrusion conditions in accordance with the extrusion temperatures and ultrahigh extrusion pressures disclosed elsewhere herein, within an extruder, preferably a single extruder, to modify, preferably physically modify, starch in the admixture into a water-soluble extrusion-modified starch gellant in the particles 46 of extruded clumping agent additive 40 that gels and/or forms a gel when the particles 46 are wetted with water. Wetting with water, preferably cold water or room temperature water, causes the gelling constituent extrudate and/or extruded gelling constituent composed of the gelling constituent extrudate in the particles 46 of extruded clumping agent additive 40 to gel and/or form a gel when wetted with water. As disclosed in more detail below, in one preferred embodiment, other starch(es) of the starch-containing admixture is modified, preferably also physically modified, by the high extrusion pressure and extrusion conditions within the single screw extruder such that pregelatinized starch also is formed in the gelling constituent extrudate of the extruded clumping agent additive 40 producing an extruded clumping agent additive 40 containing an extruded gelling constituent in accordance with the present invention. This can configure the extruded clumping agent additive 40 with two-component gelling, with each particle 46 having one gelling component provided by the water-soluble extrusion-modified starch gellant in the gelling constituent of the particulate extrudate 46, and the other gelling component provided by the water-soluble pregelatinized starch in the gelling constituent of the particulate extrudate 46.

In one preferred embodiment, the extrusion pressures and extrusion conditions within the single screw extruder modify some of the starch in the starch-containing admixture into a plurality of different molecular weight extrusion-modified starch polymers or starch-based polymers that form the water-soluble extrusion-modified starch gellant in the particles 46 of extruded clumping agent additive 40 that polymerize into a hydrocolloid gel when wetted with and/or preferably mixed with water. In another preferred embodiment, the extrusion pressures and extrusion conditions within the extruder also modify and/or free up some of the protein or proteins in the starch-containing admixture into a crosslinker that forms part of the water-soluble extrusion-modified starch gellant that crosslinks the plurality of different molecular weight starch polymers or starch-based polymers of the gellant when particles 46 of the extruded clumping agent additive 40 are wetted with and/or preferably mixed with water. In one such preferred embodiment where the water-soluble extrusion-modified starch gellant contains both (a) extrusion-modified starch or starches that forms a plurality of different molecular weight extrusion-modified starch polymers or different molecular weight extrusion-modified starch-based polymers, and (b) extrusion-modified or extrusion-freed protein or proteins that crosslink the different molecular weight extrusion-modified starch polymers or different molecular weight extrusion-modified starch-based polymers when an extruded gelling constituent composed of extrudate containing such an extrusion-modified starch polymer and protein crosslinker starch gellant is wetted with water, the resultant self-gelling gel formed in the particles 46 of the extruded clumping agent additive 40 preferably is a thermoreversible gel, a moisture re-activatable and/or moisture re-curable gel, a moisture re-activatable, a moisture re-curable at least partially water-soluble ultrahigh pressure extrusion modified starch binder, and/or a moisture re-curable at least partially water-soluble flowable adhesive component in the at least partially water soluble ultrahigh pressure extrusion modified starch binder in each particle 46.

It was previously thought that extruded particles 46 of modified starch liquid absorbent extruded clumping agent additive 40 of the present invention made using air quenching that freezes the state of its modified water-soluble starches only forms an at least partially water-soluble binder and an at least partially water-soluble flowable adhesive that can only be water-activated and moisture-cured a single time once wetted with water or urine. It is therefore an unexpected surprise that at least some of the ultrahigh pressure extrusion modified starch in the particles 46 of the modified starch water absorbent extruded clumping agent additive 40 that is or forms the at least partially water-soluble binder and at least partially water soluble flowable adhesive in each particle 46 can be at least partially solubilized, water re-activated, and moisture re-cured at least one and preferably at least a plurality of times after previously being wetted, water activated and moisture cured with room temperature water or cat body temperature urine.

In a preferred embodiment, the water-soluble extrusion-modified starch gellant in each particle 46 of extruded clumping agent additive 40 is a cold-water soluble hydrocolloid, which when wetted with room temperature water mixed therewith, forms a gel, preferably a self-gelling gel, which is thermally stable, and which preferably produces thermally and shelf-life stable emulsions when mixed with an aqueous liquid, preferably water, such as preferably using a high shear mixer or another mixer or blender forming a slurry. In one such preferred embodiment, the extruded gelling constituent of each particle 46 is composed of a gelling constituent extrudate that not only contains water-soluble extrusion-modified starch gellant but also contains pregelatinized starch formed of other starch in the admixture modified, preferably also physically modified by extrusion pressure during extrusion into pregelatinized starch, which also gels when wetted with water mixed therewith producing a dual-gelling component gelling constituent in each particle 46 of the extrudate 40 that contains not only one gelling component, namely a water-soluble extrusion-modified starch gellant that gels when particle(s) 46 are wetted, but which also contains a second gelling component, namely a pregelatinized starch that also gels when particle(s) 46 are wetted.

In a preferred embodiment, during wetting of at least a plurality of pairs of particles 46 of extruded clumping agent additive 40 of the present invention where 400 grams of the particles 46 are wetted with 200 grams of water, e.g., 2% saline solution, at room temperature, e.g., between 68° F. and 74° F., the viscosity at wetting or at the beginning of wetting of the particles 46 as measured with a Brookfield DV3T viscometer at a spindle rotation of 50 RPM rapidly increases from about 33-35 centipoise at wetting as the water solubilizes water-soluble binder in each wetted granule forming a flowable adhesive whose viscosity increases to at least 200-400 centipoise within one second after wetting, increases to at least 450-800 centipoise after one second and within five seconds after wetting, increases to at least 850-1200 centipoise after five seconds and within 10 seconds of wetting such that the water in solubilizing water-activated moisture-curing water-soluble binder forms a relatively high viscosity flowable adhesive gel that relatively rapidly adheres together the at least plurality of pairs of wetted particles 46 and litter granules 48 or 48a and 48b forming a clump 56 thereof. In another preferred embodiment, during wetting of such a plurality of pairs of particles 46 where 200 grams of the particles 46 are wetted with 200 grams of water, e.g., 2% saline solution, at room temperature, the viscosity at wetting or at the beginning of wetting of the particles as measured with a Brookfield DV3T viscometer at a spindle rotation of 50 RPM rapidly increases from about 37-40 centipoise at the time of initial wetting of the particles 46 as the water solubilizes water-soluble binder in each wetted particle 46 forming a flowable adhesive whose viscosity increases to at least 400 centipoise within one second after wetting, increases to at least 500 centipoise after one second and within five seconds after wetting, increases to at least 700 centipoise after five seconds and within 10 seconds after wetting, increases to at least 900-1500 centipoise after 10 seconds and within 20 seconds of wetting, increases to at least 1700-2300 centipoise after 20 seconds and within 25 seconds of wetting, increases to at least 2500-3000 centipoise after 25 seconds and within 30 seconds of wetting, increases to at least 5000-9000 centipoise after 30 seconds and within 40 seconds of wetting such that the water in solubilizing water-soluble binder forms a water-activated moisture-cured relatively high viscosity flowable adhesive gel that relatively rapidly adheres together the at least plurality of pairs of the particles 46 and litter granules 48 or 48a and 48b forming a clump 56 having a clump retention rate of at least 80%, preferably at least 85%, more preferably at least about 90% and a clump crush strength of at least 50 PSI, preferably at least 100 PSI, and more preferably at least 150 PSI, even more preferably at least 250 PSI when moisture cured by drying to a moisture content of no more than 12% by clump weight and clump tested using the clump compression strength test procedure below.

The present invention also is directed to an extruded clumping agent additive 40 containing a modified-starch water-absorbent mobile clumping agent that is mobile by being flowable when wetted with urine or water where at least some of the moisture-curing water-activated adhesive in each particle 46 of the extruded clumping agent additive 40 comprises a room temperature moisture-curing water-activated thermoset adhesive. In at least one embodiment, at least some of the moisture-curing water-activated adhesive in each particle 46 comprises a room temperature moisture-curing water-activated thermoplastic adhesive. Such a room temperature moisture-curing water-activated adhesive in each particle 46 preferably is comprised of a room temperature moisture-curing water-activated thermoset adhesive and a room temperature moisture-curing water-activated thermoplastic adhesive.

The modified-starch water-absorbent mobile clumping agent in each particle 46 can be comprised of (1) cold water swellable water-absorbent modified starch, and (2) cold water soluble modified starch binder that forms an at least partially water soluble flowable adhesive when wetted with an aqueous liquid or solution comprised of water, at least some which adhesively adheres to adjacent outer surfaces of litter granules 48 of litter 50 or granules 48a, 48b of multicomponent litter 50′ in a litter box 52 imparting facilitating clumping of the same and even imparting clumping thereto where the litter 50 or 50′ is non-clumping litter. The clumping agent in each particle 46 is comprised of (a) cold water swellable water-absorbent modified starch, and (b) cold water soluble modified starch binder that forms an at least partially water soluble flowable adhesive when wetted with an aqueous liquid or solution comprised of water, at least some which adhesively self-adheres the extrusion modified-starch water-absorbent clumping agent to outer surfaces of litter granules 48 or 48a and/or 48b in the litter box 52 when one of (1)(i) the modified-starch water-absorbent clumping agent, and (ii) the particle is wetted with an aqueous wetting liquid comprised of water, (2) wet modified-starch water-absorbent clumping agent from wetted particles 46 is disposed in contact with a wet outer surface of litter granules 48 or 48a and/or 48b in the litter box, and (3) the flowable adhesive thereafter moisture cures or sets solidifying into a solid hardened adhesive in a glassy material state that bonds the modified-starch water-absorbent clumping agent to outer surfaces of litter granules 48 or 48a and/or 48b in a litter box 52 forming a clump 56 on top thereof.

Over time, the flowable adhesive formed from the clumping agent wetted by urine or water during litter us cures or sets and becomes solid and hard. Over time, the moisture content is reduced, such as through evaporation, thereby transitioning the flowable adhesive formed of or by wetted clumping agent into a solid glassy material. Over time, the moisture content of the clumping agent is reduced until the flowable adhesive formed therefrom transitions from one of a flowable liquid and a gel into a solid glassy material that preferably is solid and more preferably hard to the touch.

Over time, the moisture content of the clumping agent is reduced to no more than about 8% by weight to cure or set the flowable adhesive formed when particles 46 from which the flowable adhesive flows were wetted thereby transitioning the flowable adhesive from one of a viscous liquid and a semi-solid gel into a solid glassy material that becomes hard to the touch. The at least partially water-soluble binder of the clumping agent in each particle 46 preferably comprises a water-activated and water-cured at least partially water-soluble binder. The water-activated and water-cured at least partially water-soluble binder of the clumping agent of each particle 46 is comprised of at least one of a modified starch, a thermomechanically modified starch, a thermally modified starch, a physically modified starch, a pregelatinized starch, and an instantized starch.

Modified-starch water-absorbent clumping agent in at least one preferred embodiment of particle 46 preferably comprises at least one or more of a water-activated adhesive, a water-activated modified starch adhesive, a water-activated physically modified starch adhesive, a water-activated thermomechanically modified starch adhesive, a water-activated degraded modified starch adhesive, a water-activated physically degraded modified starch adhesive, a water-activated pregelatinized starch adhesive and a water-activated instantized starch adhesive. Modified-starch water-absorbent clumping agent in at least one preferred embodiment of particle 46 preferably comprises at least one or more of a water-curing or water-cured adhesive, a water-curing or water-cured modified starch adhesive, a water-curing or water-cured physically modified starch adhesive, a water-curing or water-cured thermomechanically modified starch adhesive, a water-curing or water-cured degraded modified starch adhesive, a water-curing or water-cured physically degraded modified starch adhesive, a water-curing or water-cured pregelatinized starch adhesive and a water-curing or water-cured instantized starch adhesive. Modified-starch water-absorbent clumping agent can also comprise at least one or more one of a water-activated and water-curing or water-cured adhesive, a water-activated and water-curing or water-cured modified starch adhesive, a water-activated and water-curing or water-cured physically modified starch adhesive, a water-activated and water-curing or water-cured thermomechanically modified starch adhesive, a water-activated and water-curing or water-cured degraded modified starch adhesive, a water-activated and water-curing or water-cured physically degraded modified starch adhesive, a water-activated and water-curing or water-cured pregelatinized starch adhesive and a water-activated and water-curing or water-cured instantized starch adhesive. The modified-starch water-absorbent clumping agent can further comprise at least one or more of a water-activated biopolymer or biopolymeric adhesive, a water-activated modified starch biopolymer or biopolymeric adhesive, a water-activated physically modified starch biopolymer or biopolymeric adhesive, a water-activated thermomechanically modified starch biopolymer or biopolymeric adhesive, a water-activated degraded modified starch biopolymer or biopolymeric adhesive, a water-activated physically degraded modified starch biopolymer or biopolymeric adhesive, a water-activated pregelatinized starch biopolymer or biopolymeric adhesive and a water-activated instantized starch biopolymer or biopolymeric adhesive. The modified-starch water-absorbent clumping agent can still further comprise at least one or more of a water-curing or water-cured biopolymer or biopolymeric adhesive, a water-curing or water-cured modified starch biopolymer or biopolymeric adhesive, a water-curing or water-cured physically modified starch biopolymer or biopolymeric adhesive, a water-curing or water-cured thermomechanically modified starch biopolymer or biopolymeric adhesive, a water-curing or water-cured degraded modified starch biopolymer or biopolymeric adhesive, a water-curing or water-cured physically degraded modified starch biopolymer or biopolymeric adhesive, a water-curing or water-cured pregelatinized starch biopolymer or biopolymeric adhesive and a water-curing or water-cured instantized starch biopolymer or biopolymeric adhesive. The modified-starch water-absorbent clumping agent can yet further comprise at least one or more of a water-activated and water-curing or water-cured biopolymer or biopolymeric adhesive, a water-activated and water-curing or water-cured modified starch biopolymer or biopolymeric adhesive, a water-activated and water-curing or water-cured physically modified starch biopolymer or biopolymeric adhesive, a water-activated and water-curing or water-cured thermomechanically modified starch biopolymer or biopolymeric adhesive, a water-activated and water-curing or water-cured degraded modified starch biopolymer or biopolymeric adhesive, a water-activated and water-curing or water-cured physically degraded modified starch biopolymer or biopolymeric adhesive, a water-activated and water-curing or water-cured pregelatinized starch biopolymer or biopolymeric adhesive and a water-activated and water-curing or water-cured instantized starch biopolymer or biopolymeric adhesive.

The modified-starch water-absorbent clumping agent in each particle 46 preferably comprises a water-activated modified starch biopolymer adhesive. The modified-starch water-absorbent clumping agent can be and preferably is comprised of one of a moisture-curing adhesive and a moisture-curing flowable adhesive which cures or sets during reduction of moisture after being wetted. The one of the moisture-curing adhesive and the moisture-curing flowable adhesive can also at least one or more of a water-activated adhesive and a water-activated flowable adhesive. The one of the moisture-curing adhesive and the moisture-curing flowable adhesive cures and hardens into a solid glassy material comprised of starch during reduction of moisture after being wetted to one of a moisture content of no more than 15%, no more than 12%, no more than 10%, and no more than 8% by extruded clumping agent additive particle weight. The one of the moisture-curing adhesive and the moisture-curing flowable adhesive cures and hardens into a solid glassy material comprised of starch resulting from a reduction of moisture by drying.

The one of the moisture-curing adhesive and the moisture-curing flowable adhesive produced by wetted particles 46 during litter use cures and hardens into a solid glassy material comprised of starch during reduction of moisture by drying the self-clumping absorbent litter granule to one of a moisture content of no more than 15%, no more than 12%, no more than 10%, and no more than 8% by extruded clumping agent additive particle weight. The one of the moisture-curing adhesive and the moisture-curing flowable adhesive comprises at least one of a water-activated adhesive and a water-activated flowable adhesive and wherein one of the moisture-curing adhesive and the moisture-curing flowable adhesive is comprised of a pregelatinized starch.

The extrusion modified-starch water-absorbent clumping agent in each particle 46 can be and preferably is comprised of a cold-water swellable water-absorbent modified starch that absorbs one of (a) at least three times its particle weight in room temperature water having a temperature between 68° Fahrenheit and 72° Fahrenheit, (b) at least four times its weight in room temperature water, (c) at least five times its weight in room temperature water, and (d) at least six times its weight in room temperature water. Each particle 46 can have cold-water swellable water-absorbent modified starch that can be and preferably is comprised of a pregelatinized starch. The cold-water swellable water-absorbent modified starch in each particle 46 can be comprised of one of an extrusion-modified pregelatinized starch, physically modified pregelatinized starch, thermomechanically modified pregelatinized starch, degraded-starch pregelatinized starch, physically degraded starch pregelatinized starch, and a thermomechanically degraded starch pregelatinized starch.

The modified-starch water-absorbent clumping agent in each particle 46 can also be comprised of a cold-water swellable water-absorbent modified starch that absorbs one of (a) at least four and a half times its weight in room temperature water having a temperature between 68° Fahrenheit and 72° Fahrenheit, and (b) at least six times its weight in room temperature water. Each particle 46 can have cold-water swellable water-absorbent modified starch that can be substantially completely composed or comprised of a pregelatinized starch. Such cold-water swellable water-absorbent modified starch can be composed or comprised of an at least partially water soluble pregelatinized starch. Each particle 46 can also have cold-water swellable water-absorbent modified starch that can be composed or comprised of a water soluble pregelatinized starch that substantially completely solubilizes in water. Such cold-water swellable water-absorbent modified starch can also be comprised of a water soluble pregelatinized starch that substantially completely solubilizes in room temperature water. Each particle 46 can contain cold-water swellable water-absorbent modified starch comprised of an at least partially cold water soluble pregelatinized starch. Such cold-water swellable water-absorbent modified starch can be comprised of a cold water soluble pregelatinized starch. Such cold-water swellable water-absorbent modified starch can also be comprised of a cold water soluble pregelatinized starch that substantially completely solubilizes in room temperature water.

The modified-starch water-absorbent mobile clumping agent in each particle 46 of extruded clumping agent additive 40 can be comprised of a cold-water swellable water-absorbent modified starch that absorbs at least one of (a) four and one-half times the weight of the modified-starch water-absorbent clumping agent of room temperature water, (b) five times the weight of the modified-starch water-absorbent clumping agent of room temperature water, and (c) six times the weight of the modified-starch water-absorbent clumping agent of room temperature water within sixty seconds being wetted with the room temperature water. The cold-water swellable water-absorbent modified starch is comprised of a pregelatinized starch. Such cold-water swellable water-absorbent modified starch can be comprised of an at least partially water soluble pregelatinized starch. Such cold-water swellable water-absorbent modified starch can also be comprised of a water soluble pregelatinized starch that substantially completely solubilizes in water. Such cold-water swellable water-absorbent modified starch can further be comprised of a water soluble pregelatinized starch that substantially completely solubilizes in room temperature water. Such cold-water swellable water-absorbent modified starch can be comprised of an at least partially cold water soluble pregelatinized starch. Such cold-water swellable water-absorbent modified starch can also comprised of a cold water soluble pregelatinized starch. Such cold-water swellable water-absorbent modified starch can further be comprised of a cold water soluble pregelatinized starch that substantially completely solubilizes in room temperature water.

The modified-starch water-absorbent clumping agent in each particle 46 can be comprised of one of a water swellable water-absorbent modified starch and a cold-water swellable water-absorbent modified starch configured such that the particle 46 when wetted with water swells at least one of (a) 80% in volume during the absorption of at least two times the weight of the particle 46 in water, (b) 100% in volume during the absorption of at least three times the weight of the particle 46 in water, (c) 120% in volume during the absorption of at least four times the weight of the particle in water, (d) 150% in volume during the absorption of at least four and a half times the weight of particle 46 in water, (c) 200% in volume during the absorption of at least five times the weight of the particle 46 in water and (f) 300% in volume during the absorption of at least six times the weight of the particle 46 in water.

The modified-starch water-absorbent clumping agent in each particle 46 can be comprised of one of a water swellable water-absorbent modified starch and a cold-water swellable water-absorbent modified starch configured such that the particles 46 swell at least one of (a) 80% in volume during the absorption of at least two times the weight in room temperature water within 90 seconds of contacting or being wetted with the room temperature water, (b) 100% in volume during the absorption of at least three times the weight in room temperature water within 90 seconds of contacting or being wetted with the room temperature water, (c) 120% in volume during the absorption of at least four times the weight in room temperature water within 90 seconds of contacting or being wetted with the room temperature water, (d) 150% in volume during the absorption of at least four and half times the weight in room temperature water within 90 seconds of contacting or being wetted with the room temperature water, (c) 200% in volume during the absorption of at least five times the weight in room temperature water within 90 seconds of contacting or being wetted with the room temperature water, and (f) 300% in volume during the absorption of at least six times the weight in room temperature water within 90 seconds of contacting or being wetted with the room temperature water.

The modified-starch water-absorbent clumping agent in each particle 46 can be comprised of one of a water swellable water-absorbent modified starch and a cold-water swellable water-absorbent modified starch that configures the particle 46 to swell during absorption of room temperature water, and wherein the one of the water swellable water-absorbent modified starch and the cold-water swellable water-absorbent modified starch in each particle 46 can be and preferably is comprised of at least one of a physically modified starch and a thermomechanically modified starch. The modified-starch water-absorbent clumping agent in each particle 46 can be comprised of one of a water swellable water-absorbent modified starch and a cold-water swellable water-absorbent modified starch configured to cause the particle 46 swell during absorption of room temperature water, and wherein the one of the water swellable water-absorbent modified starch and the cold-water swellable water-absorbent modified starch in each particle 46 can be comprised of at least one of a physically modified starch physically modified by or during extrusion of the modified-starch water-absorbent clumping agent, and a thermomechanically modified starch thermomechanically modified by or during extrusion of the modified-starch water-absorbent clumping agent.

The one of the water swellable water-absorbent modified starch and the cold-water swellable cold water-absorbent modified starch in each particle 46 can be comprised of an ultrahigh extrusion pressure modified starch formed of or from native starch in a starch-containing admixture comprised of at least 40% starch by admixture weight, which has a moisture content of no greater than 25%, preferably no greater than about 20%, by admixture weight, and which is subjected to an ultrahigh extrusion pressure in an extruder of at least one of about 2000 PSI, at least 3000 PSI, at least 4000 PSI or at least 5000 PSI at an extrusion temperature within the extruder of at least 100° Celsius, preferably at least 130° Celsius, thereby mechanically modifying at least some of the native starch in the admixture in the extruder during ultrahigh pressure extrusion into at least one or both of an extrusion modified water swellable water absorbent starch in the particle 46 of extruded clumping agent additive 40 that ultimately is produced that absorbs water and swells during water absorption, and an extrusion modified cold water swellable water absorbent starch in the particle 46 of extruded clumping agent additive 40 that ultimately is produced that absorbs room temperature water having a temperature of between 68° Fahrenheit and 72° Fahrenheit and which swells during absorption of the room temperature water. Preferably at least one of the water swellable water absorbent starch and the cold-water swellable cold water-absorbent modified starch in each particle 46 can be comprised of an insoluble pregelatinized starch. The one of the water swellable water absorbent starch and the cold-water swellable cold water-absorbent modified starch in each particle 46 can also be comprised of a water insoluble pregelatinized starch. The one of the water swellable water absorbent starch and the cold-water swellable cold water-absorbent modified starch in each particle 46 can be comprised of a pregelatinized starch that is not water soluble in room temperature water. In at least one preferred embodiment, one of the water swellable water-absorbent modified starch and a cold-water swellable cold water-absorbent modified starch in each particle 46 can be substantially completely composed or comprised of a dextrinized starch. In at least one other preferred embodiment, one of the water swellable water-absorbent modified starch and a cold-water swellable cold water-absorbent modified starch in each particle 46 can be substantially completely composed or comprised of a dextrin.

The mobile clumping agent in each particle 46 can include a starch-based sorbent swelling biopolymeric gellant that swells and gels upon sorption of a liquid. In one embodiment, the starch-based sorbent swelling biopolymeric gellant can be composed or comprised of a pregelatinized starch. The starch-based sorbent swelling biopolymeric gellant can comprise between 2% and 50% by weight of the mobile clumping agent in each particle 46 by particle weight. In another embodiment that contains starch-based sorbent swelling biopolymeric gellant, the starch-based sorbent swelling biopolymeric gellant can comprise between 4% and 40% by particle weight of the clumping agent. Starch-based sorbent swelling biopolymeric gellant present in particles 46 can comprise between 5% and 35% by particle weight of the clumping agent. The starch-based sorbent swelling biopolymeric gellant can also comprise between 5% and 25% by particle weight of the clumping agent in each particle. Each particle 46 can contain starch-based sorbent swelling biopolymeric gellant in an amount of (a) between about 5% and about 25% by particle volume of the clumping agent, (b) between 5% and 35% by particle volume of the clumping agent, or (c) between 2% and 40% by particle volume of the clumping agent.

In one embodiment, the starch-based sorbent swelling biopolymeric gellant of the clumping agent of each particle 46 can be comprised of an at least partially soluble extrusion modified starch binder and a water-swellable water-absorbent extrusion modified starch. Such an at least partially soluble extrusion modified starch binder of the clumping agent can comprise one of a water-activated adhesive and a moisture curing adhesive that adhesively bonds the outer layer of the starch-based sorbent swelling biopolymeric gellant to one or more other particles 46 and/or litter granules 48 or 48a and 48b during litter clumping. The at least partially soluble extrusion modified starch binder of the clumping agent can be comprised of a pregelatinized starch. The at least partially soluble extrusion modified starch binder of the clumping agent can also be comprised of an at least partially cold-water soluble extrusion modified starch binder and the water-swellable water-absorbent extrusion modified starch can be comprised of a cold water-swellable cold water-absorbent extrusion modified starch. In a preferred embodiment, the at least partially soluble extrusion modified starch binder and the water-swellable water-absorbent extrusion modified starch in each particle 46 can both be comprised of a pregelatinized starch.

The at least partially soluble extrusion modified starch binder of the clumping agent in each particle 46 can be comprised of a water soluble pregelatinized starch and the water-swellable water-absorbent extrusion modified starch can be comprised of a water insoluble pregelatinized starch. The at least partially soluble extrusion modified starch binder in each particle 46 can also be comprised of a pregelatinized starch that is water soluble in room temperature water and the water-swellable water-absorbent extrusion modified starch can also be comprised of a pregelatinized starch that is not water soluble in room temperature water. The at least partially soluble extrusion modified starch binder in each particle can further be comprised of a pregelatinized starch that is water soluble in room temperature water, room temperature urine, and cat body temperature urine and the water-swellable water-absorbent extrusion modified starch can further be comprised of a pregelatinized starch that is not water soluble in room temperature water, in room temperature urine, and in cat body temperature urine.

For all of the percentages of the clump retention rates listed herein, the following test procedure preferably is used:

### Clump Retention Rate Test Procedure

### Clump Drop Test

The clump retention rate is determined by adding 10 milliliters of water to the litter to wet the particles and granules, and cause a clump, e.g., clump 56, to be formed in the litter. After waiting a predetermined period of time after the formation of the clump, which in one variation of the test is 10 minutes and another variation of the test is 30 minutes, the clump is weighed, referred to as the pre-drop weight, and then the clump is dropped from a height of 18 inches onto a No. 10 screen. The portion of the clump that remains after being dropped onto the screen is then weighed and is referred to as the post-drop weight. Any portion shed from the clump from the impact with the screen will result in the post-drop weight being less than the pre-drop weight. The clump retention rate is the decimal result of the post-drop clump weight divided by the pre-drop clump weight multiplied by 100 to express the clump retention rate as a percentage of the original clump that is left after being dropped.

In a preferred implementation of the 10-minute test, the clump, e.g., clump 56, is removed from the litter ten minutes after formation of the clump, weighed to obtain the pre-drop clump weight, dropped from a height of 18 inches onto the screen, and the portion of the clump remaining on the screen after being dropped onto the screen is weighed to obtain the post-drop clump weight. In a preferred implementation of the 30-minute test, the clump is removed from the litter 40 or 40′ thirty minutes after formation of the clump, weighed to obtain its pre-drop weight, dropped from a height of 18 inches onto the screen, and the clump remaining on the screen after being dropped is weighed to obtain its post-drop weight. For each clump, the post-drop clump weight is divided by the pre-drop clump weight and the result is multiplied by 100 to obtain the clump retention rate of the clump.

For all of the values of litter particle tracking effectiveness listed herein, the following test procedure preferably is used:

### Litter Particle Tracking Effectiveness Test Procedure

A preferred litter tracking effectiveness test tool is used that employs a generally flat or planar litter particle tracking pickup pad with a fibrous face facing in one direction and a handle on the other side facing in an opposite direction. The pad has a fibrous face composed of relatively tightly packed uprightly extending fibers that are litter particle pickup fibers and which includes a generally, rectangular, e.g., square, litter particle tracking pickup pad region that preferably is one inch by one inch square. In a preferred embodiment of the tool, the pad preferably is a flocked fiber pad with a fibrous face of flocked fibers that are used as litter particle pickup fibers. If desired, the tool can be made to have the fibrous face of the pad to be limited to be one inch by one inch square.

The pad preferably is about a quarter inch thick in cross-section and includes a base from which the fibers outwardly extend with the base supported by or on an underlying rigid backing that can be made of a polystyrene foam, e.g., STYROFOAM, plastic, or the like from which the handle outwardly extends. If desired, base can include or be composed of a layer of foam, such as a layer of an open cell foam, which foam can be disposed between the layer of fibers and the backing. The pad is about one quarter inch thick and the fibers are made of a synthetic material, preferably nylon, having a fiber length of about 0.150 inches such that the fibers stick out from the base, e.g., extend outwardly from the foam layer, about 0.150 inches. The flock density of the fibers of the pad can range from 200 grams per meter squared to 500 grams per meter squared. In a preferred embodiment, the tool is a 1500C HANDI PAINTR made and sold by Shur-Line of Waukesha Wisconsin but a Shur-Line 1520C Trim and Touch Up Pad can also be used.

When pressed into granular litter, e.g., litter or composed of particles 46 and granules 48 or 48a and 48b, the pad of the tool is configured for picking up particles of litter in a manner that simulates, and which preferably is predictive of a cat picking up litter particles of the litter from a litter box containing the litter and tracking litter particles out of the litter box. In carrying out a litter particle tracking effectiveness test in accordance with the present invention, the handle of the tool is manually grasped by a user, e.g., tester, and maneuvered so the fibrous face of the pad overlies the surface of the litter before being pressed straight down, and not at an angle, against and preferably at least slightly into the litter. Pressure is applied, such as preferably in an amount of 0.5 pounds per square inch of pressure, pressing the fibrous face of the pad against and/or into the surface of the litter for five seconds. Thereafter, the tool is lifted straight up away from the litter's surface out of the litter disengaging the fibrous face of the pad from the litter. If desired, the pad can be mounted on a test stand overlying the litter to be tested that is designed or configured to be lowered directly vertically downwardly into the top surface of the litter to be tested applying a pressure of 0.5 pounds per square inch of the fibrous face against the litter's surface for five seconds before the pad is vertically raised out of the litter. This amount of pressure is intended to simulate the weight of a cat's paw pressing on the surface of the litter. The number of litter particles 46 and/or granules 48 or 48a and 48b, which adhere to the fibers of the one inch by one inch test region of the fibrous face of the pad are counted, such as by removing the particles and granules which remain adhered to the pad from the pad, to obtain a count of the number of litter particles per square inch that is the litter particle tracking effectiveness number. The count of the number of litter particles per square inch of the test region of the pad which became adhered thereto includes the number of particles and granules which became adhered to the test region of the pad in carrying out a single litter particle tracking effectiveness test. Of course, the litter particle tracking effectiveness test can be performed on a multicomponent litter. The number of litter particles per square inch of the test region of the pad which become adhered thereto during the test is representative of and preferably corresponds to the number of litter particles and/or litter granules tracked from the surface 60 of the litter in a litter box by a cat using the litter. The litter particles are removed after each test to ensure that there are no particles adhering to the test region of the pad before a new test is performed.

The litter particle tracking effectiveness test procedure can be and preferably is repeated at three other different locations of the outer surface of the litter. The total number of litter particles and granules picked up by the one-inch by one-inch square test pad region are counted and divided by the number of test procedures performed to get an average litter particle tracking effectiveness number for the litter that enables the uniformity of the blend or formulation of the litter to be assessed. The particles and granules that are picked up are then removed after each test to ensure that no particles or granules remain adhered to the test region of the pad before a new test is performed.

For all of the values of the clump compression strengths or clump crush strengths listed herein, the following test procedure preferably is used:

### Clump Compression Strength Test Procedure

The following equipment was utilized in carrying out extruded granular absorbent (litter) clump compression strength testing:
(1) 5 mL centrifuge tubes with screw top caps, plastic.
(2) 3.0 mL disposable pipettes, plastic.
(3) Distilled water
(4) Force Gauge: Mark-10 Model M7-500 S/N 3674412
(5) Motorized test stand: Model ESM303 S/N 3979431
(6) Digital control panel: Mark-10 Model DC4060 S/N 3680222
(7) DREMEL handheld high speed rotary power tool with deep cutting wheel
(8) Samples of extruded granular absorbent material (extruded pellets) to be wetted to form clumps therefrom to be compression strength tested.

Using the above, the following methodology was utilized in performing extruded granular absorbent (litter) clump compressive strength testing:
(1) Saw off tapered end of a 15 mL test tube and clean off burrs.
(2) Screw on cap of test tube and fill tube with sample material to be tested.
(3) Add distilled water to sample material in test tube (1:1 by weight) to wet sample material
(4) Wait 10 seconds.
(5) Unscrew cap from test tube and gently push “cast” clump formed of wetted sample material out of test tube using bulbous end of a plastic pipette (snug fit).
(6) Let cast clump sit and dry for 5 days at ambient room temperature conditions.
(7) Using deep cutting wheel attached to a DREMEL high speed rotary tool at high speed greater than 10,000 RPM, cut cast clump into barrel-shaped sections each approximately 0.5 inches thick or long.
(8) Measure the diameter and length of each barrel shaped cast clump section.
(9) Place barrel shaped cast clump section on middle of compression test stand platform, with flat cut ends of barrel shaped cast clump section on top and bottom for compression testing by force gauge.
(10) Using a compression speed of 0.5 inches/minute, determine peak compression strength of barrel shaped cast clump section using force gauge.

It is also to be understood that, although the foregoing description and drawings describe and illustrate in detail one or more preferred embodiments of the present invention, to those skilled in the art to which the present invention relates, the present disclosure will also suggest various modifications, constructions, and alternatives, as well as different embodiments and applications all of which are contemplated as being within the scope of the invention. The present invention, therefore, is intended to be limited only by the scope of the appended claims.

It is claimed:

1. A litter clumping agent additive comprised of at least a plurality of pairs of sorbent clumping agent additive particles each containing a clumping agent and configured to be added to a base granular litter comprised of at least a plurality of pairs of sorbent litter granules forming a clumping agent additive enhanced granular litter that is a blend thereof that forms clumps when wetted with urine or water (a) where the base granular litter is a non-clumping litter; and (b) which have at least one improved clumping property compared to clumps formed where the base granular litter is a clumping litter.

2. The litter clumping agent additive of claim 1, further comprising a clumping agent additive container holding the plurality of pairs of clumping agent additive particles, the container having an opening configured to dispense the clumping agent additive particles therefrom to add the clumping agent additive particles to the base granular litter and form the clumping agent additive enhanced granular litter.

3. The litter clumping agent additive of claim 1, wherein the base granular litter is prepackaged in a litter container having an opening configured for dispensing the base granular litter into a litter box for use, the prepacked base granular litter comprising one of a bag, a jug, a pail, a tub, and a box holding a predetermined weight, mass or volume of the base granular litter therein, and further comprising a clumping agent additive container holding the plurality of pairs of clumping agent additive particles and having a clumping agent additive particle dispensing opening configured to (a) engage the granular litter dispensing opening of the prepackaged base granular litter container and (b) facilitate dispensing of the clumping agent additive particles into the prepackaged base granular litter container to blend the clumping agent additive particles with the base granular litter in the prepackaged base granular litter containing forming the clumping agent additive enhanced granular litter.

4. The litter clumping agent additive of claim 1, wherein the clumping agent additive is comprised of at least 5% by weight of a water-soluble binder clumping agent and the clumping agent additive enhanced litter contains at least 3% by weight of the litter clumping agent additive particles.

5. The litter clumping agent additive of claim 4, wherein the litter clumping agent additive particles have a maximum particle size, the litter granules of the base granular litter have a minimum granule size, and the maximum particle size of the litter clumping agent additive particles is smaller than the minimum granule size of the base granular litter.

6. The litter clumping agent additive of claim 5, wherein the clumping agent additive enhanced litter has a particle tracking effectiveness of no greater than 200 particles per square inch.

7. The litter clumping agent additive of claim 6, wherein the maximum particle size of the litter clumping agent additive particles are no larger than about 1700 μm and the maximum particle size of the litter granules of the base granular litter is no less than about 1800 μm.

8. The clumping agent additive of claim 1, wherein the clumping agent additive enhanced litter contains at least 5% by weight of the litter clumping agent additive and a clump formed of at least a plurality of pairs of litter granules and at least a plurality of pairs of particles of the clumping agent additive wetted with water has a clump retention rate of at least 90%.

9. The clumping agent additive for litter of claim 1, wherein the clumping agent additive particles are each comprised of at least 7.5% water-soluble binder clumping agent by weight, the clumping agent additive enhanced litter contains at least 5% by weight of the litter clumping agent additive particles and a clump formed of at least a plurality of pairs of litter granules and at least a plurality of pairs of clumping agent additive particles wetted with water has a clump retention rate of at least 95%.

10. The litter clumping agent additive of claim 9, wherein the clumping agent additive enhanced litter has a particle tracking effectiveness of no greater than 200 particles per square inch.

11. The litter clumping agent additive of claim 10, wherein the litter clumping agent additive particles have particle sizes no larger than about 1700 μm and the litter granules of the base granular litter have particle sizes of no less than about 1800 μm.

12. The litter clumping agent additive of claim 1, wherein the clumping agent is comprised of (a) a first constituent comprised of a single-time moisture activated single-time moisture cured binder, and (b) a second constituent comprised of a moisture reactivatable moisture re-curable binder configured to be moisture activated and moisture cured at least a plurality of times.

13. The litter clumping agent additive of claim 12, wherein the clumping agent additive particles are comprised of an extrudate formed of a starch-containing admixture containing starch subjected to an extrusion pressure of at least 2000 PSI in an extruder and wherein at least one of the first constituent and the second constituent are comprised of an extrusion-modified starch modified by being subjected to an extrusion pressure of at least 2000 PSI in the extruder.

13. The litter clumping agent additive of claim 12, wherein the clumping agent further comprises a third constituent comprising a water sorbent and wherein the clumping agent additive particles absorb at least four times clumping agent additive particle weight in water.

14. The litter clumping agent additive of claim 13, wherein the clumping agent additive particles are comprised of an extrudate formed of a starch-containing admixture containing starch subjected to an extrusion pressure of at least 2000 PSI in an extruder and wherein third constituent is comprised of an extrusion-modified starch modified by being subjected to an extrusion pressure of at least 2000 PSI in the extruder.

15. The litter clumping agent additive of claim 12, wherein (a) one of the first constituent and the second constituent comprises a first clumping agent comprised of a cold-water soluble modified starch binder clumping agent that is at least partially water soluble at a room temperature of between 68 degrees Fahrenheit and 72 degrees Fahrenheit and is moisture reactivatable and moisture re-curable at least a plurality of times, and (b) the other one of the first constituent and the second constituent comprises a second clumping agent comprised of a cold-water pregelatinized starch.

16. The litter clumping agent additive of claim 15, wherein the first constituent and the second constituent respectively comprised an extrusion-modified starch formed of starch in the admixture physically modified by being subjected to an extrusion pressure of at least 2000 PSI during extrusion.

17. A method of making an extruded clumping agent additive for litter comprising:
(a) providing an extruder and a starch-containing admixture comprised of starch; and
(b) extruding the admixture by subjecting the admixture to an extrusion pressure of at least 2000 PSI and an extrusion temperature of at least 100° Celsius within the extruder sufficient to modify at least some of the starch in the admixture into a clumping agent and thereafter discharging the admixture as an extrudate from the extruder comprised of the clumping agent; and
(c) forming the extrudate into particles comprised of the clumping agent and defining a particulate clumping agent additive configured to be shaken onto, sprinkled on, or mixed with litter granules of an original base litter forming a clumping agent additive enhanced litter that is a mixture or blend thereof, the clumping agent additive enhanced litter forming a clump comprised of at least a plurality of pairs of the litter granules of the original base litter and at least a plurality of pairs of the particles of the clumping agent additive when the clumping agent additive enhanced litter is wetted with water.

18. The method of claim 17, wherein the original base litter is a non-clumping litter composed of non-clumping litter granules.

19. The method of claim 17, wherein the clumping agent in the extruded clumping agent additive particles is comprised of (a) a first constituent comprised of a single-time moisture activated single-time moisture cured binder formed during extrusion, and (b) a second constituent comprised of a moisture reactivating moisture recuring binder configured to be moisture activated and moisture cured a plurality of times formed during extrusion.

20. The method of claim 19, wherein one of the first constituent and the second constituent is comprised of a cold-water soluble binder clumping agent that is at least partially water soluble at a room temperature of between 68 degrees Fahrenheit and 72 degrees Fahrenheit.

21. The method of claim 20, wherein the cold-water soluble binder clumping agent is comprised of starch in the admixture during extrusion modified by being subjected to the at least 2000 PSI of extrusion pressure while the admixture is in the extruder during the extruding step (b).

22. The method of claim 19, wherein one of the first constituent and the second constituent is comprised of a pregelatinized starch.

23. The method of claim 22, wherein the pregelatinized starch is comprised of some of the starch in the admixture during extrusion subjected to the at least 2000 PSI of extrusion pressure while the admixture is in the extruder during the extruding step (b) extrusion-modifying the starch into the pregelatinized starch.

24. The method of claim 19, wherein (a) one of the first constituent and the second constituent is comprised of a pregelatinized starch, and (b) the other one of the first constituent and the second constituent is comprised of a cold-water soluble binder clumping agent that is at least partially water soluble at a room temperature of between 68 degrees Fahrenheit and 72 degrees Fahrenheit.

25. The method of claim 24, wherein the first constituent is comprised of a pregelatinized starch and the second constituent is comprised of a cold-water soluble binder clumping agent that is at least partially water soluble at a room temperature of between 68 degrees Fahrenheit and 72 degrees Fahrenheit.

26. The method of claim 17, wherein the extruded clumping agent additive particles are composed of at least 7.5% of the clumping agent by particle weigh, the clumping agent is comprised of (a) a first constituent comprised of a single-time moisture activated single-time moisture cured binder is formed of some starch in the admixture modified during extrusion, and (b) a second constituent comprised of a moisture reactivating moisture recuring binder configured to be moisture activated and moisture cured a plurality of times is formed is formed of other starch in the admixture modified during extrusion.

27. The method of claim 26, wherein during the extruding step (b), the admixture remains within the extruder for a residency time of no longer than 20 seconds before being discharged from the extruder as the extrudate.

28. The method of claim 27, wherein the extruder comprises a single screw extruder.

29. The method of claim 28, wherein the admixture is comprised of at least 40% starch, the admixture has a moisture content of no greater than 22% by admixture weight, and the residency time that the admixture remains in the single screw extruder during the extruding step (b) is no longer than 20 seconds.

30. The method of claim 29, wherein the residency time that the admixture remains in the single screw extruder during the extruding step (b) is between about 7 seconds and about 18 seconds.
